(19) United States
(12) Patent Application Publication
(10) Pub. No.: US 2004/0218172 A1
(43) Pub. Date: Nov. 4, 2004

(54) Application of spatial light modulators for new modalities in spectrometry and imaging

(76) Inventors: Richard A. DeVerse, Kailua-Kona, HI (US); Frank B. Geshwind, Madison, CT (US); Ronald R. Coifman, North Haven, CT (US); William G. Fateley, Manhattan, KS (US); Andreas C. Coppi, Groton, CT (US)

Correspondence Address: JONES DAY, 222 EAST 41ST ST, NEW YORK, NY, 10017, US

(21) Appl. No.: 10/764,113

(22) Filed: Jan. 24, 2004

Related U.S. Application Data
(60) Provisional application No. 60/442,686, filed on Jan. 24, 2003.

(51) Int. Cl. G01J 3/00; G01N 21/86

(52) U.S. Cl. 356/300; 250/559.4

(57) ABSTRACT

An adaptive digitally tuned light source is disclosed, in the form of a de-dispersive imaging spectrograph in both the visible and near infrared spectral regions. The devices are capable of illuminating a sample with appropriate energy-weighted spectral bands or spatio-spectral bands that relate only to the constituents of interest. The energy from each of the spectral resolution elements can be digitally modulated to provide a tuned weighted spectral output. A tuned light source device based on the present disclosure can be adapted for use in a conventional imaging microscope system to enable direct measure of spatio-spectral features of interest.

### CROSS REFERENCE TO RELATED APPLICATIONS

This application claims priority of U.S. provisional application serial No. 60/442,686, filed on Jan. 24, 2003, the sum and substance of which is incorporated by reference herein in its entirety.

### FIELD OF THE INVENTION

The present invention relates generally to signal processing, and more particularly to devices and methods for use in spectroscopy, imaging, spatial and spectral modulation filtering, controllable radiation source design and related signal processing.

### BACKGROUND OF THE INVENTION

Imagers employ either a two-dimensional (2D) multichannel detector array or a single element detector. Imagers using a 2D detector array measure the intensity distribution of all spatial resolution elements simultaneously during the entire period of data acquisition. Imagers using a single detector require that the individual spatial resolution elements be measured consecutively via a raster scan so that each one is observed for a small fraction of the period of data acquisition. Prior art imagers using a plurality of detectors at the image plane can exhibit serious signal-to-noise ratio problems. Prior art imagers using a single element detector can exhibit more serious signal-to-noise ratio problems. Signal-to-noise ratio problems limit the utility of imagers applied to chemical imaging applications where subtle differences between a sample's constituents become important.

Spectrometers are commonly used to analyze the chemical composition of samples by determining the absorption or attenuation of certain wavelengths of electromagnetic radiation by the sample or samples. Because it is typically necessary to analyze the absorption characteristics of more than one wavelength of radiation to identify a compound, and because each wavelength must be separately detected to distinguish the wavelengths, prior art spectrometers utilize a plurality of detectors, have a moving grating, or use a set of filter elements. However, the use of a plurality of detectors or the use of a macro moving grating has signal-to-noise limitations. The signal-to-noise ratio largely dictates the ability of the spectrometer to analyze with accuracy all of the constituents of a sample, especially when some of the constituents of the sample account for an extremely small proportion of the sample. There is, therefore, a need for imagers and spectrometers with improved signal-to-noise ratios.

Prior art variable band pass filter spectrometers, variable band reject filter spectrometers, variable multiple band pass filter spectrometers or variable multiple band reject filter spectrometers typically employ a multitude of filters that require macro moving parts or other physical manipulation in order to switch between individual filter elements or sets of filter elements for each measurement. Each filter element employed can be very expensive, difficult to manufacture and all are permanently set at the time of manufacture in the wavelengths (bands) of radiation that they pass or reject. Physical human handling of the filter elements can damage them and it is time consuming to change filter elements. There is, therefore, a need for variable band pass filter spectrometers, variable band reject filter spectrometers, variable multiple band pass filter spectrometers or variable multiple band reject filter spectrometers without a requirement for discrete (individual) filter elements that have permanently set band pass or band reject properties. There is also a need for variable band pass filter spectrometers, variable band reject filter spectrometers, variable multiple band pass filter spectrometers or variable multiple band reject filter spectrometers to be able to change the filters corresponding to the bands of radiation that are passed or rejected rapidly, without macro moving parts and without human interaction.

In several practical applications it is required that an object be irradiated with radiation having particularly shaped spectrum. In the simplest case when only a few spectrum lines (or bands) are necessary, one can use a combination of corresponding sources, each centered near a required spectrum band. Clearly, however, this approach does not work in a more general case, and therefore it is desirable to have a controllable radiation source capable of providing arbitrary spectrum shapes and intensities. Several types of prior art devices are known that are capable of providing controllable radiation. Earlier prior art devices primarily relied upon various “masking” techniques, such as electronically alterable masks interposed in the optical pathway between a light source and a detector. More recent prior art devices use a combination of two or more light-emitting diodes (LEDs) as radiation sources. In such cases, an array of LEDs or light-emitting lasers is configured for activation using a particular encoding pattern, and can be used as a controllable light source. A disadvantage of these systems is that they rely on an array of different LED elements (or lasers), each operating in a different, relatively narrow spectrum band. In addition, there are technological problems associated with having an array of discrete radiation elements with different characteristics. Accordingly, there is a need for a controllable radiation source, where virtually arbitrary spectrum shape and characteristics can be designed, and where disadvantages associated with the prior art are obviated. Further, it is desirable not only to shape the spectrum of the radiation source, but also encode its components differently, which feature can be used to readily perform several signal processing functions useful in a number of practical applications. The phrase “a spectrum shape” in this disclosure refers not to a mathematical abstraction but rather to configurable spectrum shapes having range(s) and resolution necessarily limited by practical considerations.

In addition to the signal-to-noise issues discussed above, one can consider the tradeoff between signal-to-noise and, for example, one or more of the following resources: system cost, time to measure a scene, and inter-pixel calibration. Thus, in certain prior art systems, a single sensor system may cost less to produce, but will take longer to fully measure an object under study. In prior art multi-sensor systems, one often encounters a problem in which the different sensor elements have different response characteristics, and it is necessary to add components to the system to calibrate for this. It is desirable to have a system with which one gains the lower-cost, better signal-to-noise, and automatic inter-pixel calibration advantages of a single-sensor system, while not suffering all of the time loss usually associated with using single sensors.

### SUMMARY OF THE INVENTION

In one aspect, the present invention solves the above-described problems and provides a distinct advance in the art by providing an imager or spectrometer that is less sensitive to ambient noise and that can effectively operate even when used in environments with a high level of ambient radiation. The invention further advances the art of variable band pass filter spectrometers, variable band reject filter spectrometers, variable multiple band pass filter spectrometers or variable multiple band reject filter spectrometers by providing a variable band pass filter spectrometer, variable band reject filter spectrometer, variable multiple band pass filter spectrometer or variable multiple band reject filter spectrometer that: (1) does not require the selection of the bands of wavelengths passed or rejected at the time of manufacture; (2) allows the selection of any desired combination of bands of wavelengths that are passed or rejected; (3) reduces the time to change the bands of wavelengths passed or rejected; and (4) requires no macro moving parts to accomplish a change in the bands of wavelengths passed or rejected.

In a first aspect, the system of the present invention generally includes one or more radiation sources, a two-dimensional array of modulateable micro-mirrors or an equivalent switching structure, a detector, and an analyzer. In a specific embodiment, the two-dimensional switching array is positioned for receiving an image. The micro-mirrors (or corresponding switching elements of the array) are modulated in order to reflect individual spatially-distributed radiation components of the image toward the detector. In a preferred embodiment, the modulation is performed using known and selectively different modulation rates.

According to this aspect of the invention, a detector is oriented to receive the combined radiation components reflected from the array and is operable to generate an output signal representative of the combined radiation incident thereon. The analyzer is operably coupled with the detector to receive the output signal and to demodulate the signal to recover signals representative of each of the individual spatially distributed radiation components of the image. The analyzer can be configured to recover all reflected components or to reject some unnecessary components of the recovered signals from the combined reflections.

By using micro-mirrors that receive the individual spectral or spatial radiation components and then modulate these components at different modulation rates, all of the radiation components can be focused onto a single detector and then demodulated to maximize the signal-to-noise ratio (SNR) of the detector. Various techniques for enhancing the SNR of the system are presented as well.

In another important aspect, the present invention provides a distinct advance in the state of the art by enabling the design of a controllable radiation source, which uses no masking elements, which are generally slow and cumbersome to operate, and no discrete light sources, which also present a number of technical issues in practice. Instead, the controllable radiation source in accordance with a preferred embodiment is implemented using a broadband source illuminating a two-dimensional array of switching elements, such as a digital micro-mirror array (DMA). Modulation of the individual switching elements of the array provides an easy mechanism for spatio-spectral encoding of the input radiation, which encoding can be used in a number of practical applications.

In accordance with another aspect of the invention, a two-dimensional array of switching elements, such as a DMA, can be configured and used as a basic building block for various optical processing tasks, and is referred to as an optical synapse processing unit (OSPU). Combinations of OSPUs with standard processing components can be used in the preferred embodiments of the present invention in a number of practical applications, including data compression, feature extraction and others. In a specific embodiment, a spectrometer using a controlled radiation source provides for very rapid analysis of a sample using an orthogonal set of basis functions, such as Hadamard or Fourier transform techniques, resulting in significantly enhanced signal-to-noise ratio.

The present invention gains the lower-cost, better signal-to-noise, and automatic inter-pixel calibration advantages of single-sensor systems, while not suffering all of the time loss usually associated with using single sensors, because it allows for adaptive and tunable acquisition of only the desired information, as opposed to prior-art systems which are generally full data-cube acquisition devices requiring additional post processing to discover or recover the knowledge ultimately sought in the application of the system.

In another aspect, the present invention provides a method for identifying spatio-spectral features of one or more objects. The method includes collecting one or more hyperspectral datacubes of a first set of one or more objects; building a spectrometric model from the hyperspectral datacubes; illuminating a second set of one or more objects with energy-weighted spectral bands that relate to the model in the step of building the spectrometric model, using a tunable light source; measuring the energy resulting from the step of illumination; and using the measurements in step (d) to identify spatio-spectral features of the illuminated object(s). In an embodiment, the first set of one or more objects can be the same as the second set of one or more objects. In yet another embodiment, there can be some overlap between the first set of one or more objects and the second set of one or more objects. In an embodiment of the invention, a scene or a scene of interest can include one or more objects or one or more objects of interest. In another embodiment of the invention, a sample or a feature can include one or more objects or one or more objects of interest. The tunable light source may include a spatial light modulator.

In another aspect, the present invention provides a device for identifying spatio-spectral features of one or more objects. The device includes a means for collecting hyperspectral datacubes, a means for building spectrometric models, a tunable light source means, a means for illuminating one or more objects with energy-weighted spectral bands that relate to spectrometric models, and a means for measuring the energy resulting from illumination by said means for illuminating. The tunable light source may include a spatial light modulator.

One skilled in the art will recognize that, while the invention here is described using 2D arrays of micro-mirrors, any 2D spatial light modulator can be used. It should also be noted that a pair, or a few 1D spatial light modulators can be combined to effectively produce a 2D spatial light modulator for applications that involve raster scanning, Walsh-Hadamard scanning, or scanning or acquisition with any separable library of patterns.

It is intended that the devices and methods in this application in general are capable of operating in various ranges of electromagnetic radiation, including the ultraviolet, visible, infrared, and microwave spectrum portions. Further, it will be appreciated by those of skill in the art of signal processing, be it acoustic, electric, magnetic, etc., that the devices and techniques disclosed herein for optical signal processing can be applied in a straight-forward way to those other signals as well.

### BRIEF DESCRIPTION OF THE DRAWINGS

The present invention will be understood and appreciated more fully from the following detailed description, taken in conjunction with the drawings in which:

FIGS. 1A and 1B are schematic diagrams illustrating a spectrometer constructed in accordance with two embodiments of the invention;

FIG. 2 is a plan view of a micro-mirror array used in the present invention;

FIG. 3 is a schematic diagram of two micro-mirrors illustrating the modulations of the mirrors of the micro-mirror device of FIG. 2;

FIG. 4 is a graph illustrating an output signal of the spectrometer when used to analyze the composition of a sample;

FIG. 5 is a graph illustrating an output signal of the imager when used for imaging purposes;

FIG. 6 is a schematic diagram illustrating an imager constructed in accordance with a preferred embodiment of the invention; FIG. 6A illustrates spatio-spectral distribution of a DMA, where individual elements can be modulated;

FIG. 7 is an illustration of the input to the DMA Filter Spectrometer and its use to pass or reject wavelength of radiation specific to constituents in a sample;

FIG. 8 illustrates the design of a band pass filter in accordance with the present invention (top portion) and the profile of the radiation passing through the filter (bottom portion);

FIG. 9 illustrates the design of multi-modal band-pass or band-reject filters with corresponding intensity-plots, in accordance with the present invention;

FIG. 10 illustrates the means for the intensity variation of a spectral filter built in accordance with this invention;

FIGS. 11-14 illustrate alternative embodiments of a modulating spectrometer in accordance with this invention; FIGS. 11A and 11B show embodiments in which the DMA is replaced with concave mirrors; FIG. 12 illustrates an embodiment of a complete modulating spectrometer in which the DMA element is replaced by the concave mirrors of FIG. 11. FIG. 13 illustrates a modulating lens spectrometer using lenses instead of DMA, and a “barber pole” arrangement of mirrors to implement variable modulation. FIG. 14. illustrates a “barber pole” modulator arrangement;

FIGS. 15 and 16 illustrate an embodiment of this invention in which one or more light sources provide several modulated spectral bands using a fiber optic bundle;

FIG. 17 illustrates in diagram form an apparatus using controllable radiation source;

FIGS. 18A and 18B illustrate in a diagram form an optical synapse processing unit (OSPU) used as a processing element in accordance with the present invention;

FIG. 19 illustrates in a diagram form the design of a spectrograph using OSPU;

FIG. 20 illustrates in a diagram form an embodiment of a tunable light source;

FIG. 21 illustrates in a diagram form an embodiment of the spectral imaging device, which is built using two OSPUs;

FIGS. 22 and 23 illustrate different devices built using OSPUs;

FIGS. 24-26 are flow charts of various scans used in accordance with the present invention. Specifically, FIG. 24 is a flow chart of a raster-scan used in one embodiment of the present invention; FIG. 25 is a flowchart of a Walsh-Hadamard scan used in accordance with another embodiment of the invention. FIG. 26 is a flowchart of a multi-scale scan, used in a different embodiment; FIG. 26A illustrates a multi-scale tracking algorithm in a preferred embodiment of the present invention;

FIG. 27 is a block diagram of a spectrometer with two detectors;

FIG. 28 illustrates a Walsh packet library of patterns for N=8.

FIG. 29 is a generalized block diagram of hyperspectral processing in accordance with the invention;

FIG. 30 illustrates the difference in two spectral components (red and green) of a data cube produced by imaging the same object in different spectral bands;

FIG. 31 illustrates hyperspectral imaging from airborne camera;

FIG. 32 is an illustration of a hyperspectral image of human skin;

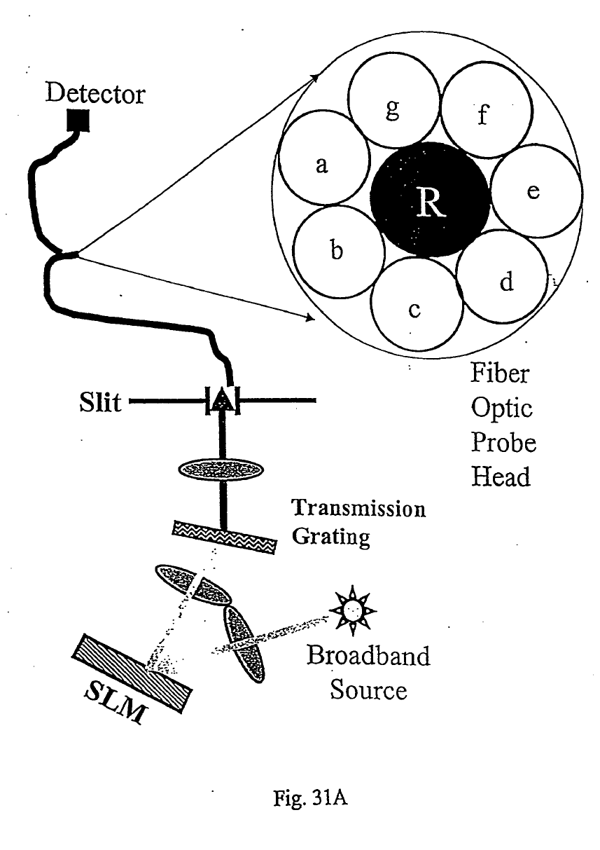

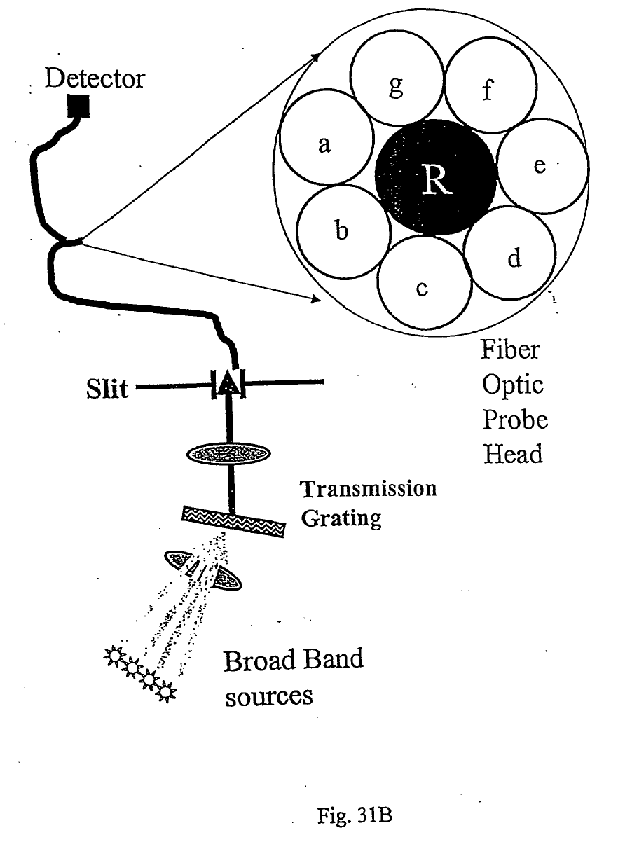

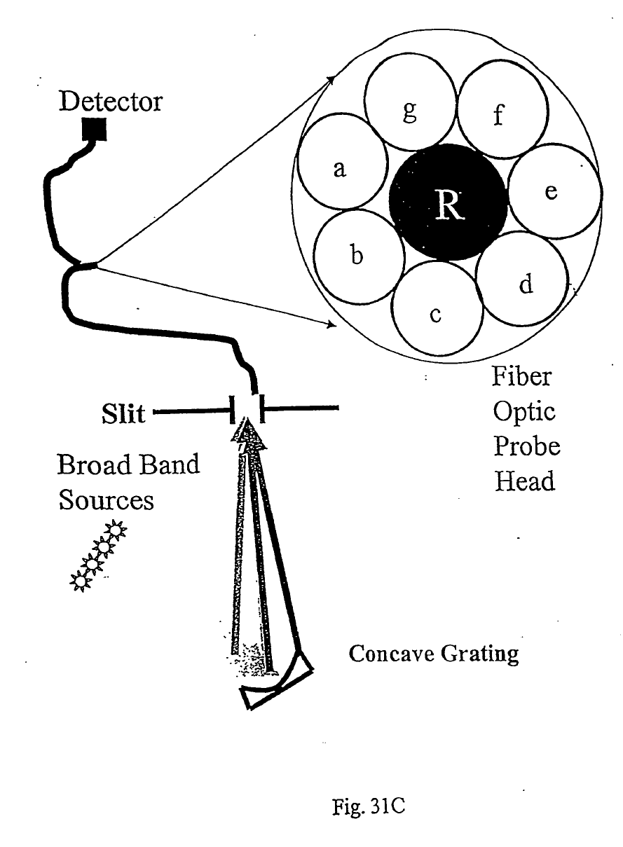

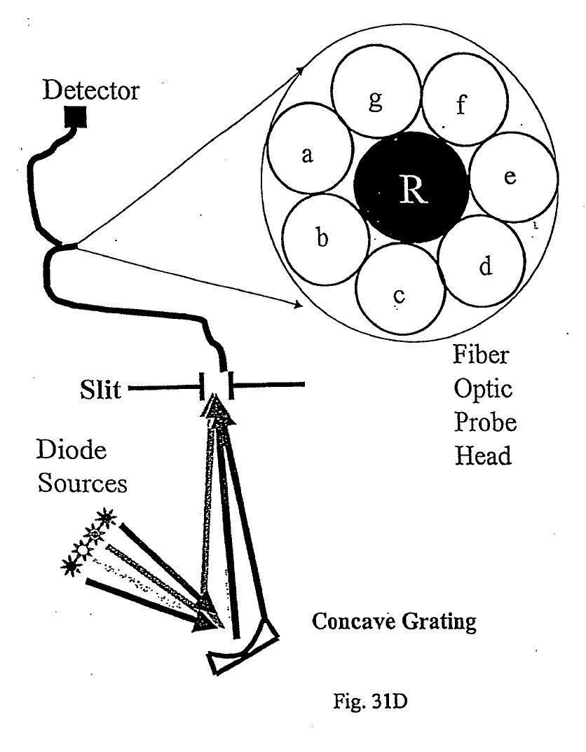

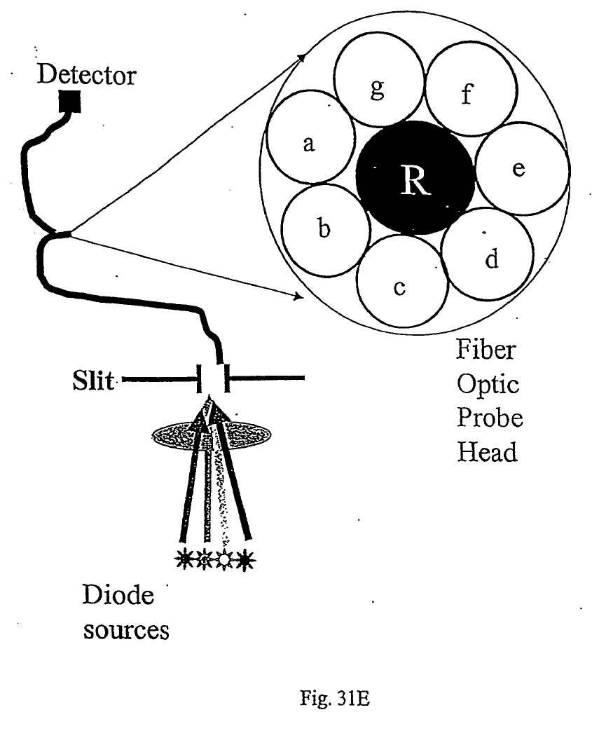

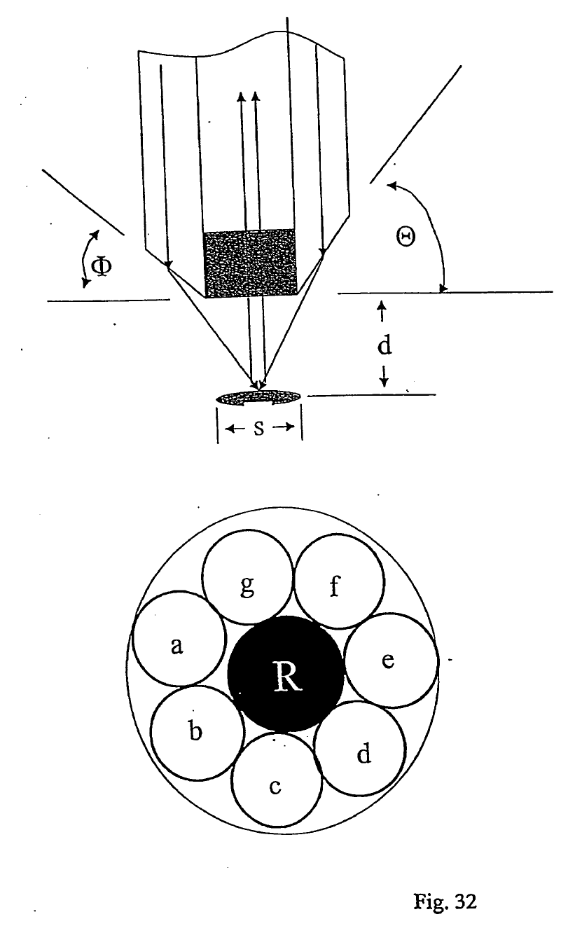

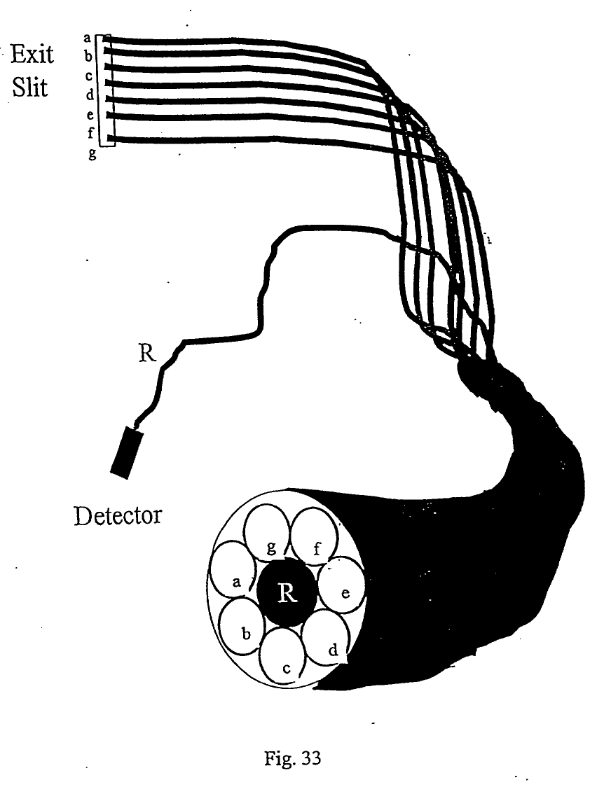

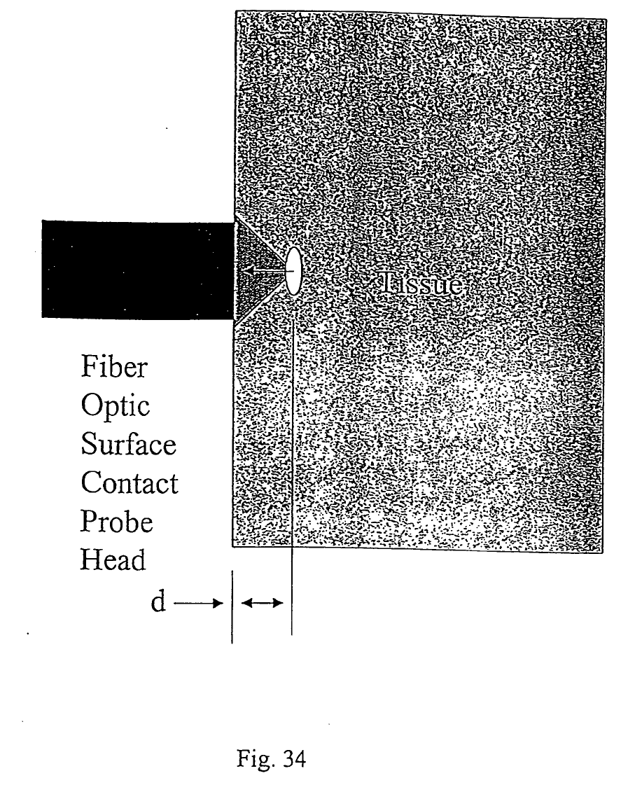

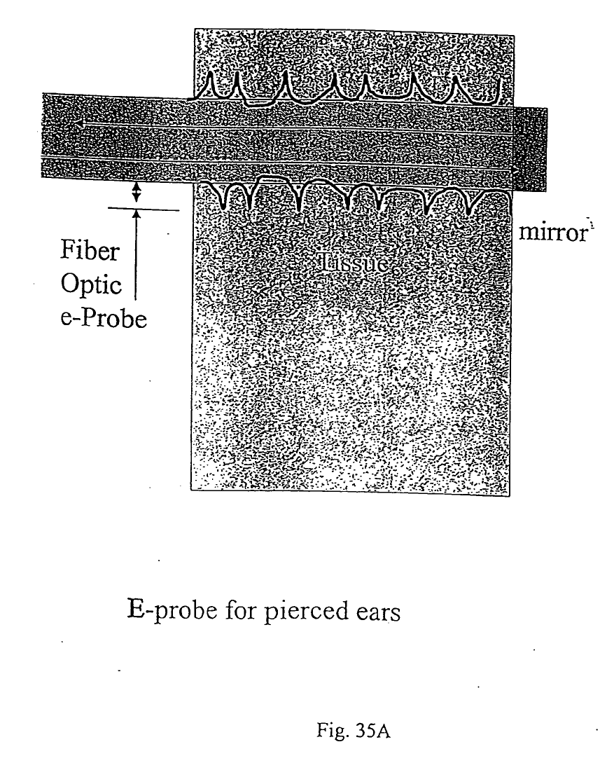

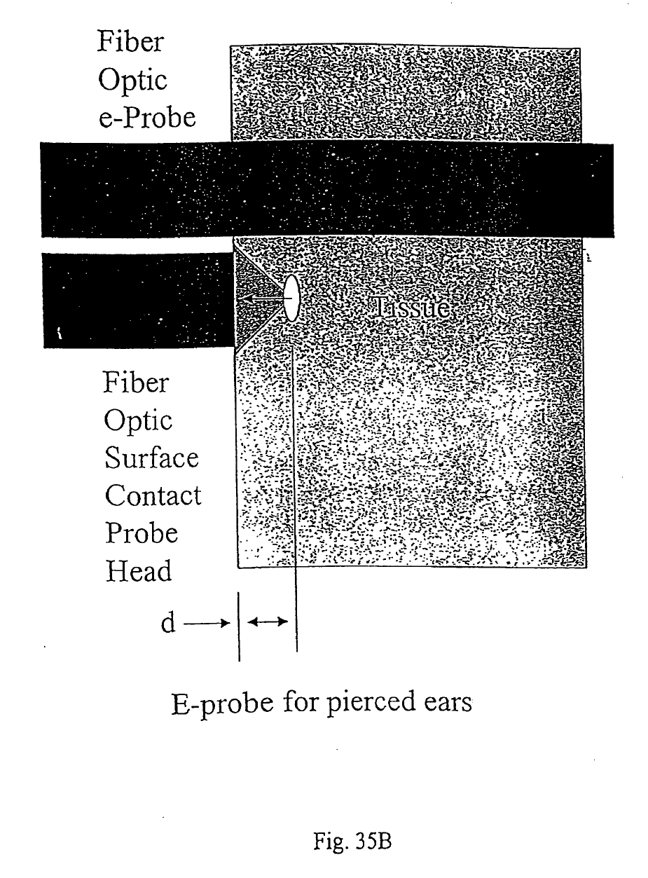

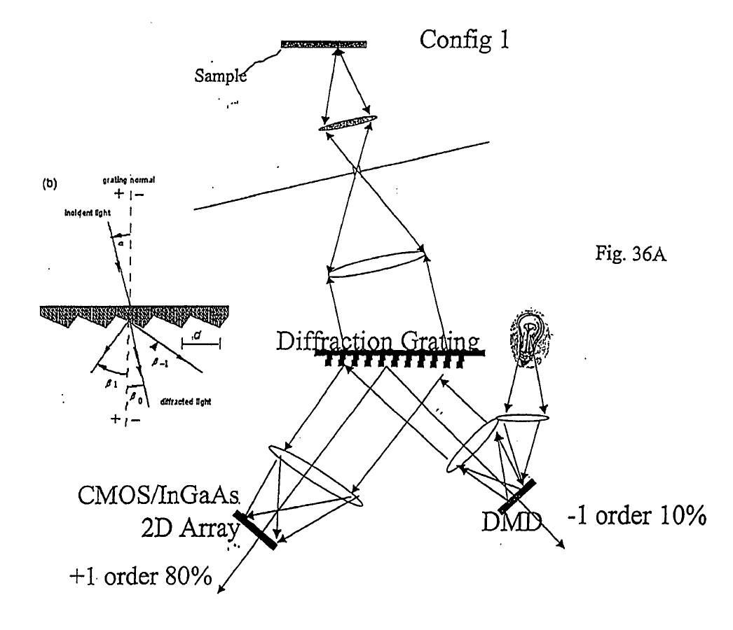

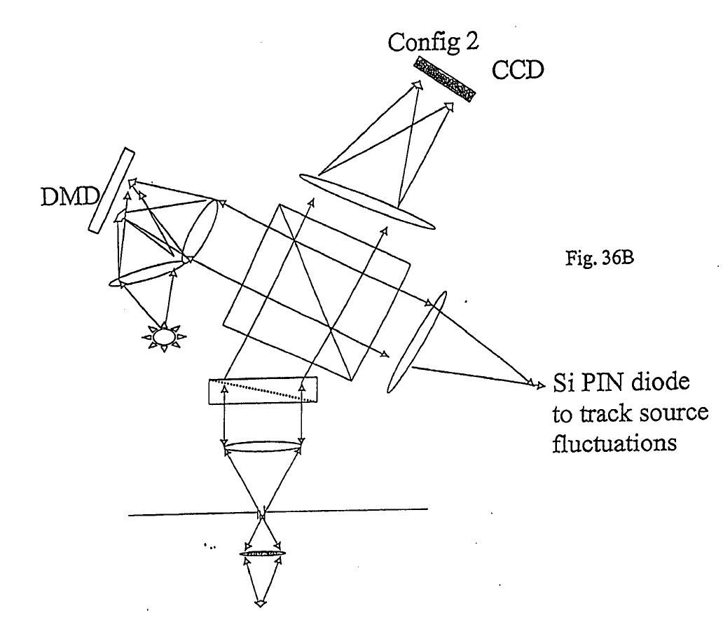

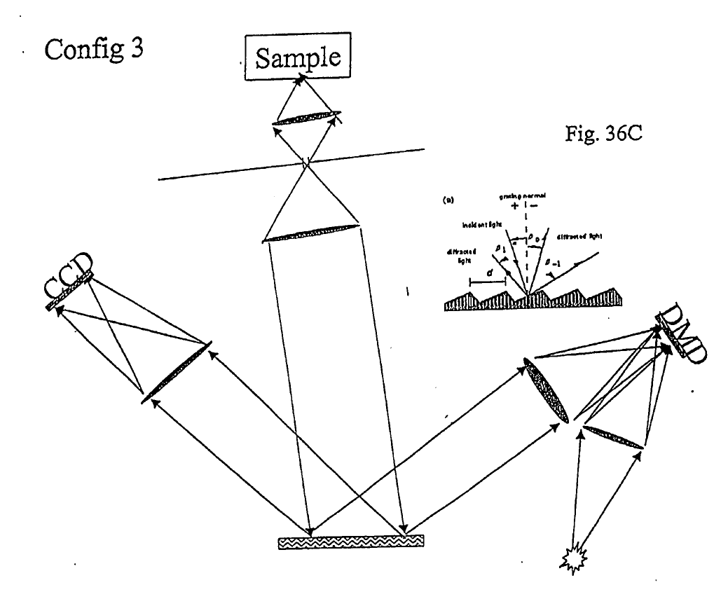

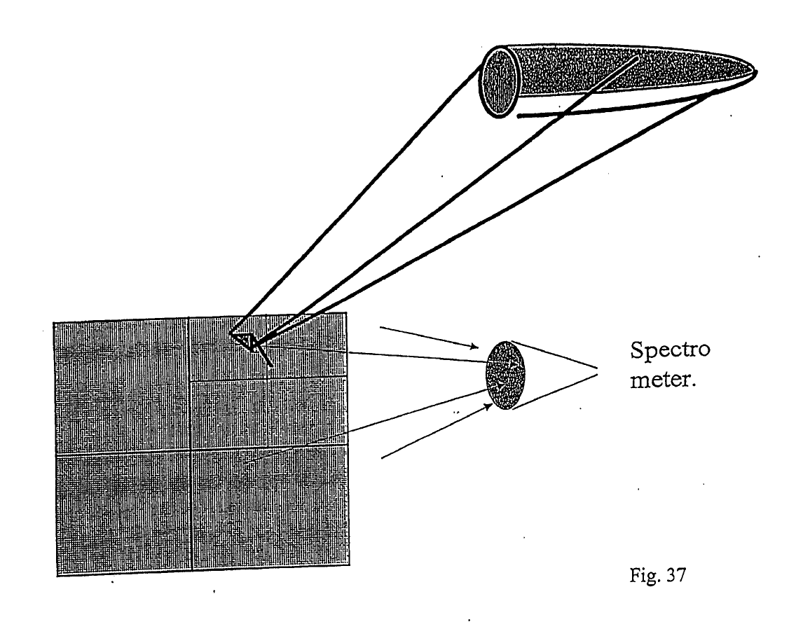

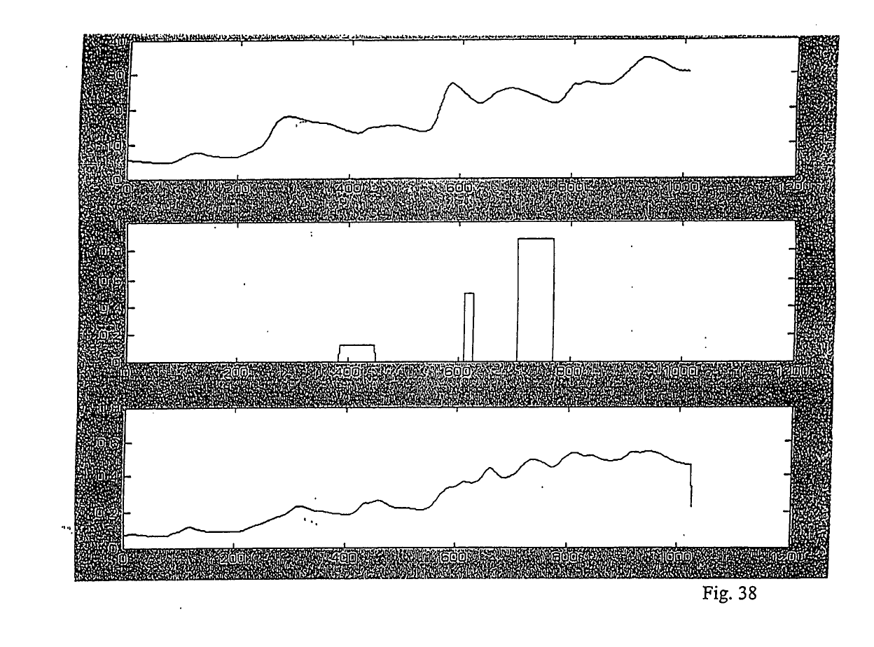

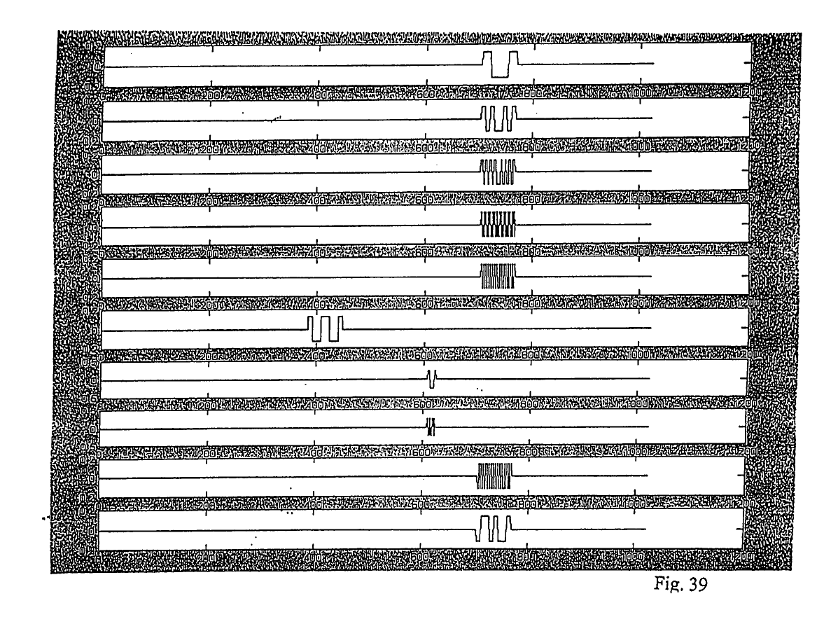

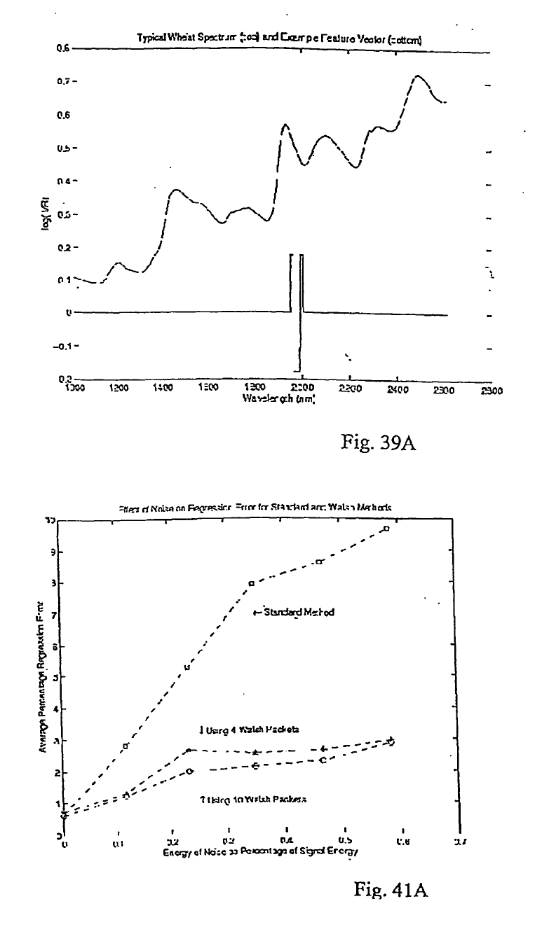

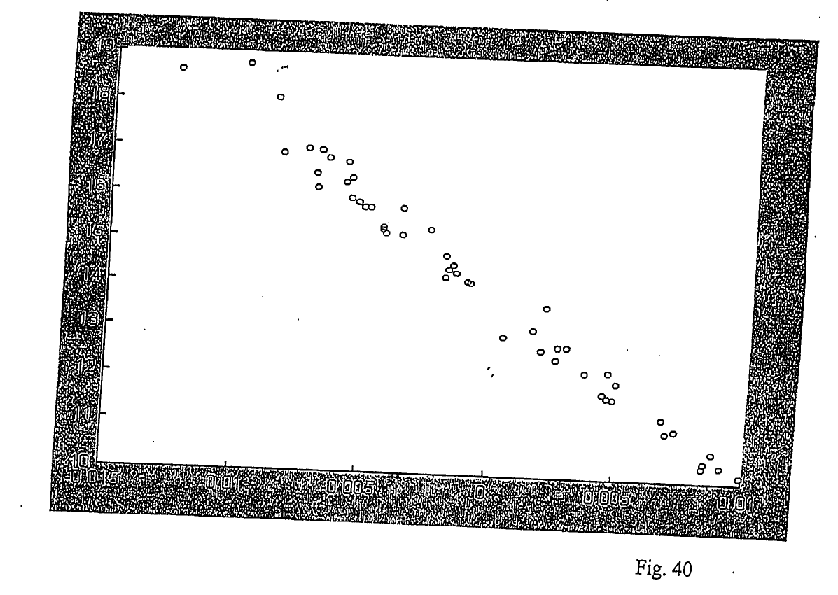

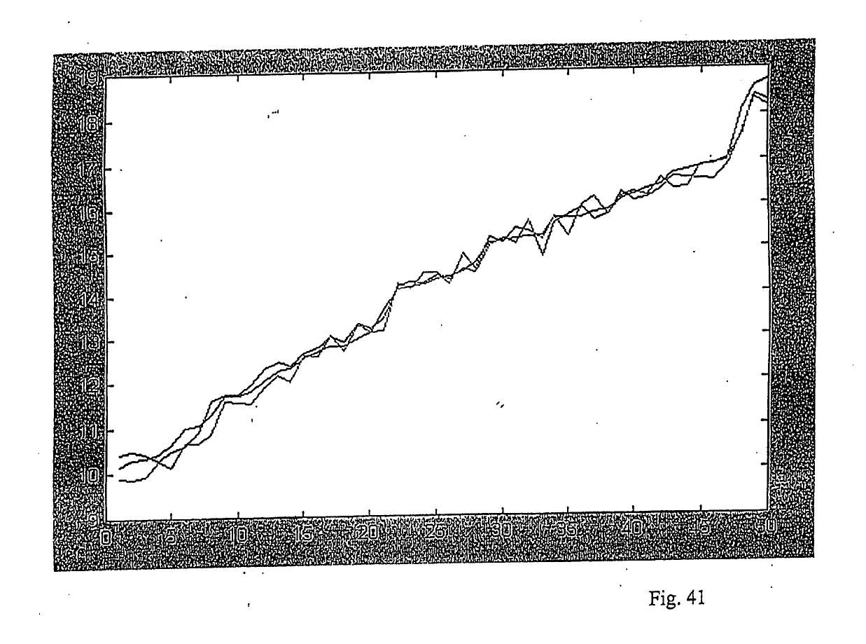

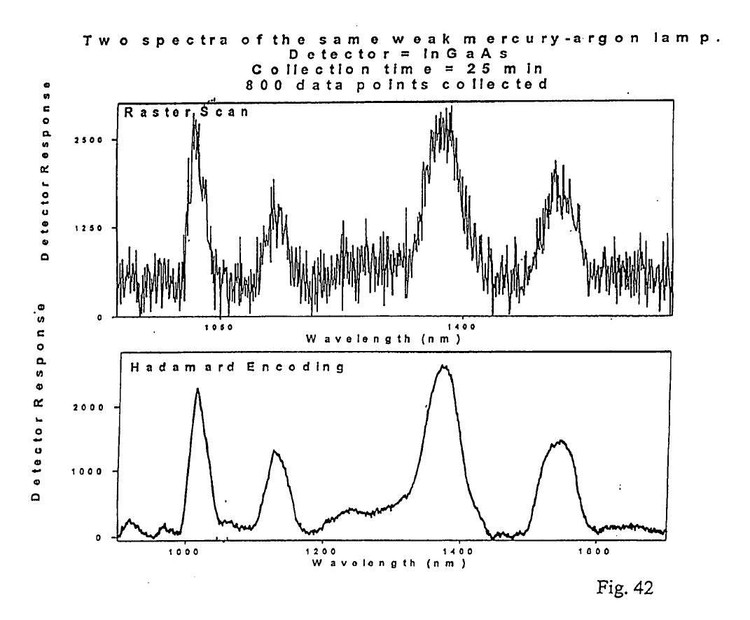

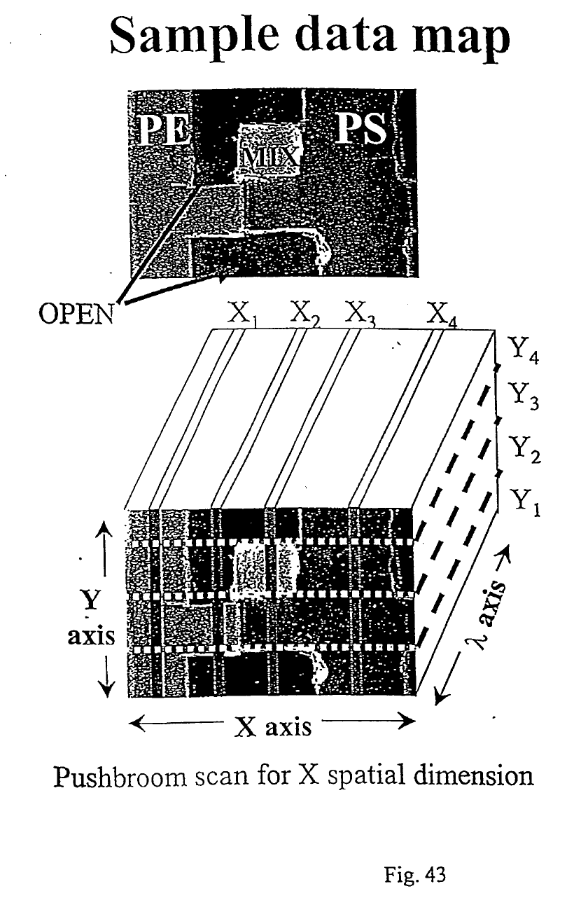

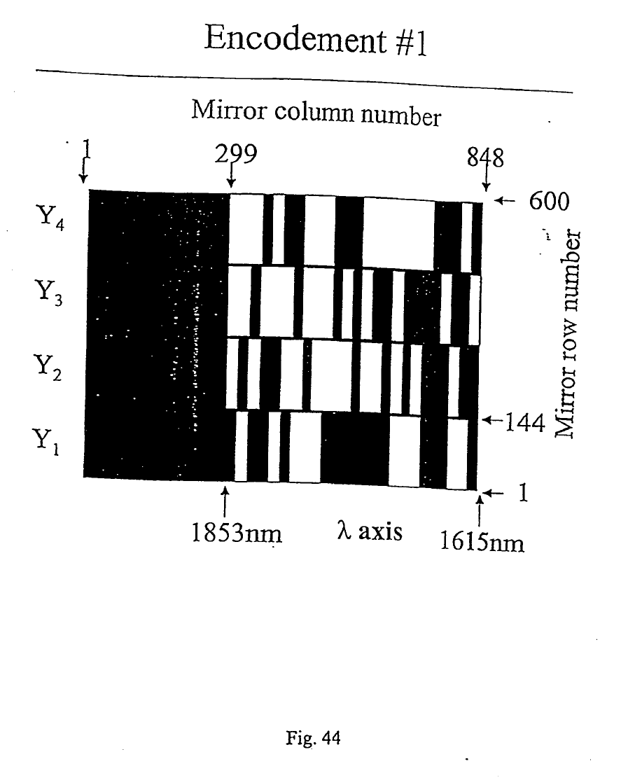

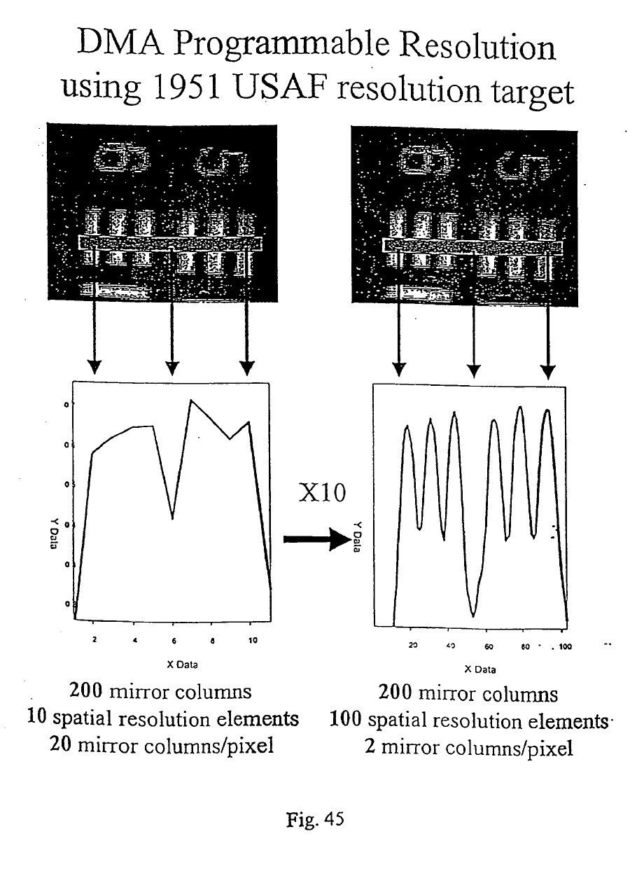

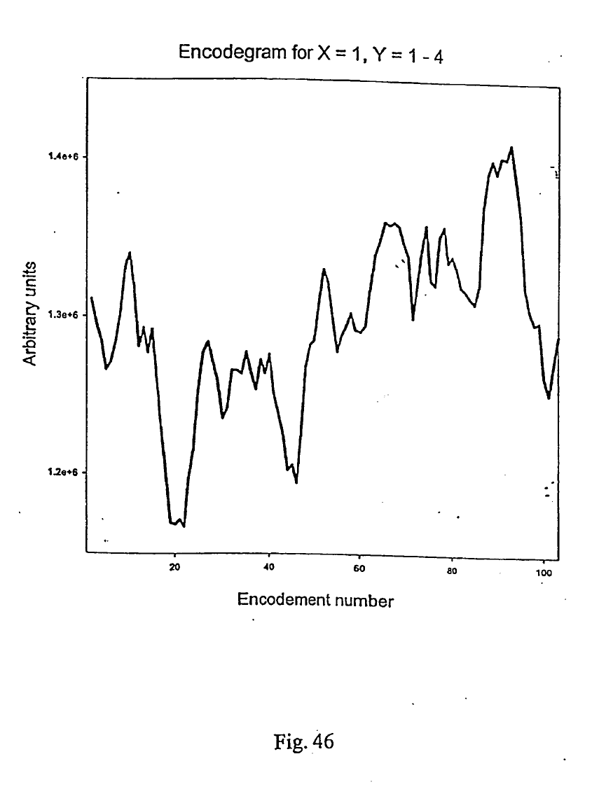

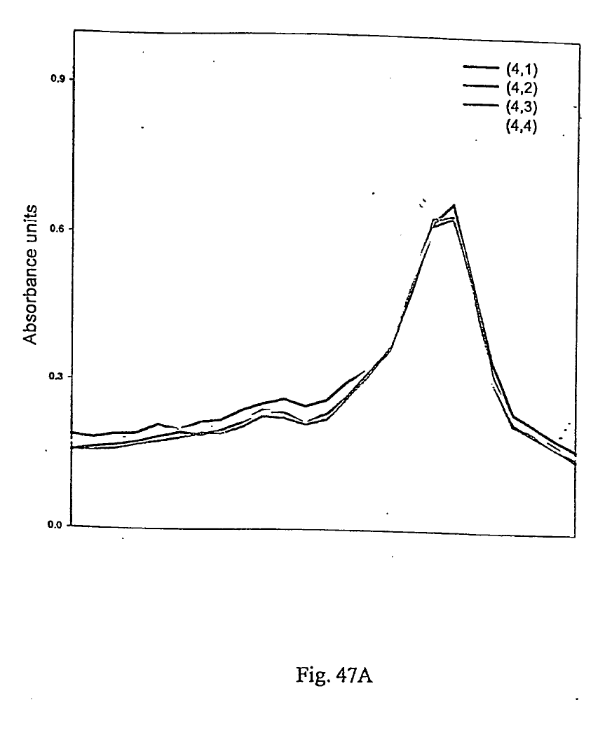

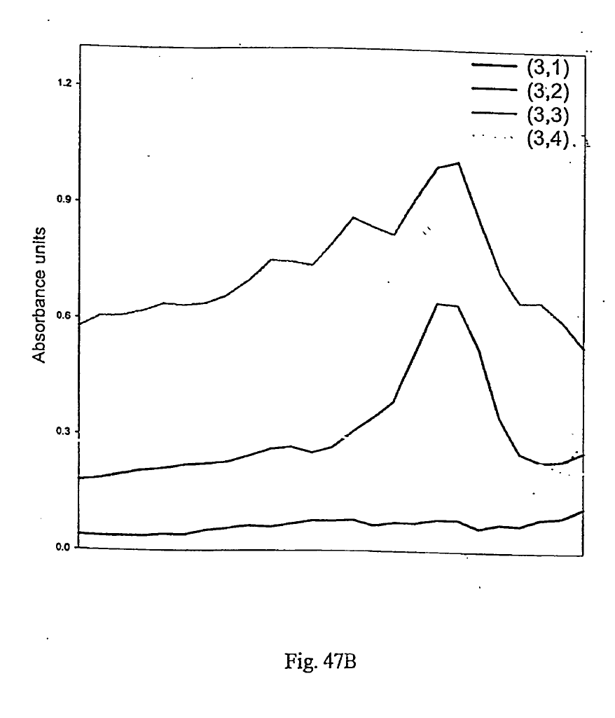

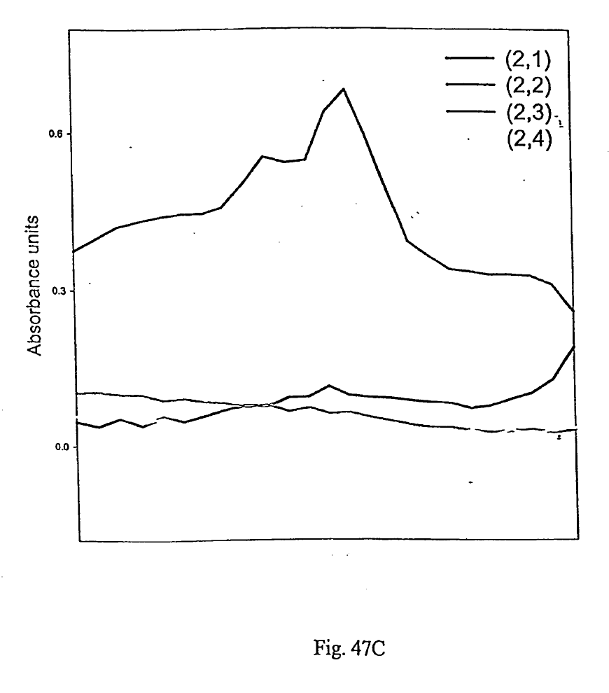

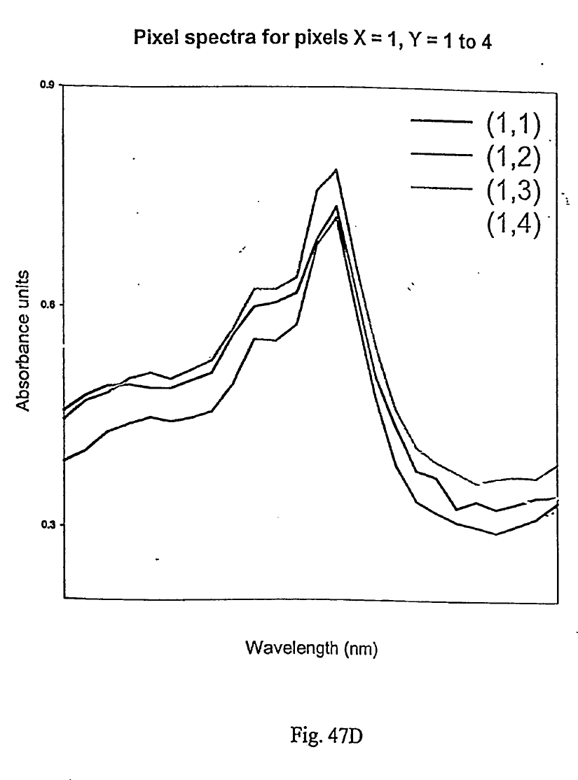

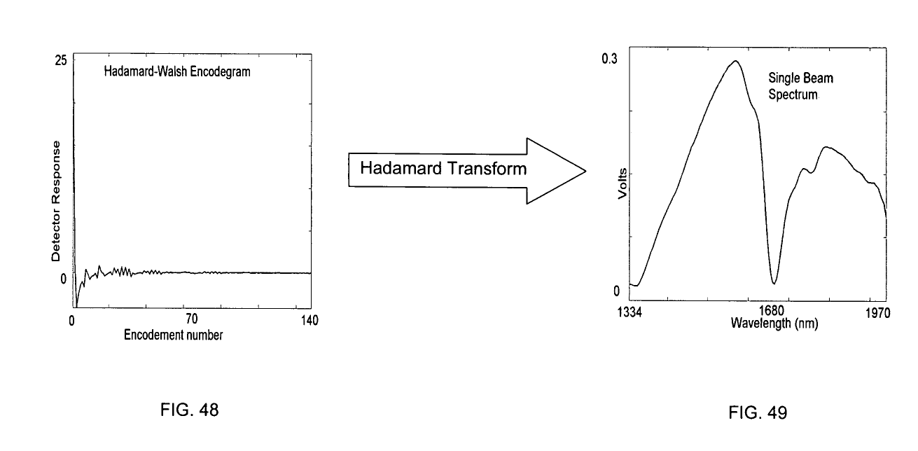

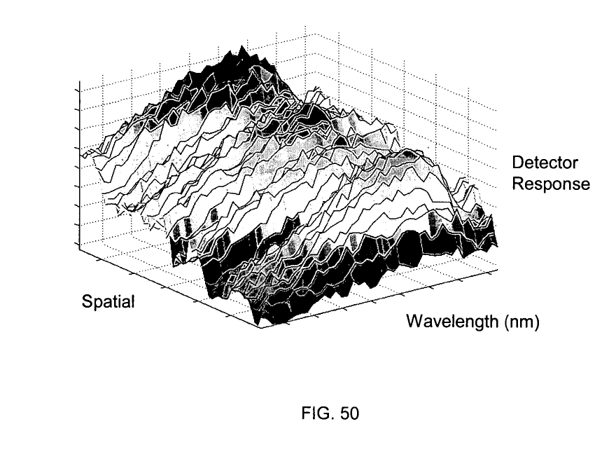

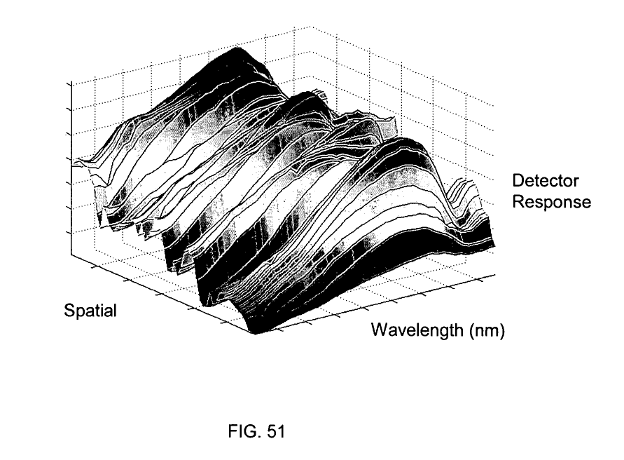

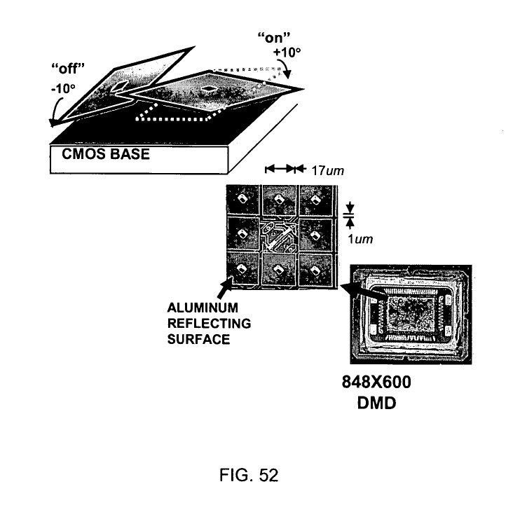

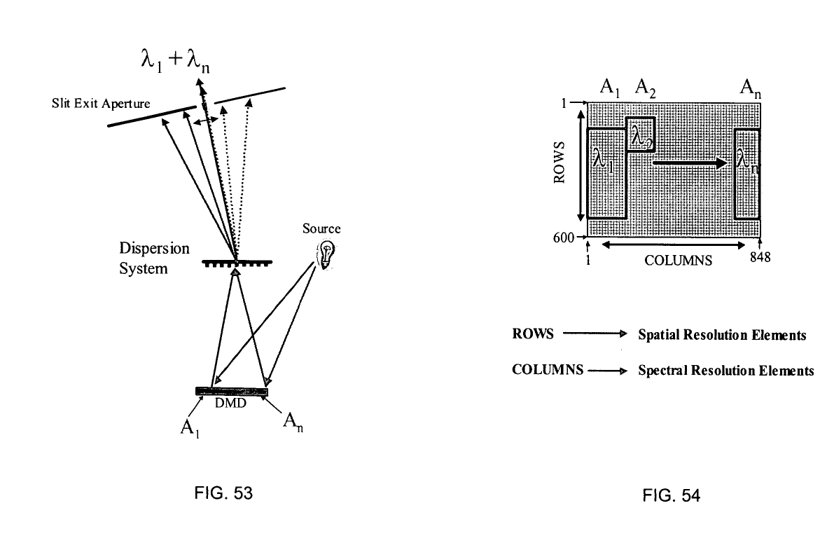

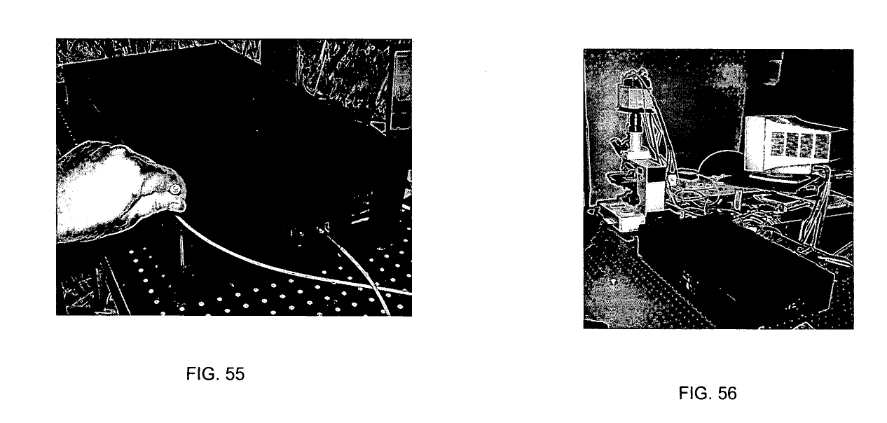

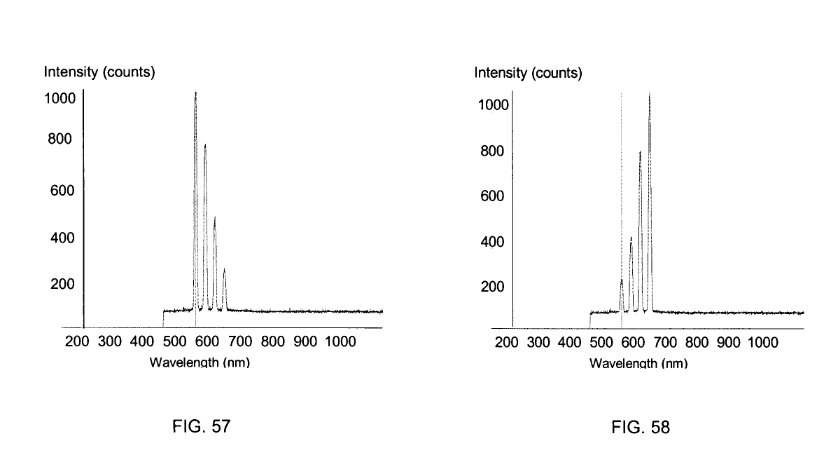

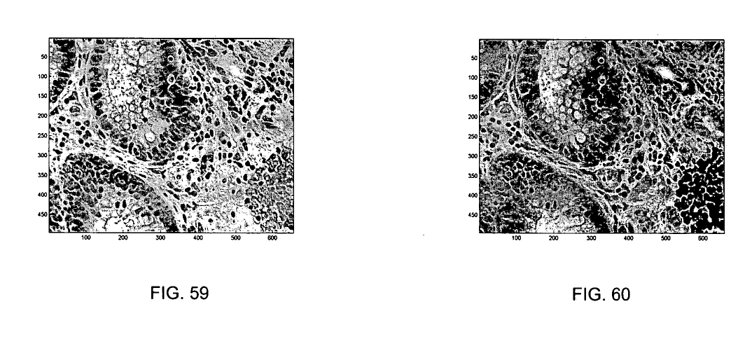

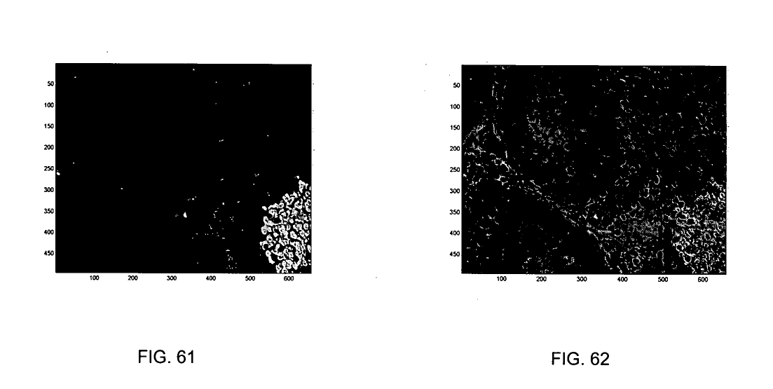

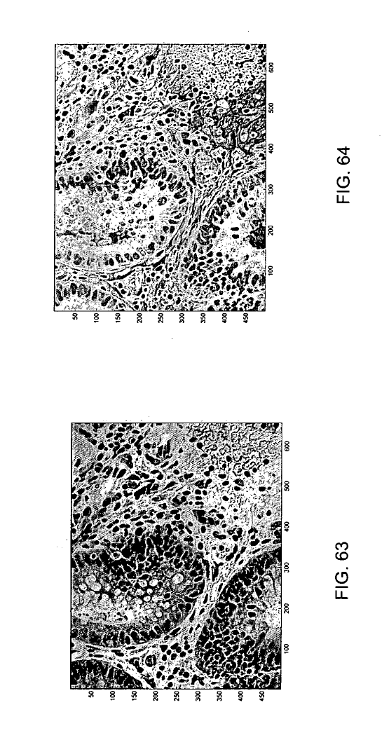

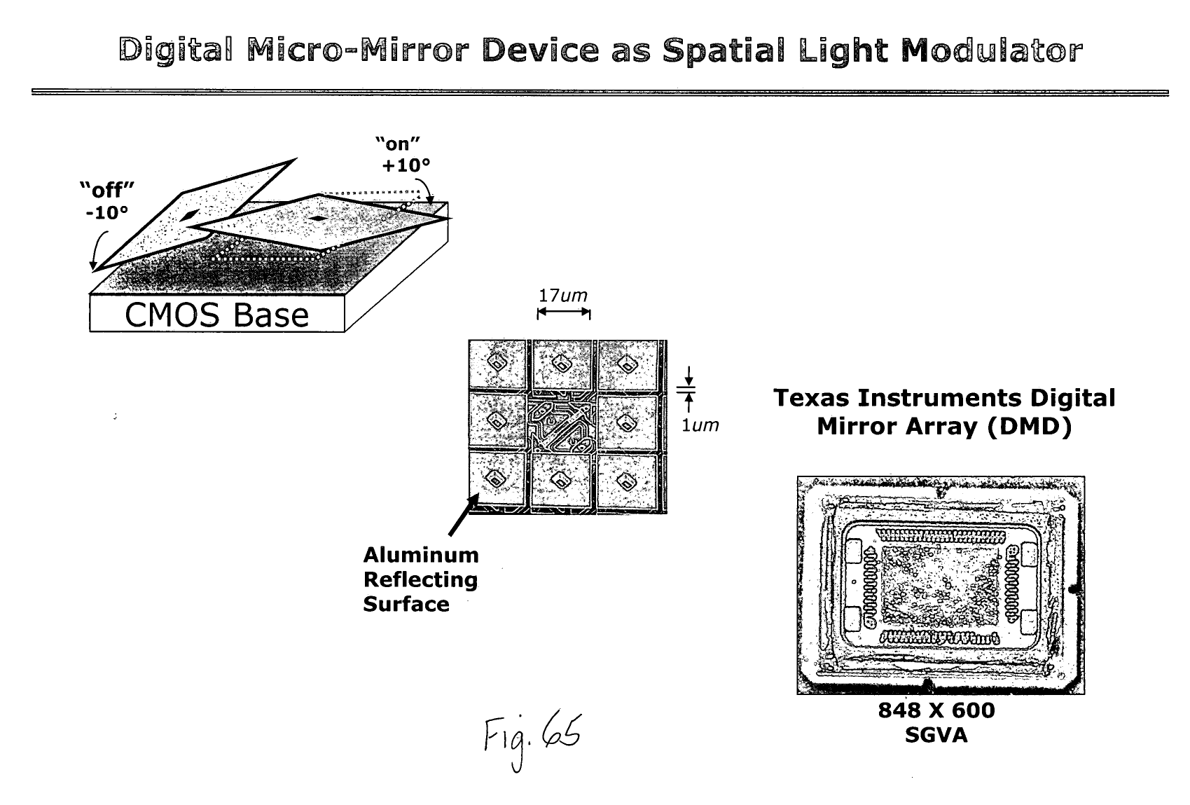

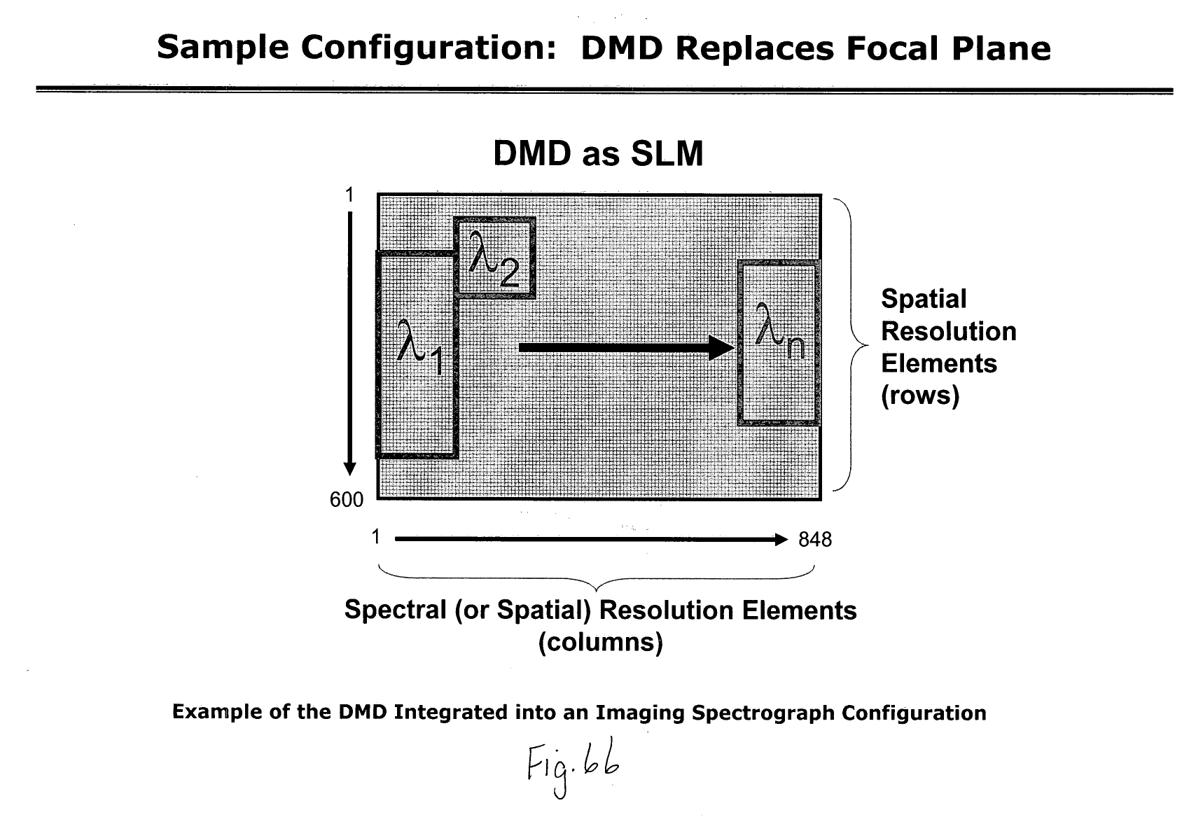

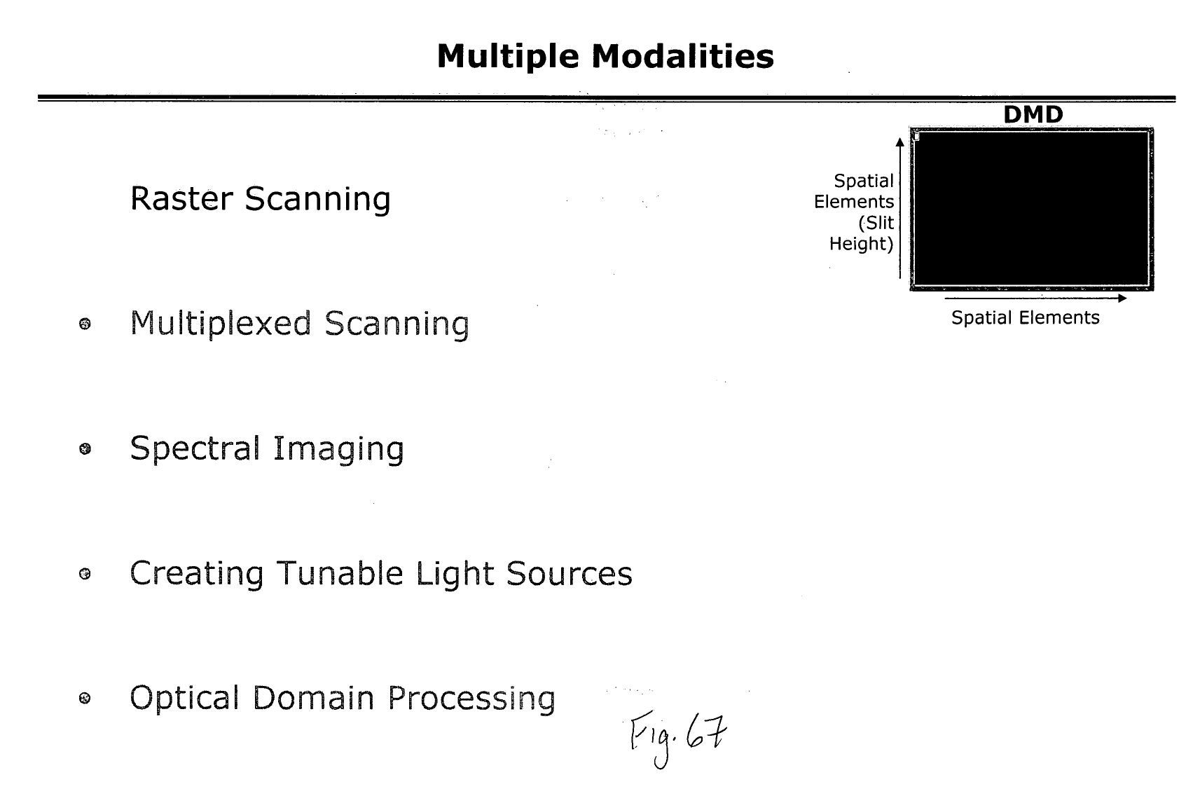

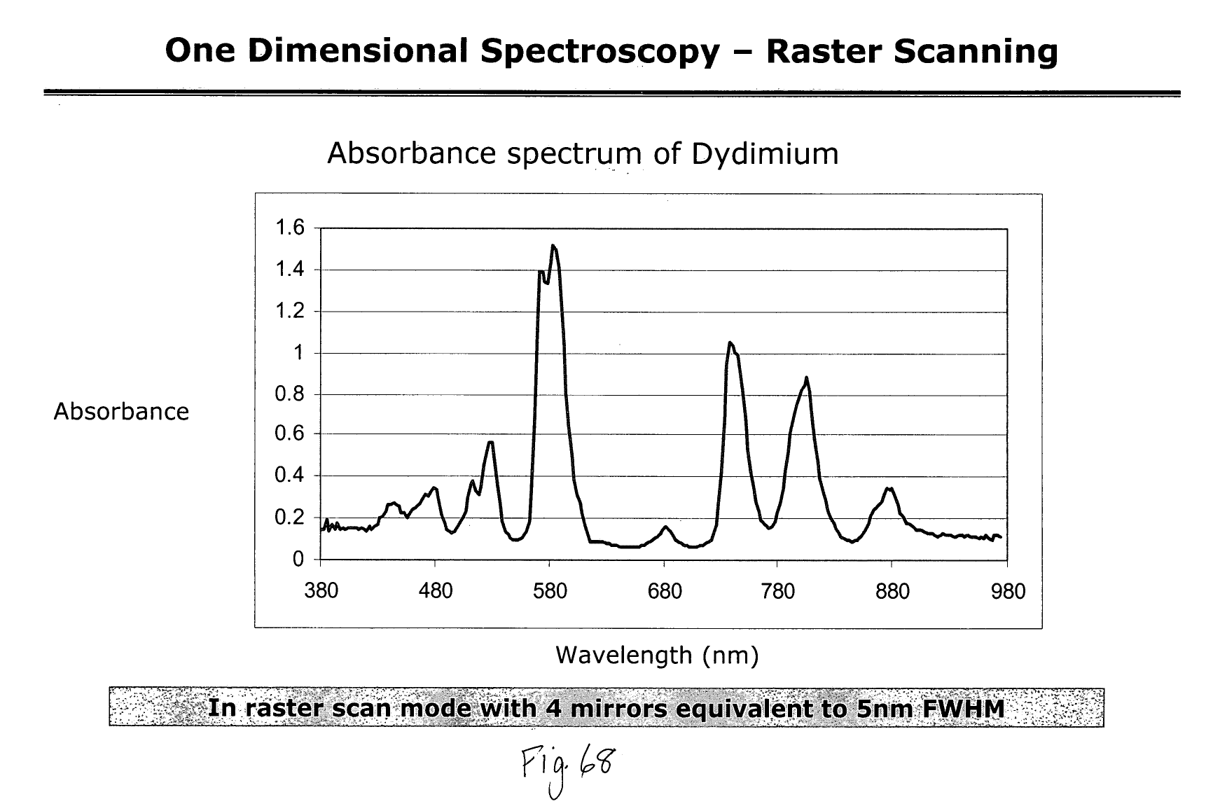

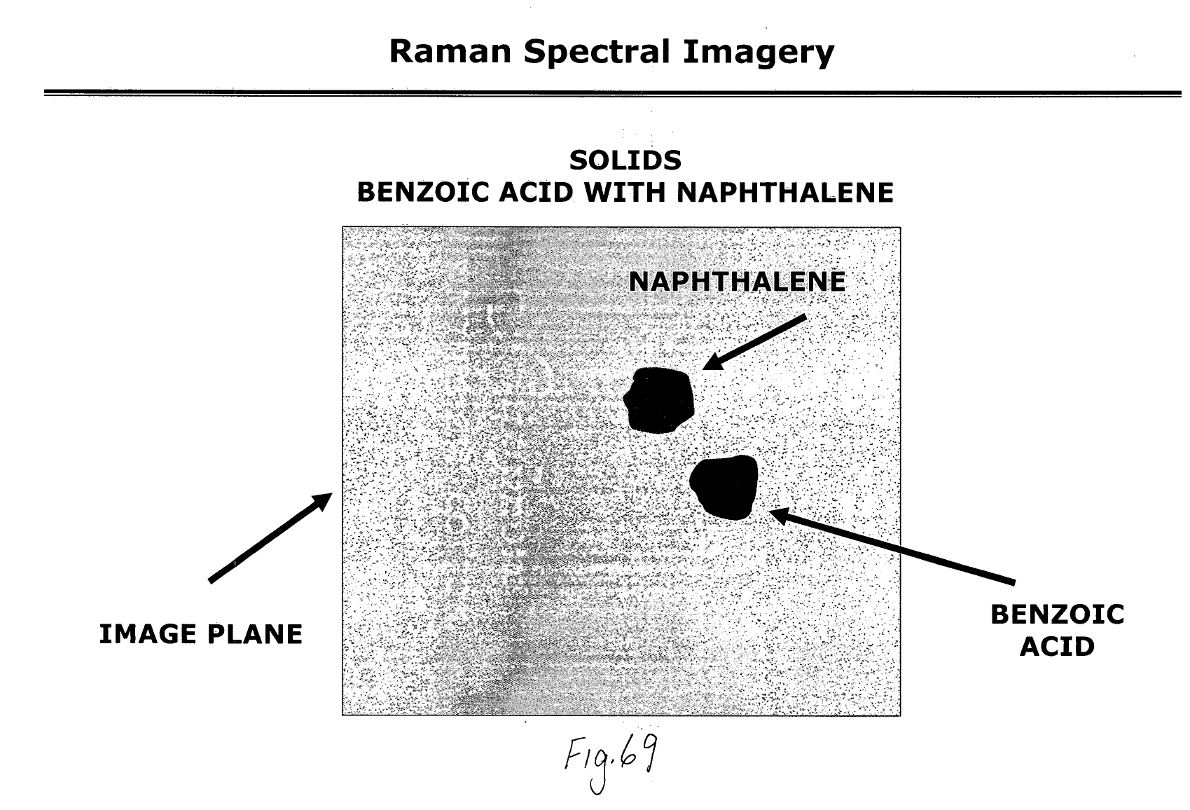

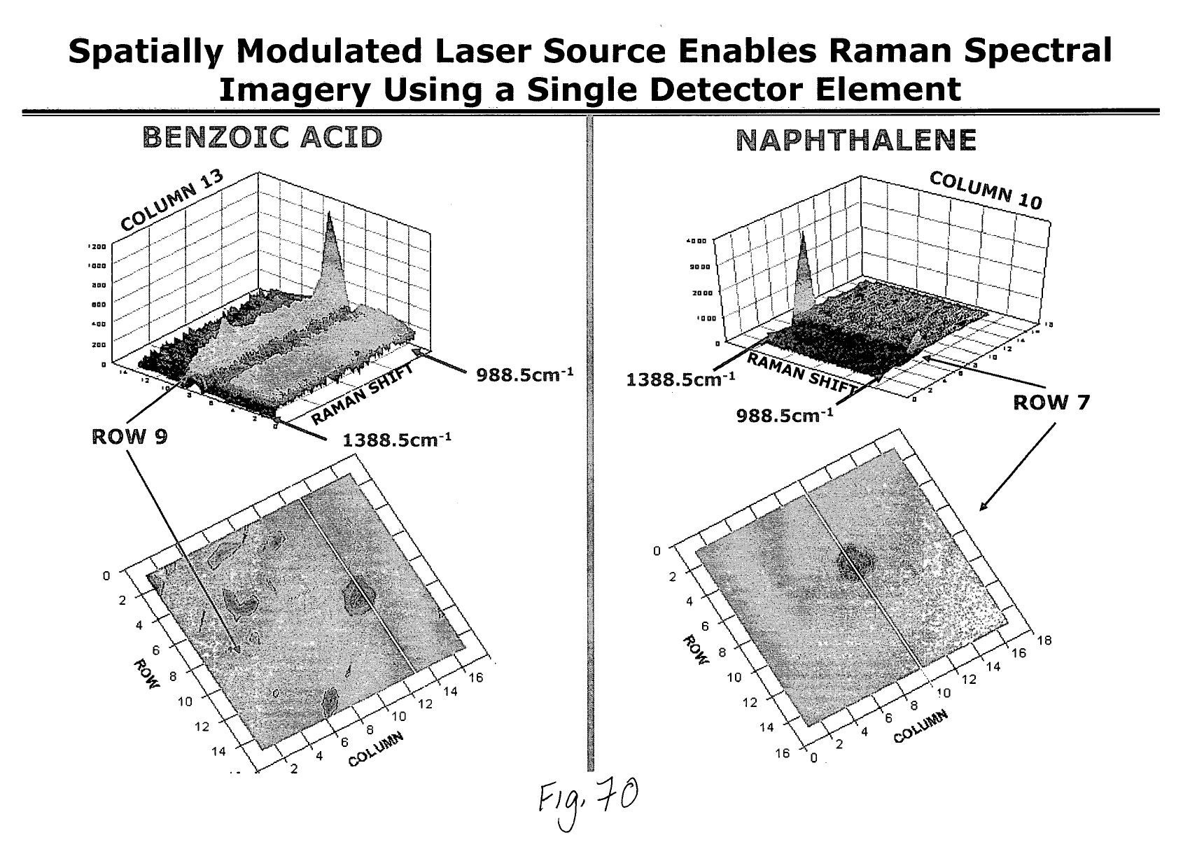

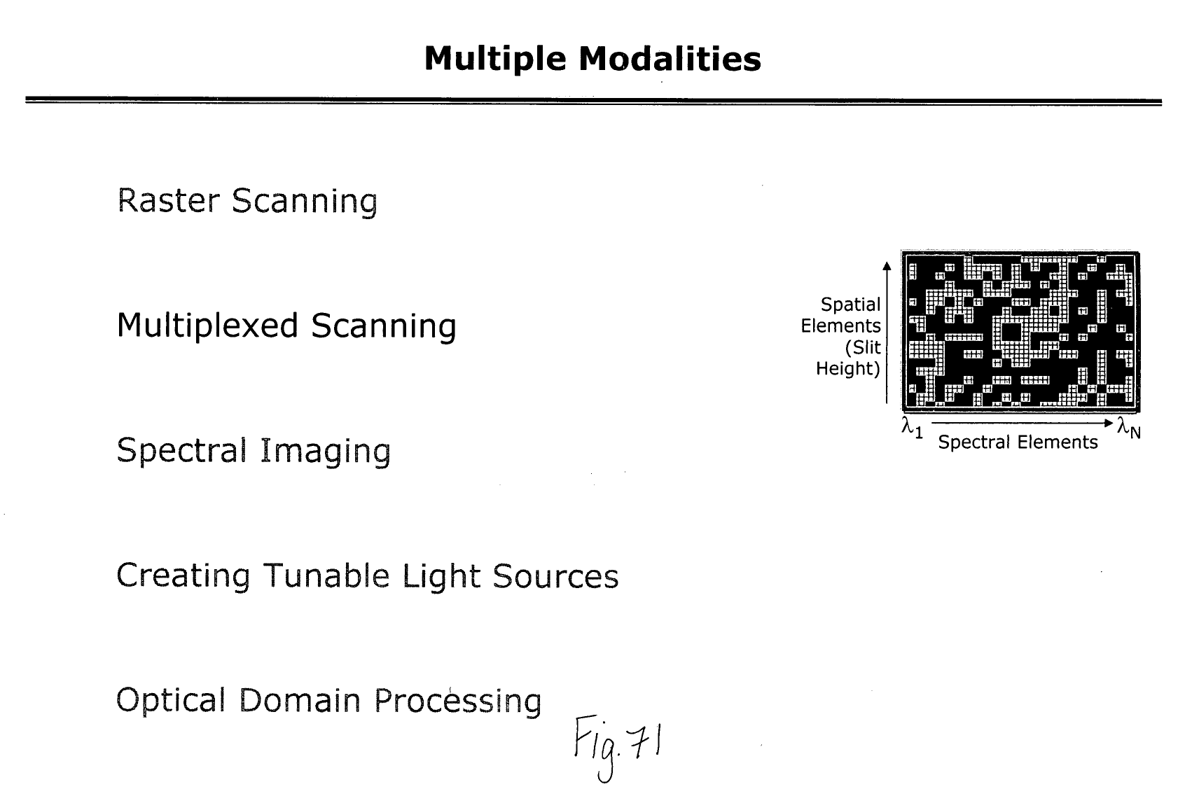

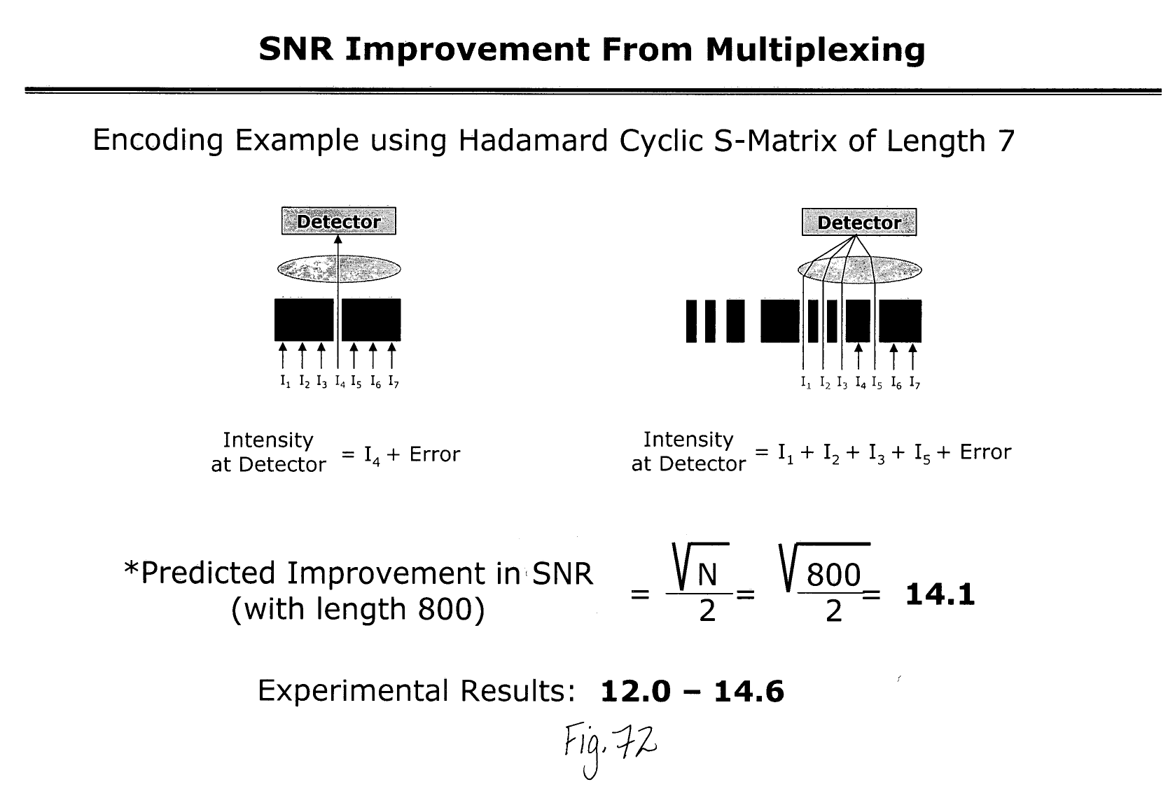

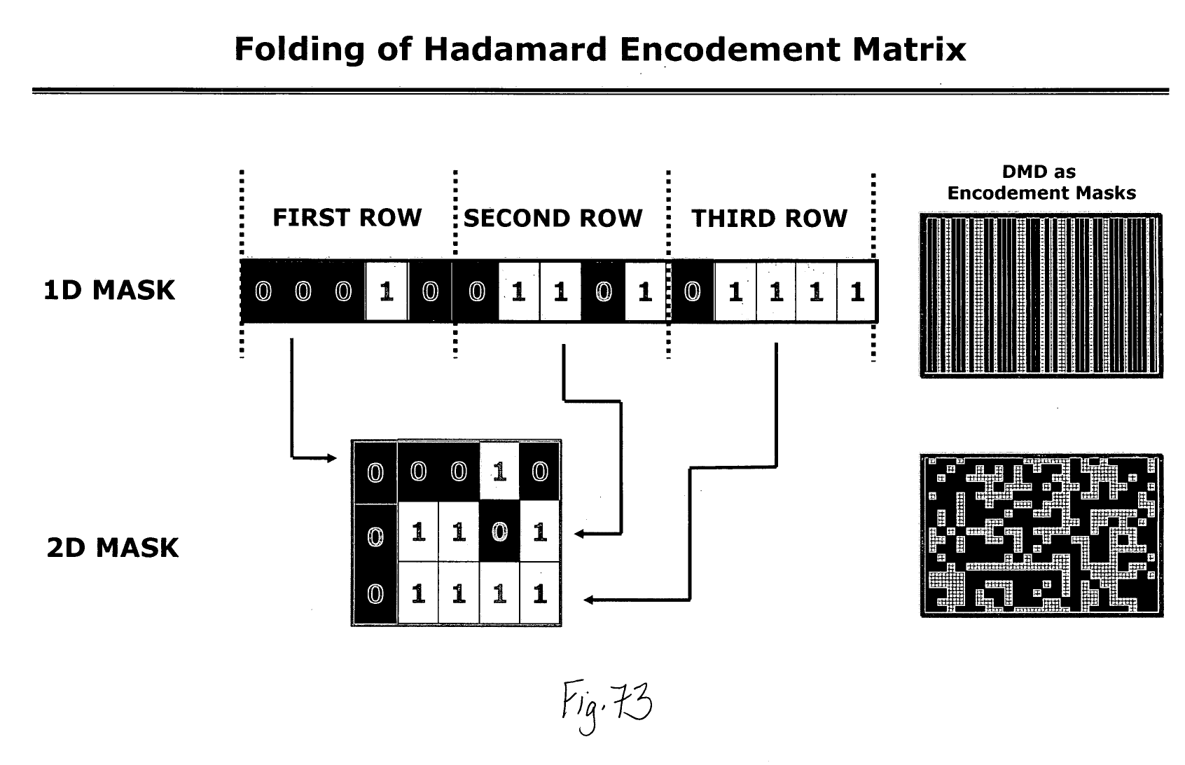

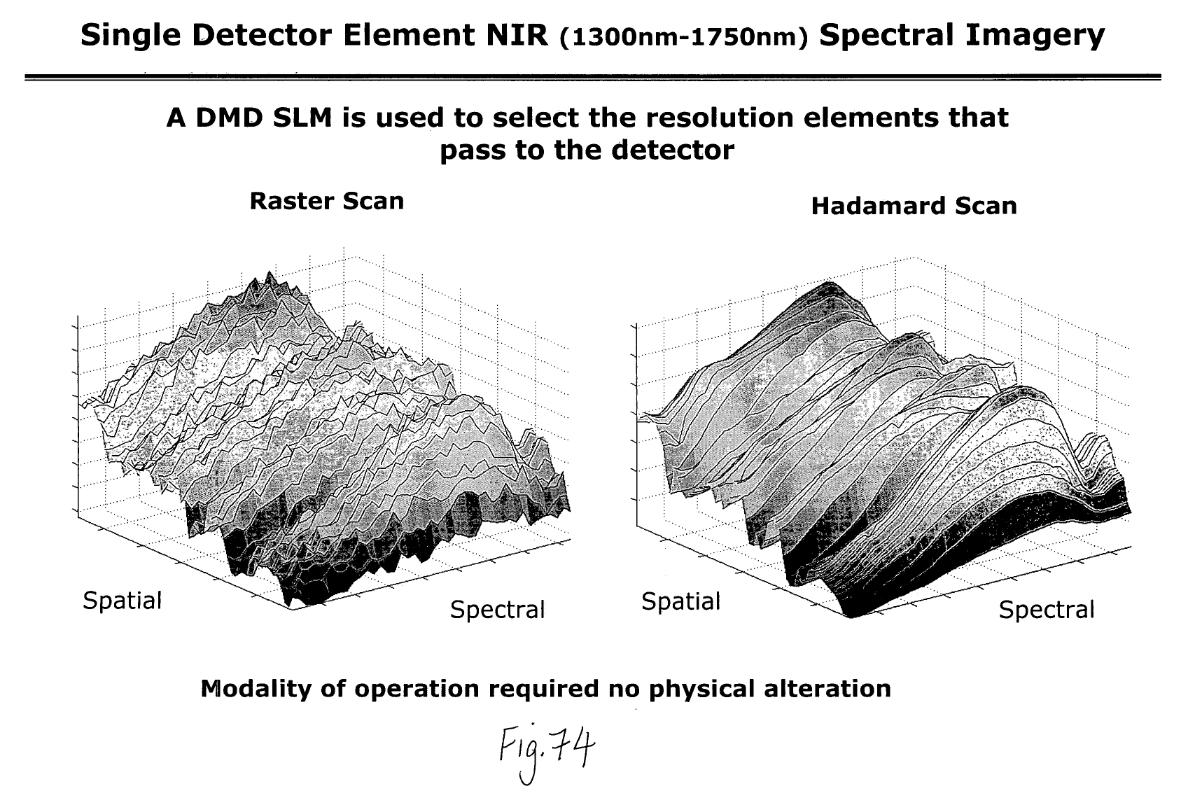

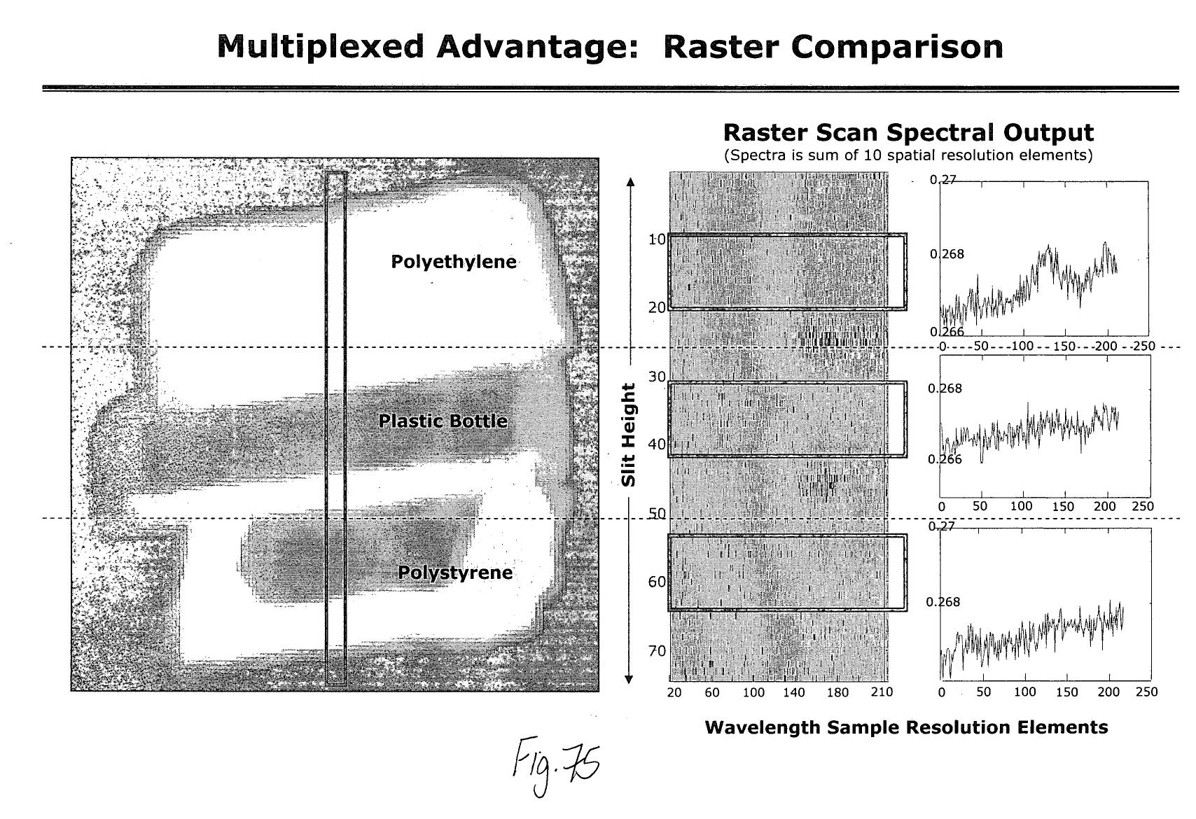

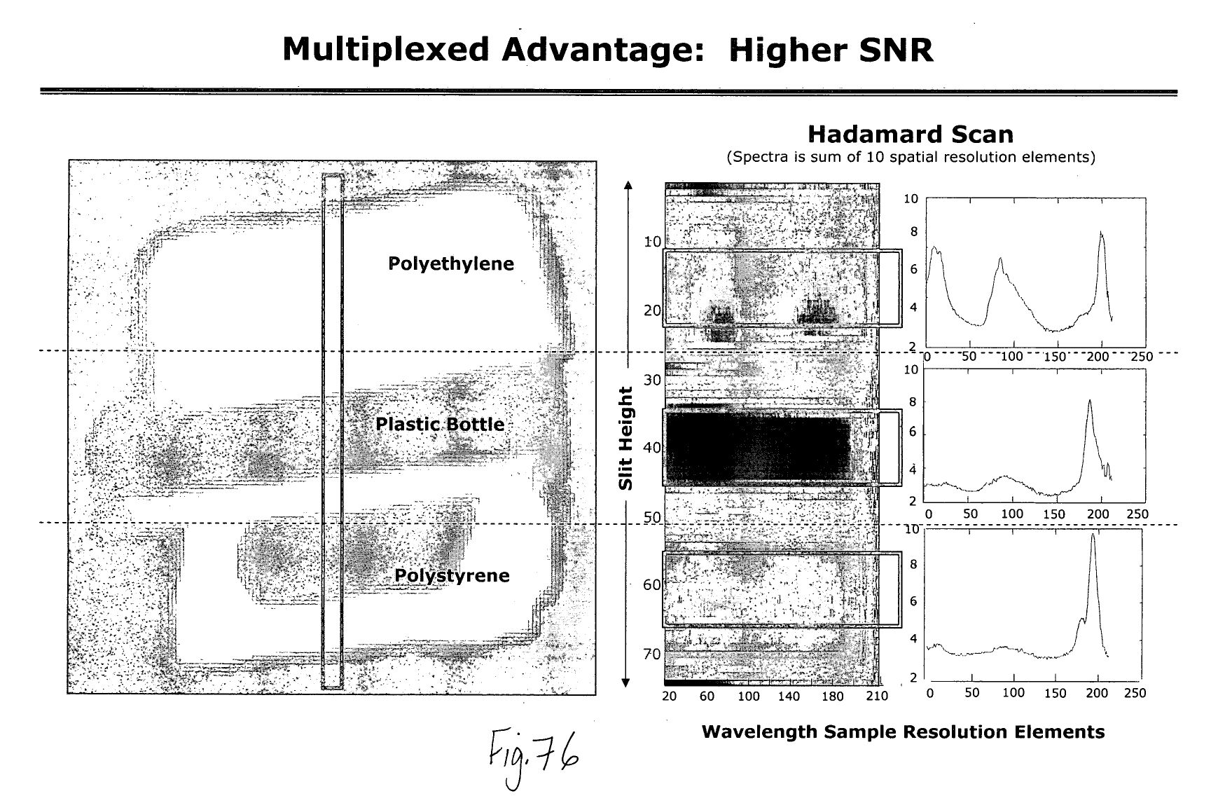

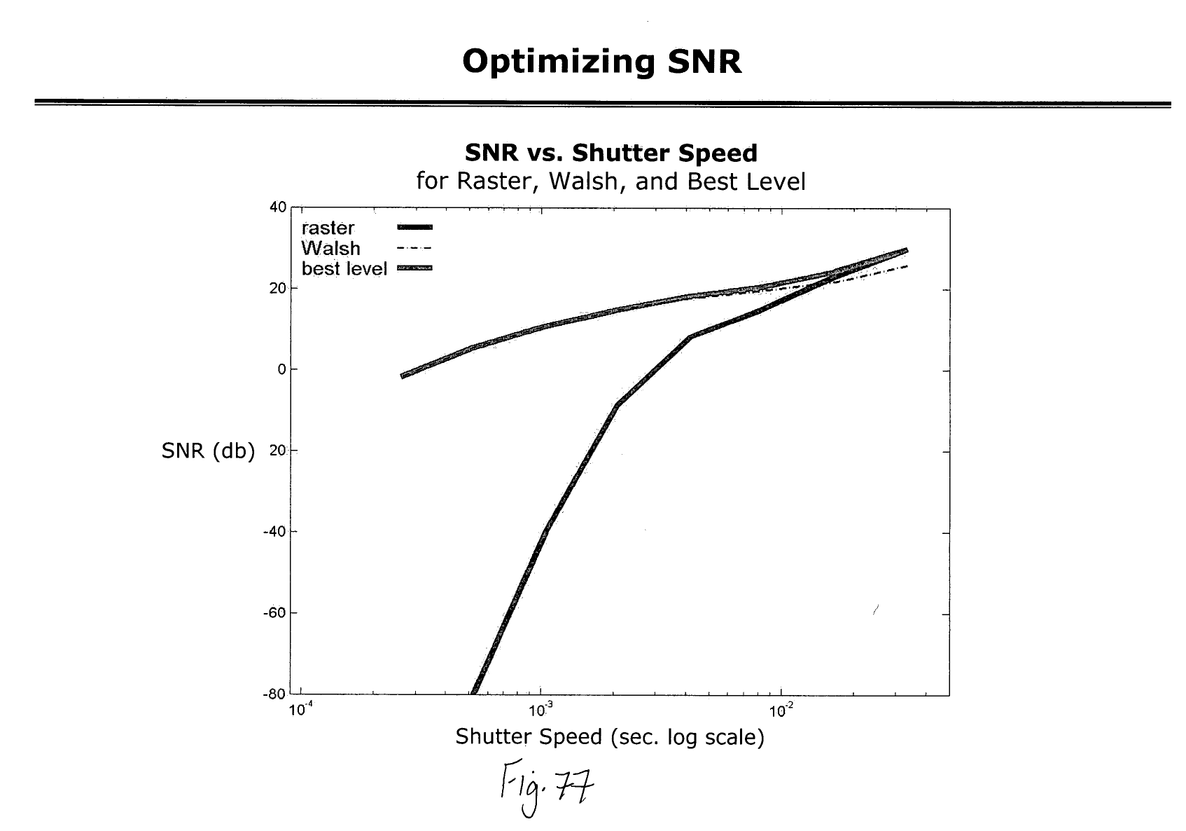

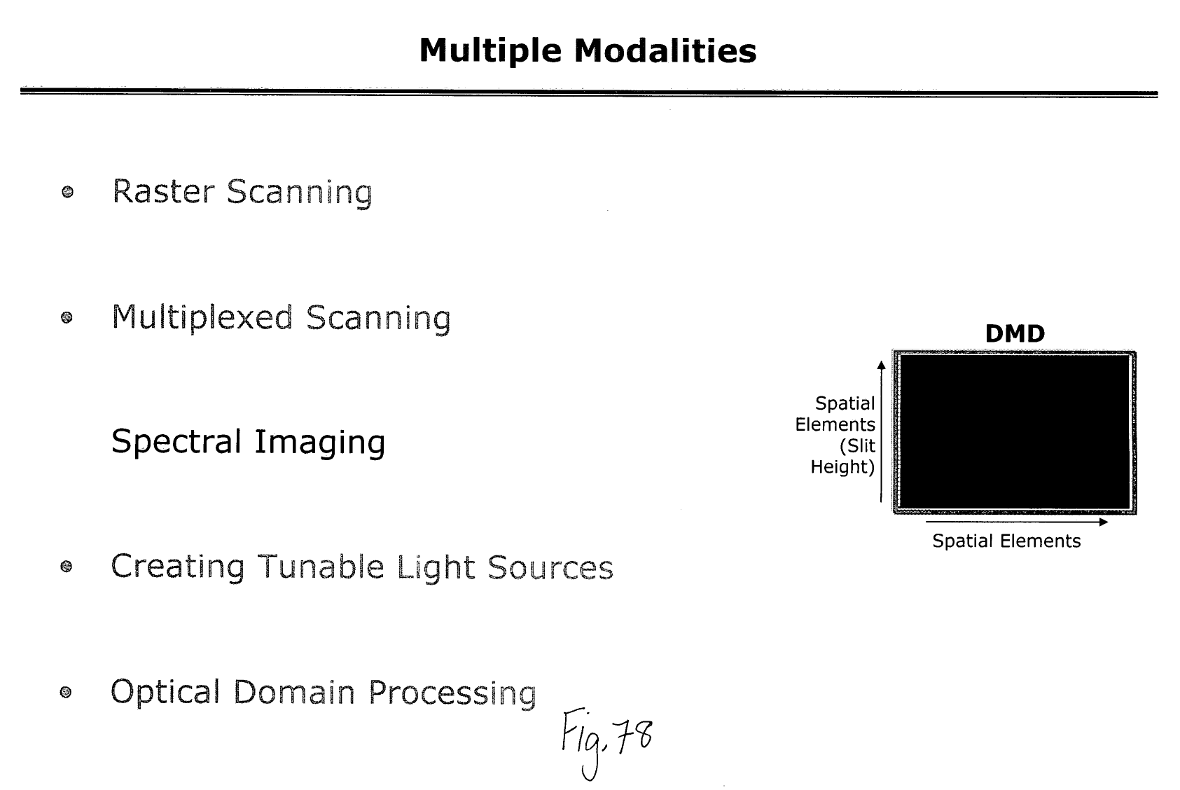

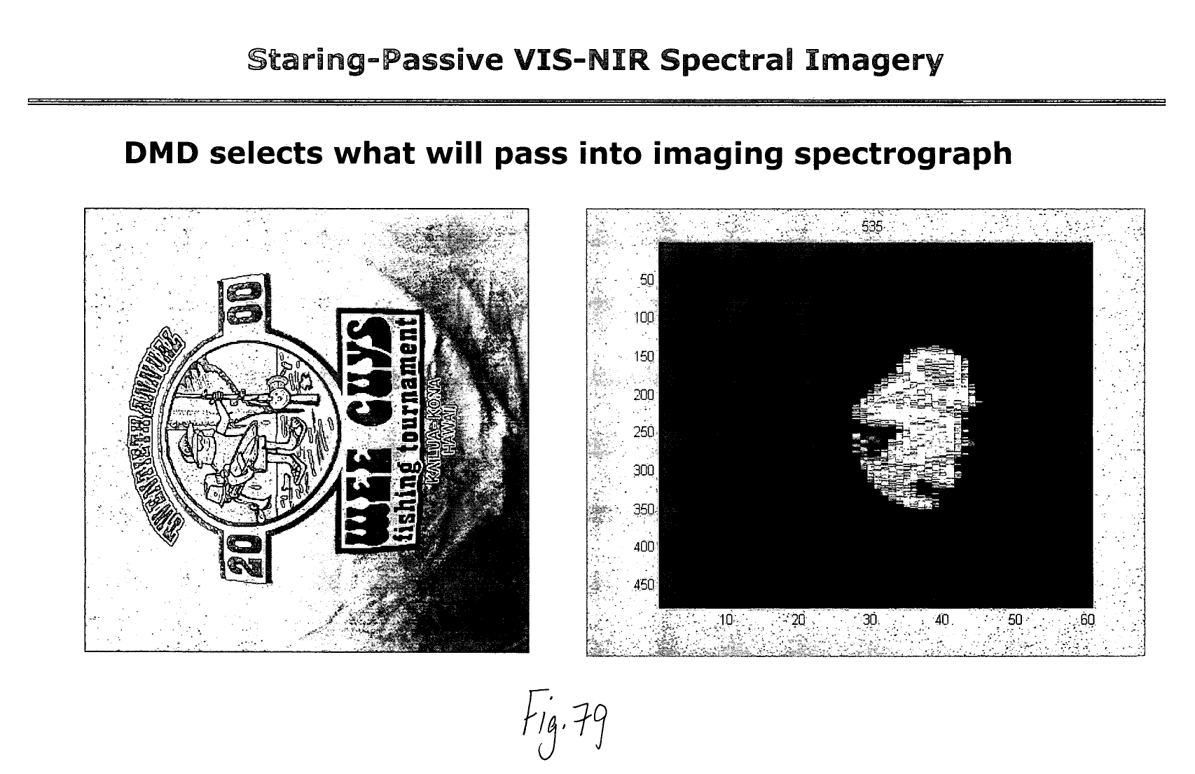

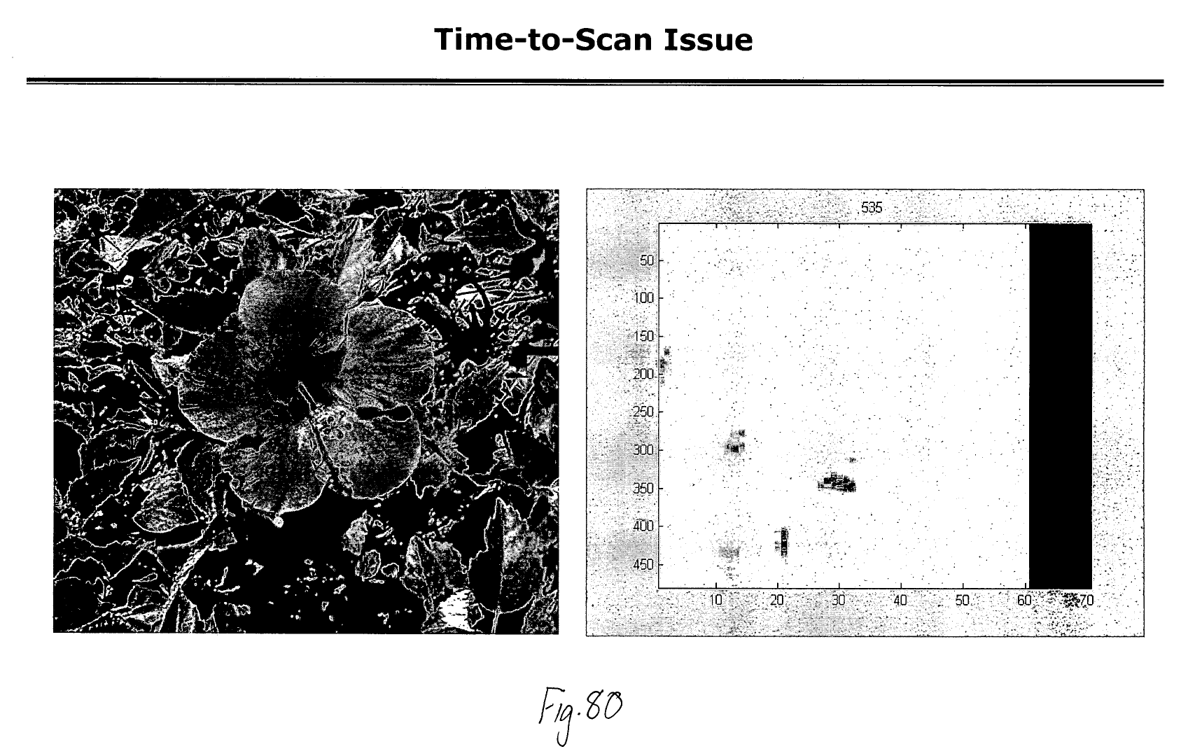

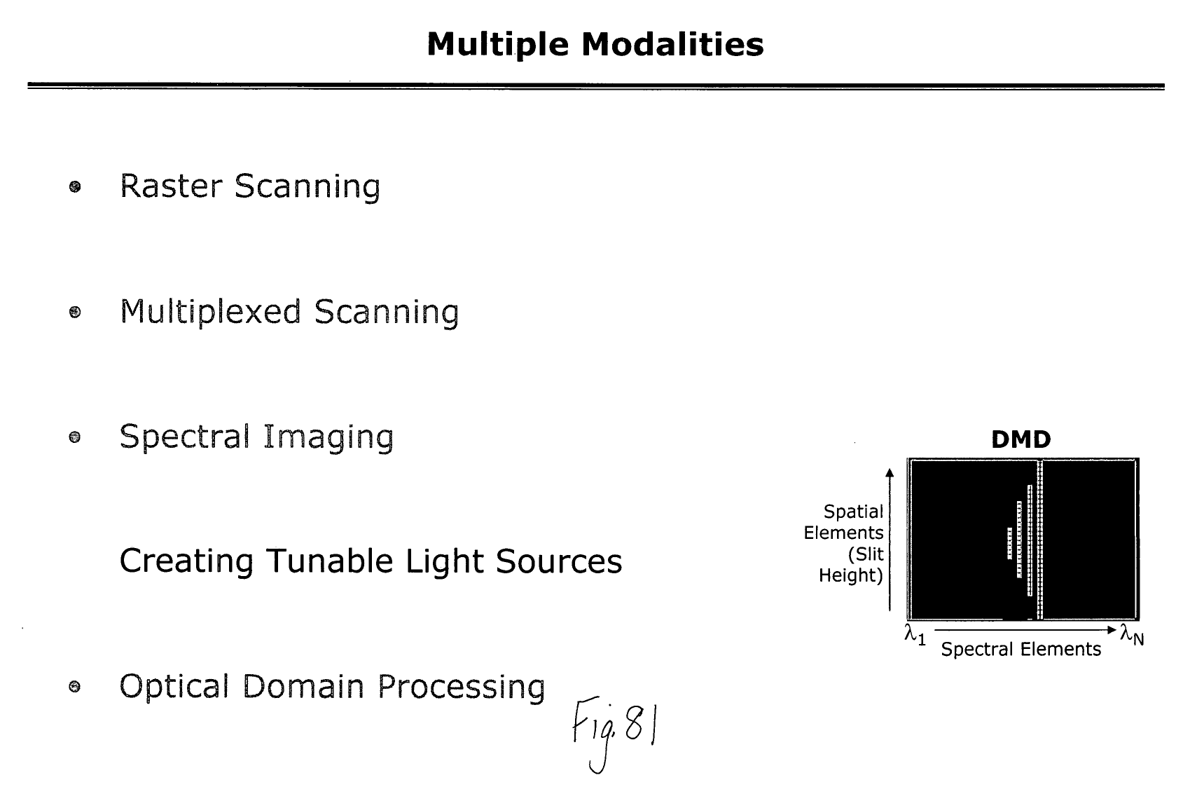

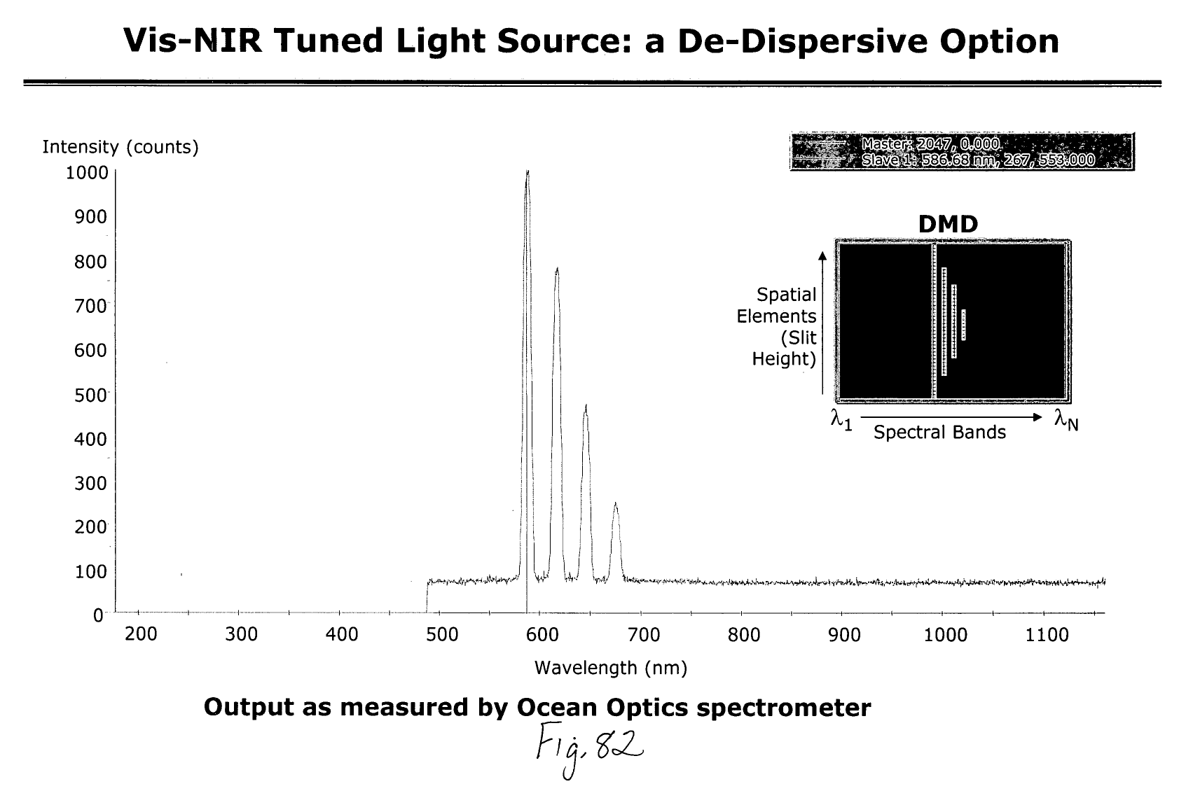

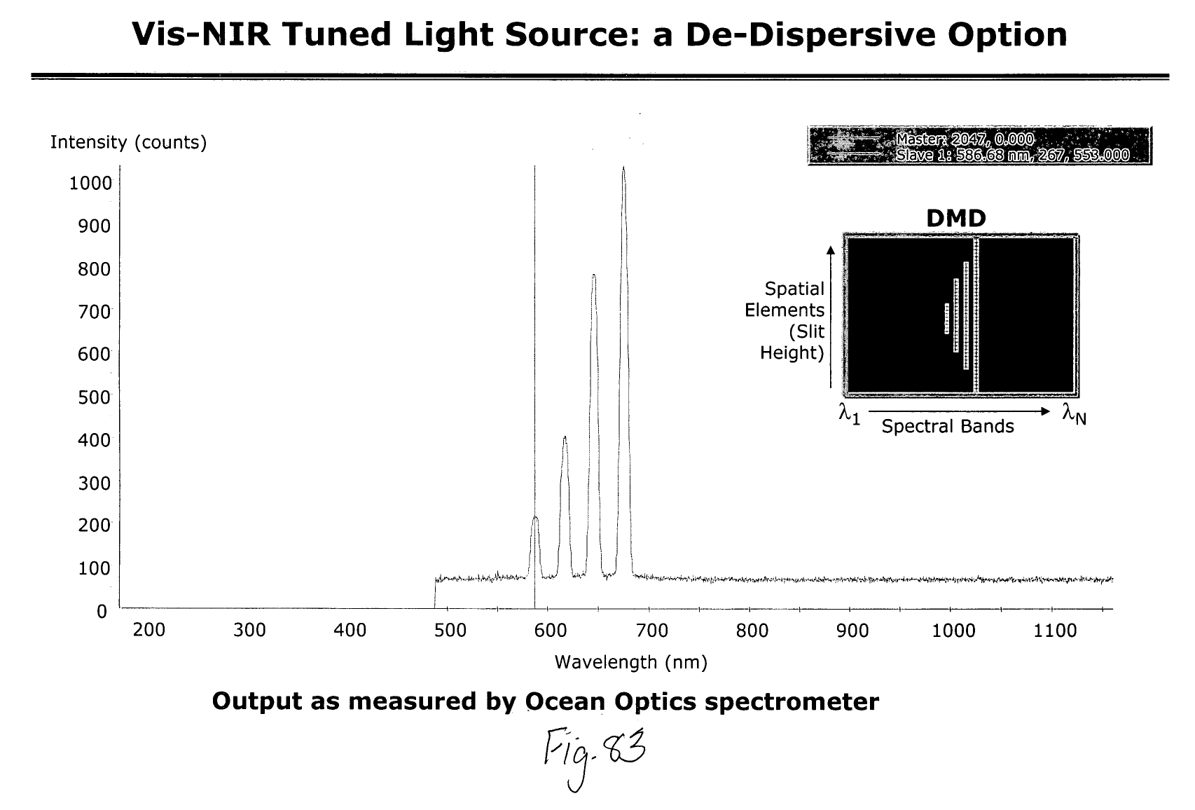

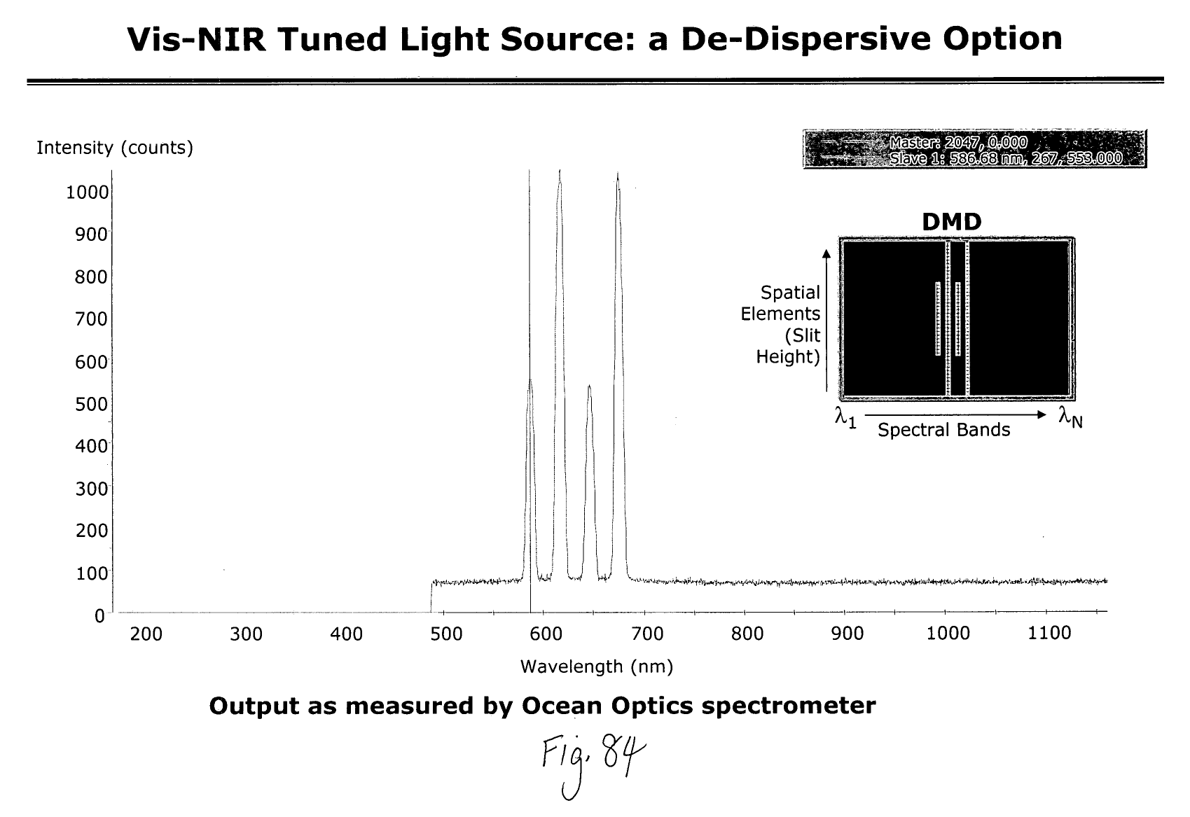

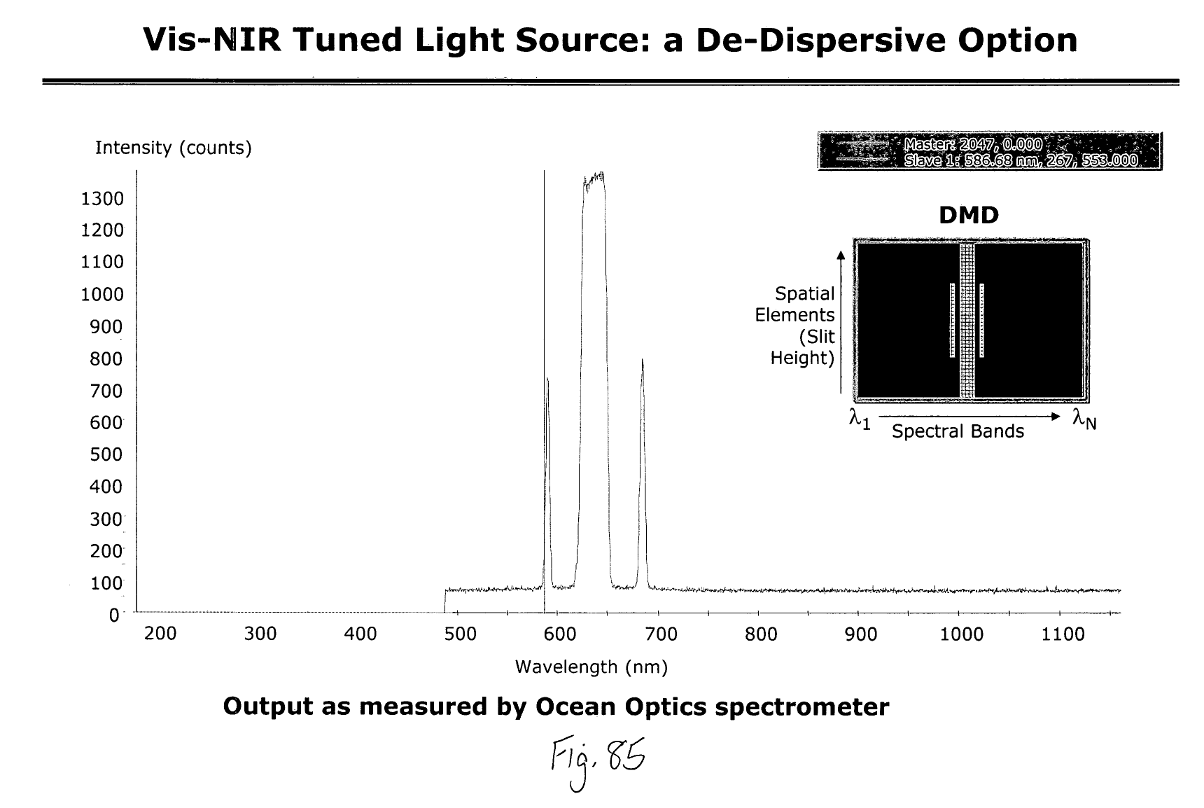

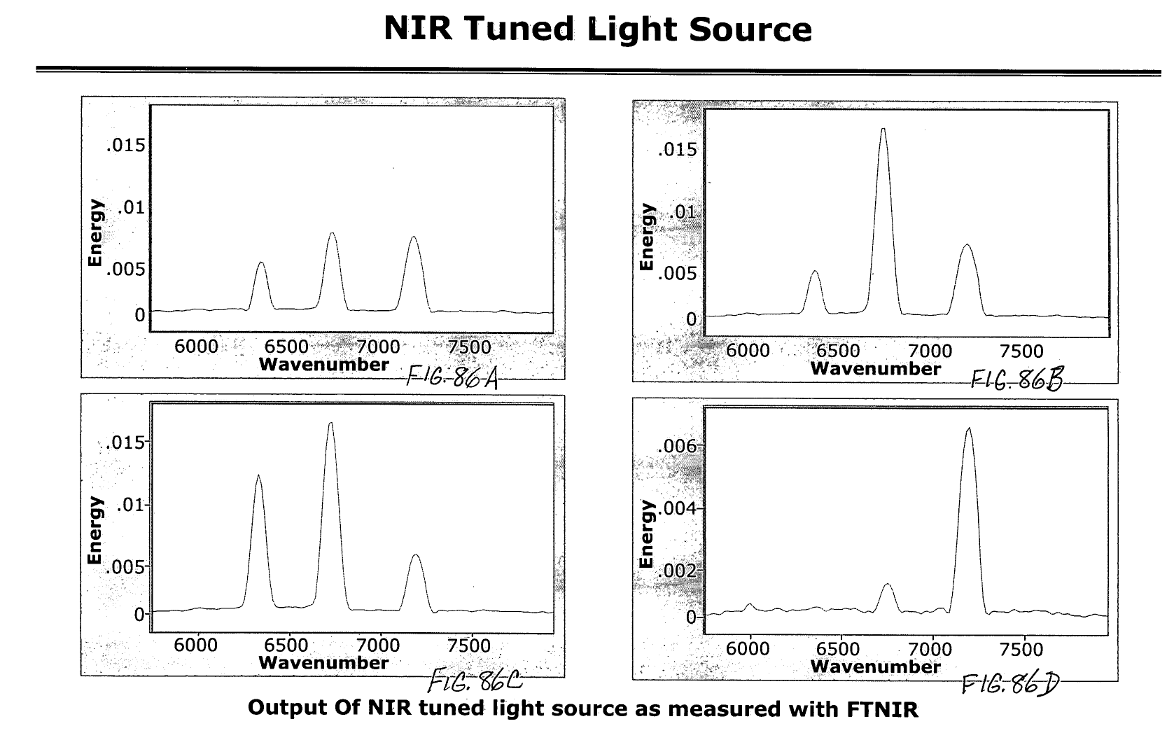

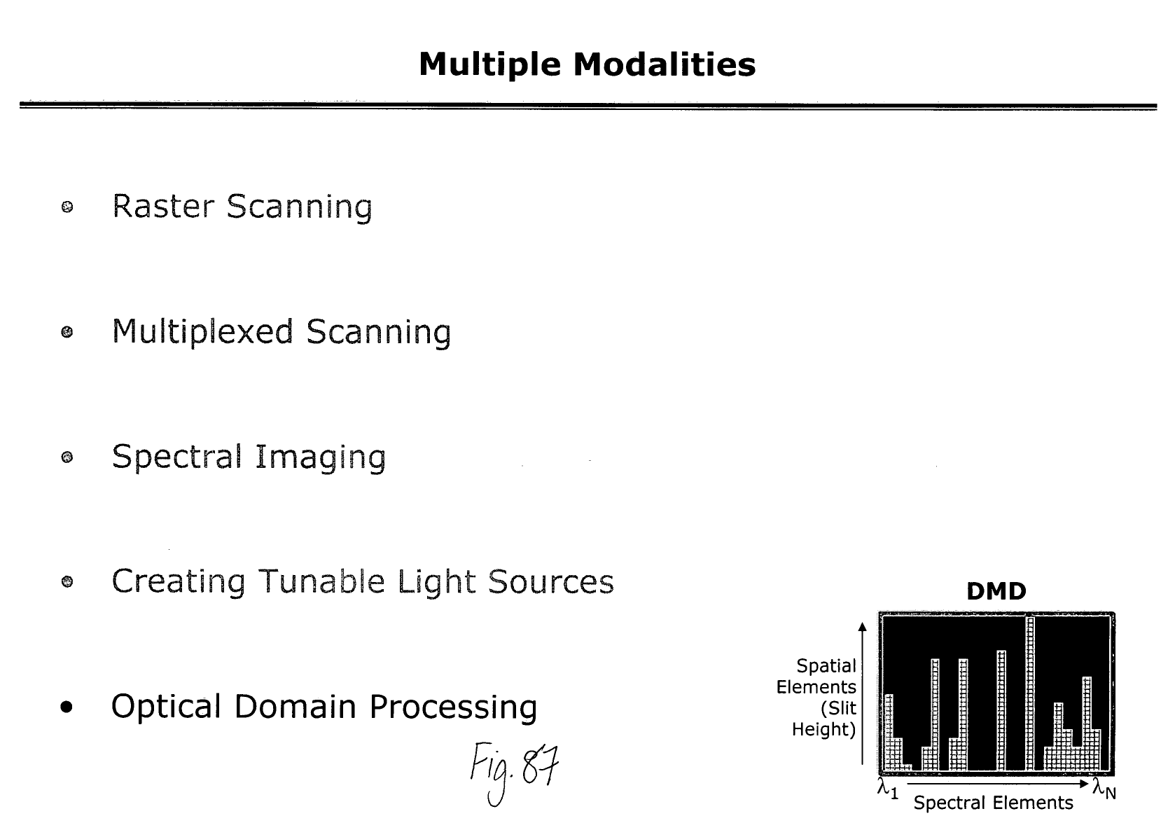

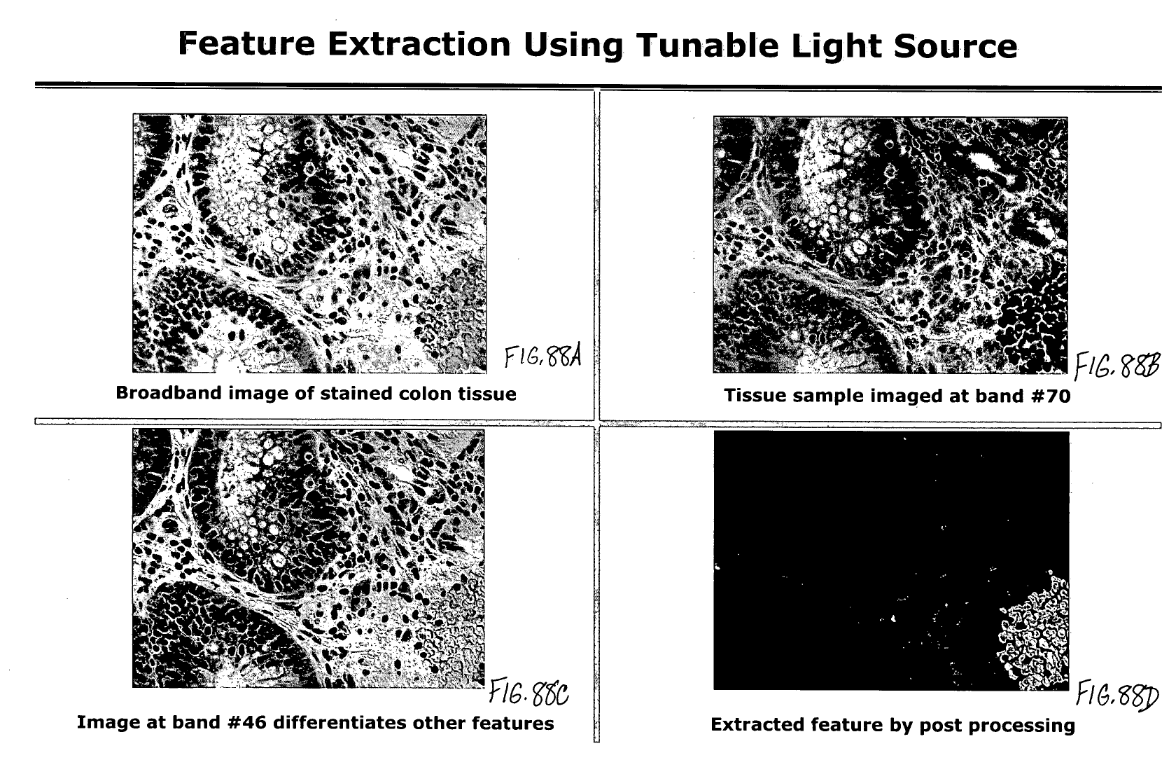

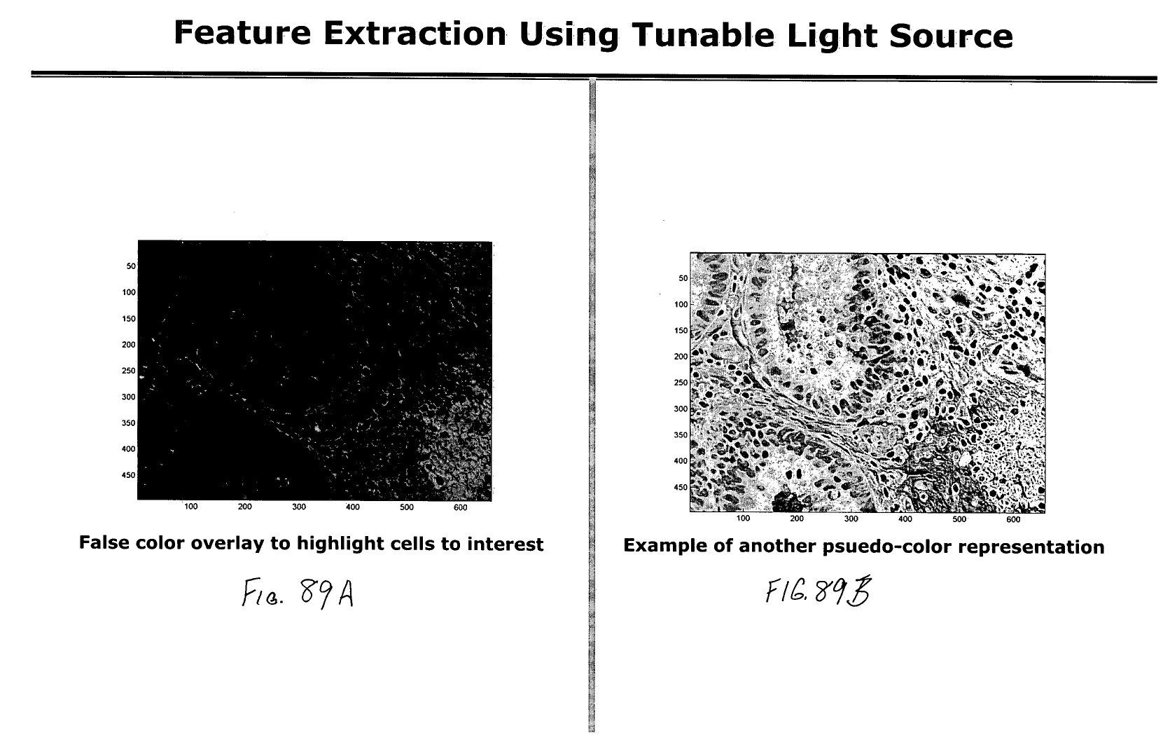

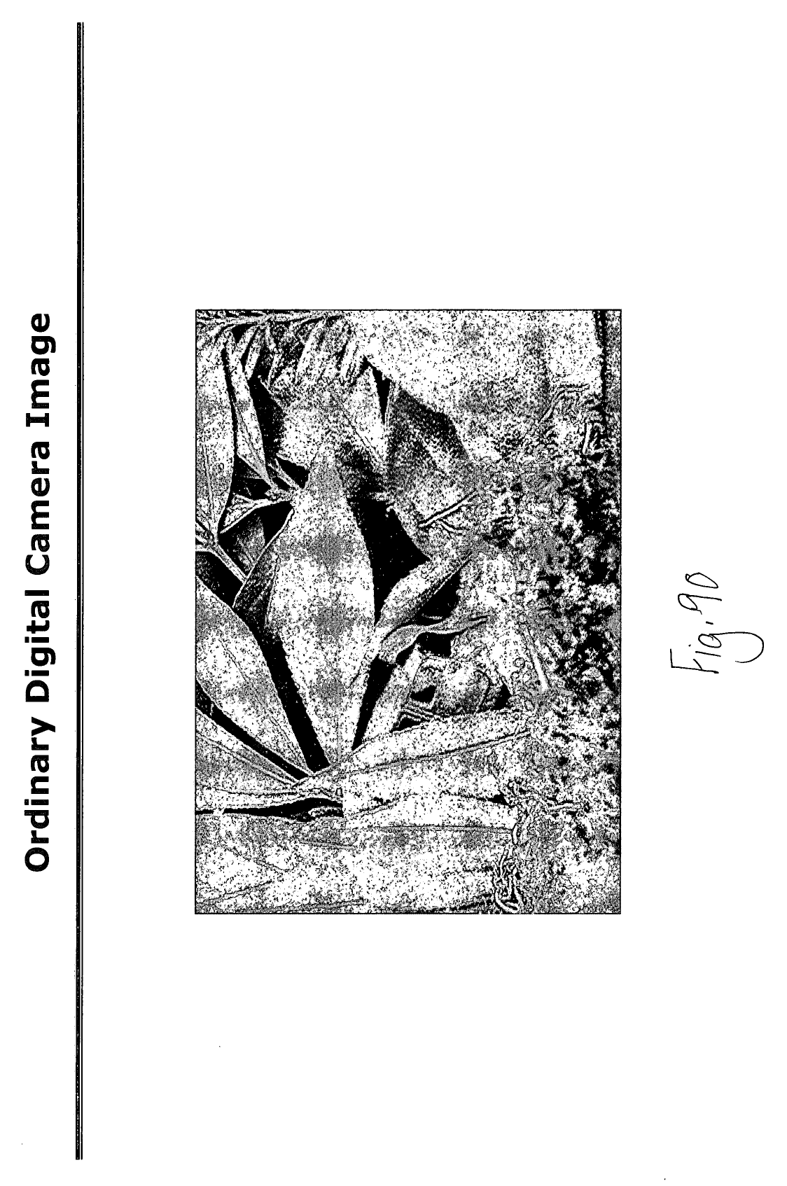

FIGS. 31A-E illustrate different embodiments of an imaging spectrograph used in accordance with this invention in de-dispersive mode;

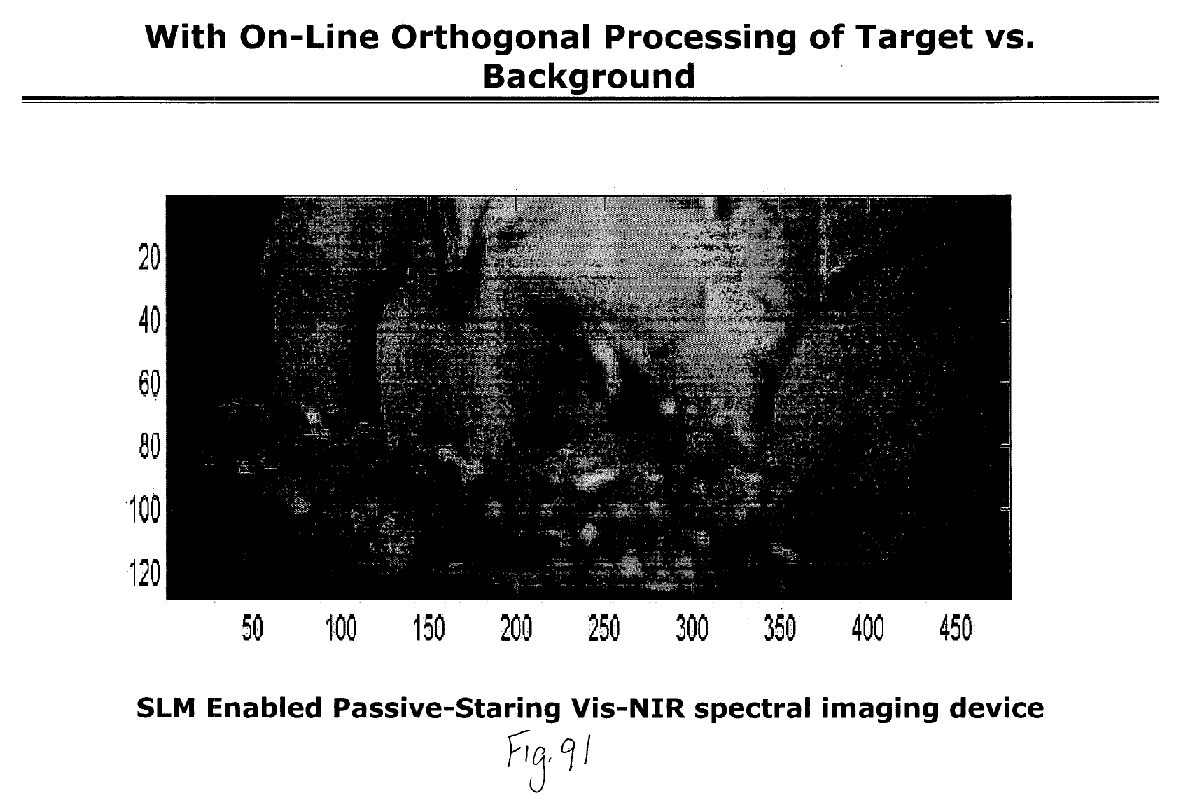

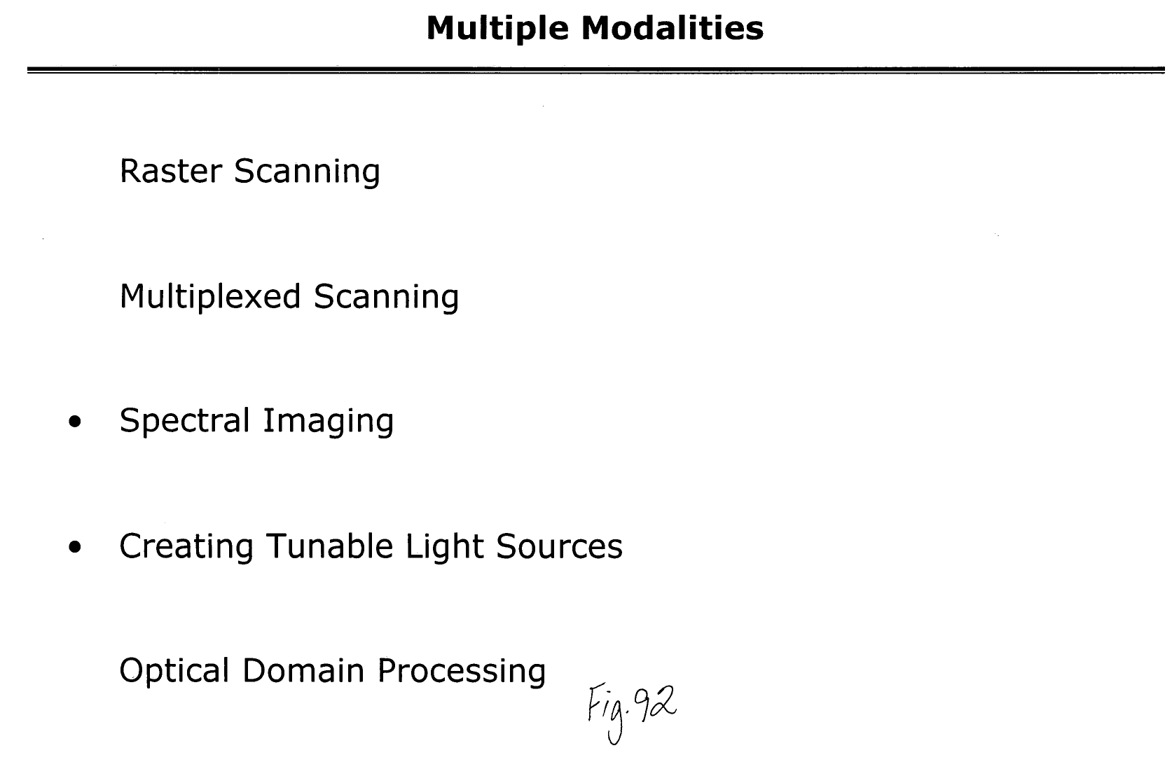

FIG. 32 shows an axial and a cross-sectional views of a fiber optic assembly;

FIG. 33 shows a physical arrangement of the fiber optic cable, detector and the slit;

FIG. 34 illustrates a fiber optic surface contact probe head abutting tissue to be examined;

FIGS. 35A and 35B illustrate a fiber optic e-Probe for pierced ears that can be used for medical monitoring applications in accordance with the present invention;

FIGS. 36A, 36B and 36C illustrate different configurations of a hyperspectral adaptive wavelength advanced illuminating imaging spectrograph (HAWAIIS) in accordance with this invention;

FIG. 37 illustrates a DMA search by splitting the scene;

FIG. 38 illustrates wheat spectra data (training) and wavelet spectrum in an example of determining protein content in wheat;

FIG. 39 illustrates the top 10 wavelet packets in local regression basis selected using 50 training samples in the example of FIG. 38;

FIG. 40 is a scatter plot of protein content (test data) vs. correlation with top wavelet packet;

FIG. 41 illustrates PLS regression of protein content of test data;

FIG. 42 illustrates the advantage of DNA-based Hadamard Spectroscopy used in accordance with the present invention over the regular raster scan;

FIGS. 43-47(A-D) illustrate hyperspectrum processing in accordance with the present invention;

FIG. 48 shows Hadamard-Walsh encodegram data;

FIG. 49 shows recovered single beam spectrum;

FIG. 50 shows a Raster scanned spectral image, which is to be compared with the multiplexed Hadamard-Walsh spectral image shown in FIG. 51;

FIG. 51 shows a Hadamard-Walsh spectral image, which is to be compared with the raster scanned image shown in FIG. 50;

FIG. 52 shows a DMD micro-mirror array;

FIG. 53 shows a de-dispersive imaging spectrograph;

FIG. 54 shows the spatio-spectral layout of the DMD micro-mirrors;

FIG. 55 shows a visible tuned light spectrometer;

FIG. 56 shows a tuned light imaging microcopy setup;

FIG. 57 a example of the output of the tuned light spectrometer;

FIG. 58 a example of the output of the tuned light spectrometer;

FIG. 59 shows a broadband image of stained colon tissue;

FIG. 60 shows a tissue sample imaged at band #70;

FIG. 61 shows extracted feature by post processing;

FIG. 62 shows a false color overlay to highlight the cells of interest;

FIG. 63 shows the image at band #46 to differentiate other features;

FIG. 64 shows an example of another psuedo-color representation;

FIG. 65 shows a digital micro-mirror device (DMD);

FIG. 66 shows an example of the DMD integrated into an imaging spectrograph configuration;

FIG. 67 shows an illustration of a Raster scan;

FIG. 68 shows an absorbance spectrum of dydimium;

FIG. 69 shows a Raman spectral image of solids, including benzoic acid with naphthalene;

FIG. 70 shows Raman spectral images using a single detector element;

FIG. 71 shows an illustration of multiplexed scanning;

FIG. 72 illustrates the SNR improvement from multiplexing;

FIG. 73 illustrates the folding of Hadamard encodement matrix;

FIG. 74 illustrates a single detector element NIR (1300 nm-1750 nm) spectral image;

FIGS. 75-76 show the advantage of a multiplexed scan compared to a Raster scan, where FIG. 75 shows Raster scans and FIG. 76 shows Hadamard scans;

FIG. 77 shows a plot of SNR vs. shutter speed for Raster, Walsh, and Best Level;

FIG. 78 shows an illustration of spectral imaging;

FIG. 79 shows a Staring-Passive VIS-NIR spectral image, where the DMD selects what passes into the imaging spectrograph;

FIG. 80 shows a hyperspectral data cube of a two-dimensional scene obtained without slit translation and with only a single detector;

FIG. 81 shows an illustration of a tunable light source including DMDs;

FIG. 82 shows an output spectrum of a Vis-NIR tuned light source as measured by an Ocean Optics spectrometer;

FIG. 83 shows a different output spectrum of a Vis-NIR tuned light source as measured by an Ocean Optics spectrometer;

FIG. 84 shows a different output spectrum of a Vis-NIR tuned light source as measured by an Ocean Optics spectrometer;

FIG. 85 shows a different output spectrum of a Vis-NIR tuned light source as measured by an Ocean Optics spectrometer;

FIGS. 86A-D show output spectra of a NIR tuned light source as measured with FTNIR;

FIG. 87 shows an illustration of optical domain processing;

FIGS. 88A-D show feature extraction using a tunable light source, where FIG. 88A shows a broadband image of stained colon tissue, FIG. 88B shows tissue sample imaged at band #70, FIG. 88C shows that the image at band #46 differentiates other features, and FIG. FIG. 88D shows an extracted feature by post processing;

FIGS. 89A-B illustrates feature extraction using tunable light source, where FIG. 89A shows a false color overlay to highlight cells to interest, and FIG. 89B shows an example of another psuedo-color representation;

FIG. 90 shows and ordinary digital camera image;

FIG. 91 shows with on-line orthogonal processing of target vs. background, and SLM enabled passive-Staring Vis-NIR spectral imaging device; and

FIG. 92 illustrates the multiple modalities.

### DETAILED DESCRIPTION OF THE PREFERRED EMBODIMENTS

Obtaining useful information from spatio-spectral data cubes can be difficult, often requiring expensive and complicated instrumentation, data collection, and data post-processing methods. Much of the data that is collected contains little information useful to the end user. Novel methods to address this and other related problems have been investigated by a number of scientists and engineering teams. The present disclosure discloses a new modality in spectrometry and imaging that integrates spatial light modulators (SLMs) as programmable modulated apertures in spectrometric and spectral imaging systems. The systems of the present disclosure enable pre-sensor chemometric processing of spatial, spectral or spatio-spectral resolution elements that can be contiguously or non-contiguously combined and modulated. This high degree of control gives applied mathematical methods a fresh opportunity to be tested and compared. Fourier and Hadamard mathematics are employed, as well as other proprietary mathematical algorithmic methods using SLMs as apertures in various visible and near-infrared spectrometric systems to realize significant improvement in signal-to-noise ratios (SNR).

The present disclosure discloses optical metrology instrumentation to provide not merely data to analyze, but also to provide answers directly. A new class of intelligent optical metrology instrumentation can be realized using the methods and systems of the present disclosure. The approaches disclosed are based on the ability disclosed in the present disclosure to manage requisite computations in the pre-sensor optical domain in concert with post sensor or electrical domain processing. A number of prototypes can be constructed a using conventional and non-conventional spectrometers and spectrometric imaging systems based on the ability disclosed in the present disclosure to use special mathematical algorithms to modify programmable optical apertures. These devices are essentially an embodiment of a rapidly re-programmable optical processor.

In the context of biological samples, there are compounded difficulties due to the variability of acquired data. Existing methodologies are hindered by substantial chemical and physical interferences that require extraordinary instrument performance and post processing for successful measurements. Common processing alternatives, such as multivariate regression, attempt to convert the complex optical measures to meaningful information. Large amounts of data are required to build a robust chemometric model, and should take into consideration concentration range, sampling environment, sample matrix and other factors involved in the analysis. A variety of attempts to use genetic algorithms and neural networks to estimate concentration have been tried, with improvements in performance difficult to realize. A fixed optical filter system for multivariate optical computation has been demonstrated (see, e.g., O. Soyemi et al., “Design and Testing of a Multivariate Optical Element (MOE): The First Demonstration of Multivariate Optical Computing for Predictive Spectroscopy” Anal. Chem., 73, 1069-1079, 2001). The need for improvements in biological metrics continues to push the limits of chemometry and instrumentation forward.

Accordingly, the present disclosure discloses a new approach to spectrometric and spectral imaging instrument design promises to provide improvements related to etendue, efficient sensor data processing and a more direct presentation of the answer to the end user.

In one aspect, the present disclosure concerns the analysis of radiation passing through or reflected from a sample of a material of interest. Since signal processing in this aspect of the invention is performed after the sample has been irradiated, in the disclosure in Section I below it is referred to as post-sample processing. Section II deals with the aspect of the invention in which radiation has already been processed prior to its interaction with the sample (e.g. based on a priori knowledge), and is accordingly referred to as pre-sample processing. Various processing techniques applicable in both pre-sample and post-sample processing are considered in Section III. Finally, Section IV illustrates the use of the proposed techniques and approaches in the description of various practical applications.

### I. POST-SAMPLE PROCESSING

A. The Basic System

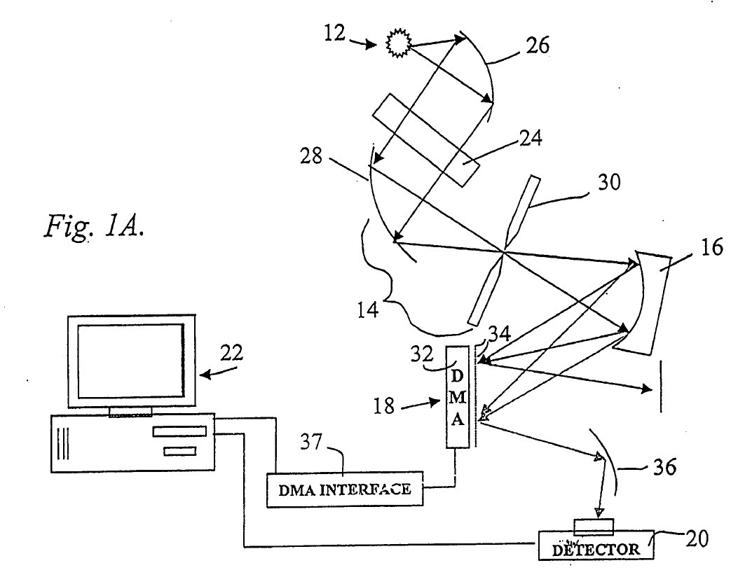

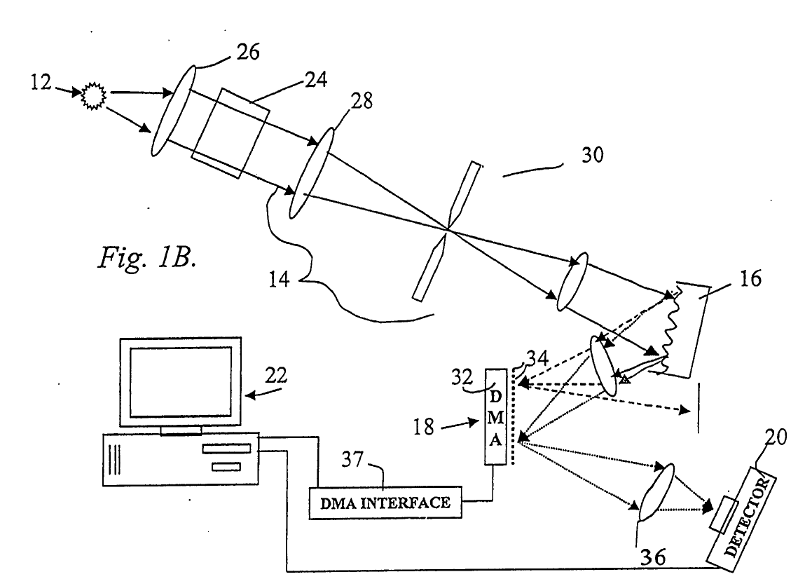

Turning now to the drawing figures and particularly FIGS. 1A and 1B, a spectrometer assembly 10 constructed in accordance with one embodiment of the invention is illustrated. With reference to FIG. 1A the device broadly includes a source 12 of electromagnetic radiation, a mirror and slit assembly 14, a wavelength dispersing device 16, a spatial light modulator 18, a detector 20, and an analyzing device 22.

In particular, the electromagnetic radiation source 12 is operable to project rays of radiation onto or through a sample 24 that is to be analyzed, such as a sample of body tissue or blood. The radiation source may be any device that generates electromagnetic radiation in a known wavelength spectrum such as a globar, hot wire, or light bulb that produces radiation in the infrared spectrum. To increase the amount of rays that are directed to the sample, a parabolic reflector 26 may be interposed between the source 12 and the sample 24. In a specific embodiment, the source of electromagnetic radiation is selected as to yield a continuous band of spectral energies, and is referred to as the source radiation. It should be apparent that the energies of the radiation source are selected to cover the spectral region of interest for the particular application.

The mirror and slit assembly 14 is positioned to receive the radiation rays from the source 12 after they have passed through the sample 24 and is operable to focus the radiation onto and through an entrance slit 30. The collection mirror 28 focuses the radiation rays through slit 30 and illuminates the wavelength dispersing device 16. As shown in diagram form in FIG. 1B, in different embodiments of the invention radiation rays from the slit may also be collected through a lens 15, before illuminating a wavelength dispersion device 16.

The wavelength dispersing device 16 receives the beams of radiation from the mirror and slit assembly 14 and disperses the radiation into a series of lines of radiation each corresponding to a particular wavelength of the radiation spectrum. The preferred wavelength dispersing device is a concave diffraction grating; however, other wavelength dispersing devices, such as a prism, may be utilized. In a specific embodiment, the wavelengths from the dispersing device 16 are in the near infrared portion of the spectrum and may cover, for example, the range of 1650-1850 nanometers (nm). It should be emphasized, however, that in general this device is not limited to just this or to any spectral region. It is intended that the dispersion device in general is capable of operating in other ranges of electromagnetic radiation, including the ultraviolet, visible, infrared, and microwave spectrum portions, as well as acoustic, electric, magnetic, and other signals, where applicable.

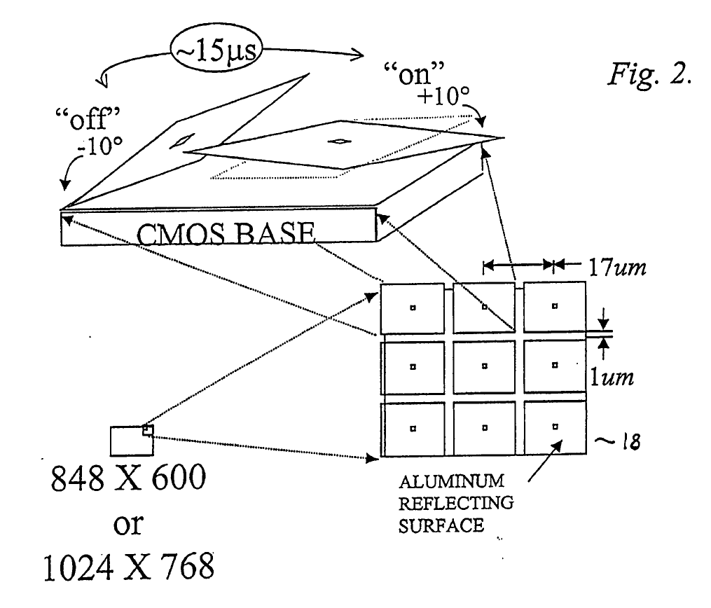

The spatial light modulator (SLM) 18 receives radiation from the wavelength dispersing device 16, individually modulates each spectral line, and reflects the modulated lines of radiation onto the detector 20. As illustrated in FIG. 2, the SLM is implemented in a first preferred embodiment as a micro-mirror array that includes a semi-conductor chip or piezo-electric device 32 having an array of small reflecting surfaces 34 thereon that act as mirrors. One such micro-mirror array is manufactured by Texas Instruments and is described in more detail in U.S. Pat. No. 5,061,049, hereby incorporated into the present application by reference. Those skilled in the art will appreciate that other spatial light modulators, such as a magneto-optic modulator or a liquid crystal device may be used instead of the micro-mirror array. Various embodiments of such devices are discussed in more detail below.

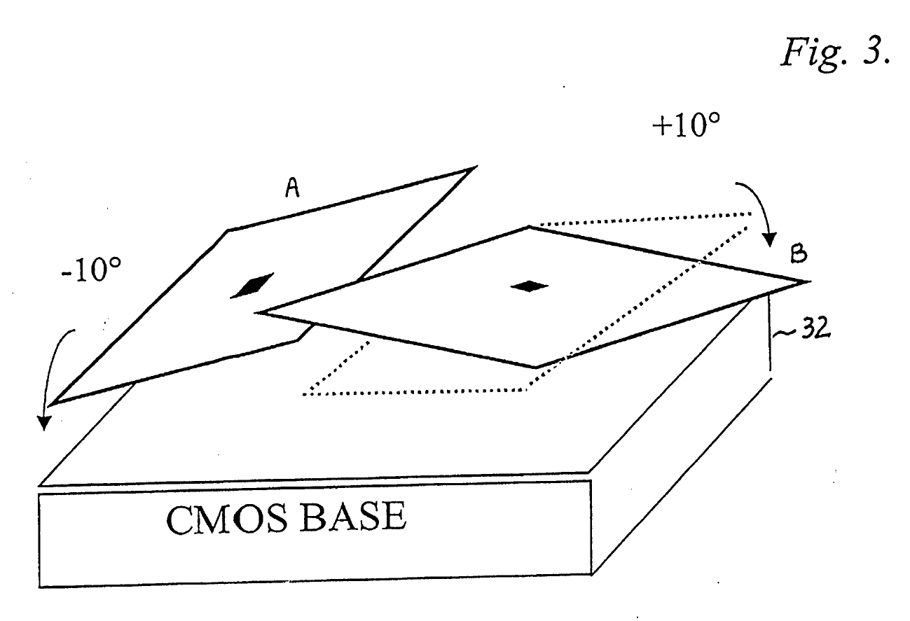

The semi-conductor 32 of the micro-mirror array 18 is operable to individually tilt each mirror along its diagonal between a first position depicted by the letter A and a second position depicted by the letter B. in FIG. 3. In preferred forms, the semi-conductor tilts each mirror 10 degrees in each direction from the horizontal. The tilting of the mirrors 34 is preferably controlled by the analyzing device 22, which may communicate with the micro-mirror array 18 through an interface 37.

The micro-mirror array 18 is positioned so that the wavelength dispersing device 16 reflects each of the lines of radiation upon a separate column or row of the array. Each column or row of mirrors is then tilted or wobbled at a specific and separate modulation frequency. For example, the first row of mirrors may be wobbled at a modulation frequency of 100 Hz, the second row at 200 Hz, the third row at 300 Hz, etc.

In a specific embodiment, the mirrors are calibrated and positioned so that they reflect all of the modulated lines of radiation onto a detector 20. Thus, even though each column or row of mirrors modulates its corresponding line of radiation at a different modulation frequency, all of the lines of radiation are focused onto a single detector.

The detector 20, which may be any conventional radiation transducer or similar device, is oriented to receive the combined modulated lines of radiation from the micro-mirror array 18. The detector is operable for converting the radiation signals into a digital output signal that is representative of the combined radiation lines that are reflected from the micro-mirror array. A reflector 36 may be interposed between the micro-mirror array 18 and the detector 20 to receive the combined modulated lines of radiation from the array and to focus the reflected lines onto the detector.

The analyzing device 22 is operably coupled with the detector 20 and is operable to receive and analyze the digital output signal from the detector. The analyzing device uses digital processing techniques to demodulate the signal into separate signals each representative of a separate line of radiation reflected from the micro-mirror array. For example, the analyzing device may use discrete Fourier transform processing to demodulate the signal to determine, in real time, the intensity of each line of radiation reflected onto the detector. Thus, even though all of the lines of radiation from the micro-mirror array are focused onto a single detector, the analyzing device can separately analyze the characteristics of each line of radiation for use in analyzing the composition of the sample.

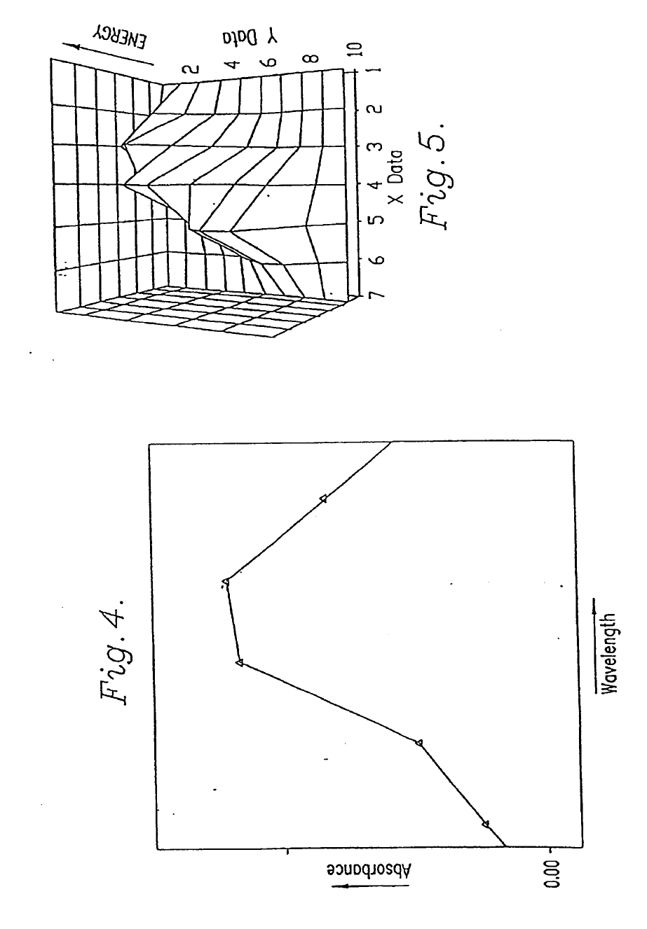

In accordance with one embodiment of this invention, the analyzing device is preferably a computer that includes spectral analysis software. FIG. 4 illustrates an output signal generated by the analyzing device in accordance with one embodiment. The output signal illustrated in FIG. 4 is a plot of the absorption characteristics of five wavelengths of radiation from a radiation source that has passed through a sample.

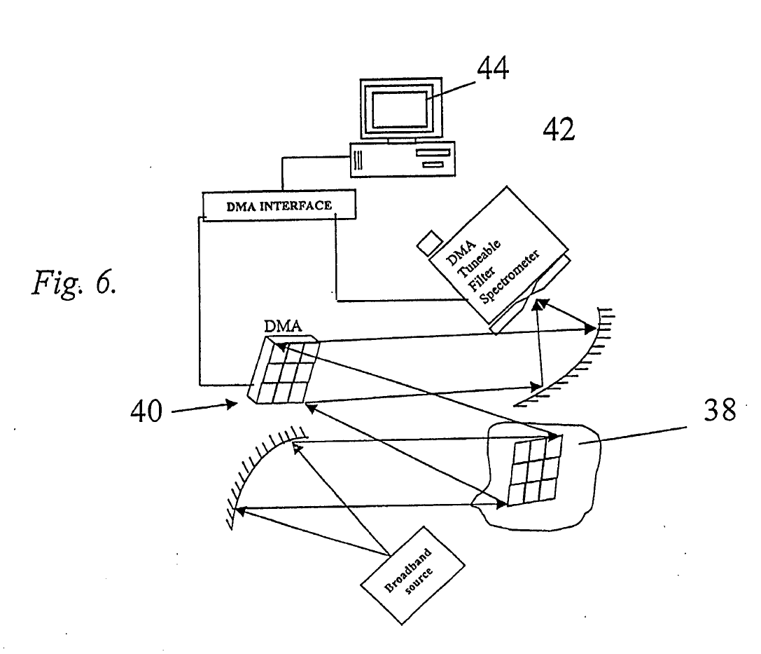

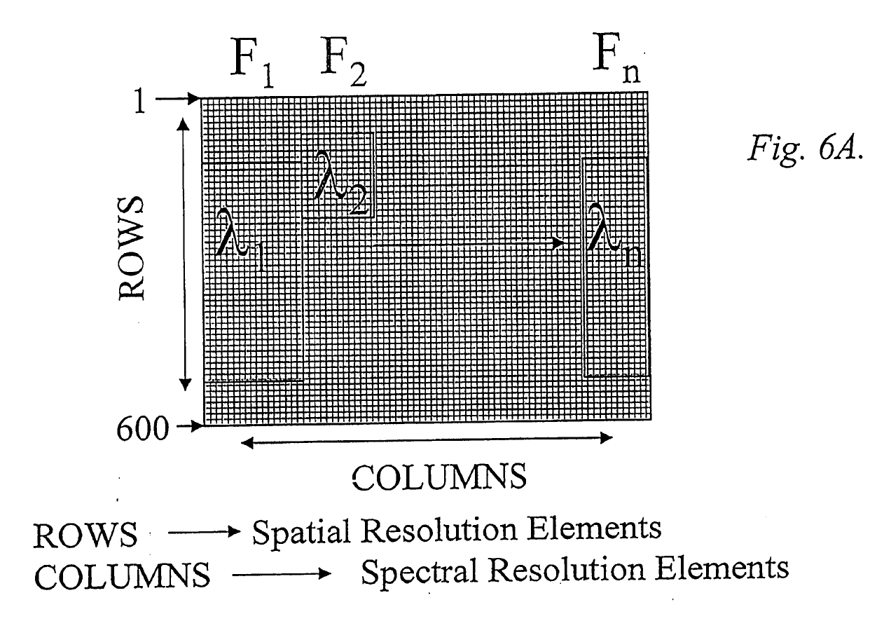

In one embodiment of the system of this invention illustrated in FIG. 6A, it is used for digital imaging purposes. In particular, when used as an imaging device, an image of a sample 38 is focused onto a micro-mirror array 40 and each micro-mirror in the array is modulated at a different modulation rate. The micro-mirror array geometry is such that some or all of the reflected radiation impinges upon a single detector element 42 and is subsequently demodulated to reconstruct the original image improving the signal-to-noise ratio of the imager. Specifically, an analyzing device 44 digitally processes the combined signal to analyze the magnitude of each individual pixel. FIG. 6B illustrates spatio-spectral distribution of the DMA, where individual elements can be modulated. FIG. 5 is a plot of a three dimensional image showing the magnitude of each individual pixel.

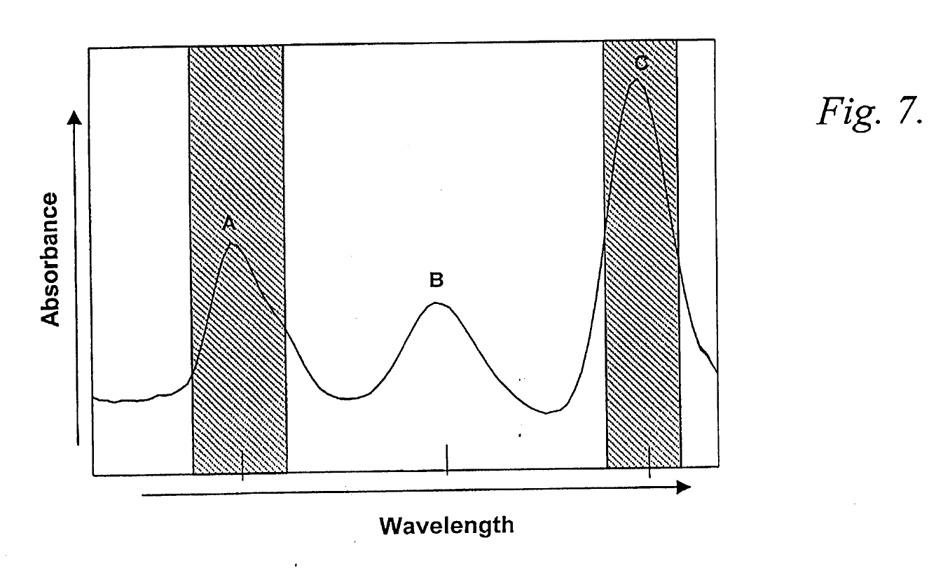

FIG. 7 illustrates the output of a digital micro-mirror array (DMA) filter spectrometer used as a variable band pass filter spectrometer, variable band reject filter spectrometer, variable multiple band pass filter spectrometer or variable multiple band reject filter spectrometer. In this embodiment, the combined measurement of the electromagnetic energy absorbed by sample constituents A and C is of interest. The shaded regions in FIG. 7 illustrate the different regions of the electromagnetic spectrum that will be allowed to pass to the detector by the DMA filter spectrometer. The wavelengths of electromagnetic radiation selected to pass to the detector correspond to the absorption band for compound A and absorption band for compound C in a sample consisting of compounds A, B, and C. The spectral region corresponding to the absorption band of compound B and all other wavelengths of electromagnetic radiation are rejected. Those skilled in the art will appreciate that the DMA filter spectrometer is not limited to the above example and can be used to pass or reject any combination of spectral resolution elements available to the DMA. Various examples and modifications are considered in detail below.

As a DMA filter imager the spatial resolution elements (pixels) of an image can be selectively passed or rejected (filtered) according to the requirements of the image measurement. The advantages of both the DMA filter spectrometer and DMA filter imager are:

(1) All spectral resolution elements or spatial resolution elements corresponding to the compounds of interest in a particular sample can be directed simultaneously to the detector for measurement. This has the effect of increasing the signal-to-noise ratio of the measurement.

(2) The amount of data requiring processing is reduced. This reduces storage requirements and processing times.

B. Modulated Spectral Filter Design

(i) Design Basics

The preceding section described the components of the basic system used in accordance with the present invention, and their operation. The focus of this section is on the design of specific modulated spectral filters using the spatial light modulator (SLM) 18, which in a preferred embodiment is implemented using a digital micro-mirror array (DMA).

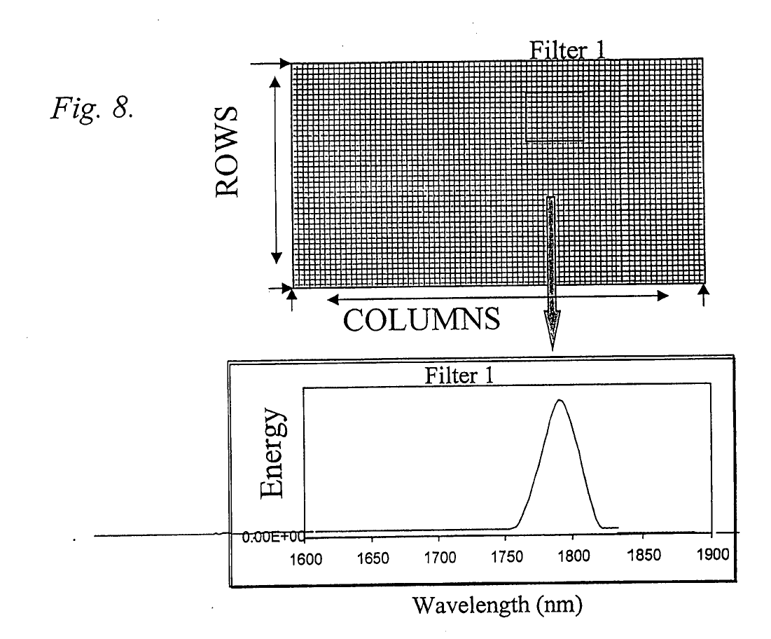

As noted above, using a DMA one can provide one or more spectral band pass or band-reject filter(s) with a chosen relative intensity. In particular, in accordance with the present invention the radiation wavelengths that are reflected in the direction of the detector are selected by specific columns of micro-mirrors of the DMA, as illustrated in FIG. 8. The relative intensity of the above spectral band is controlled by the selection of specific area of micro-mirrors on the DMA, represented by the dark area designated “A” in FIG. 8. Thus, the dark area shown in FIG. 8 is the mirrors that direct specific wavelength radiation, i.e., spectral band, to the detector. Clearly, the “on” mirrors in the dark area create a band-pass filter, the characteristics of which are determined by the position of the “on” area in the DMA. The bottom portion of the figure illustrates the profile of the radiation reaching the detector.

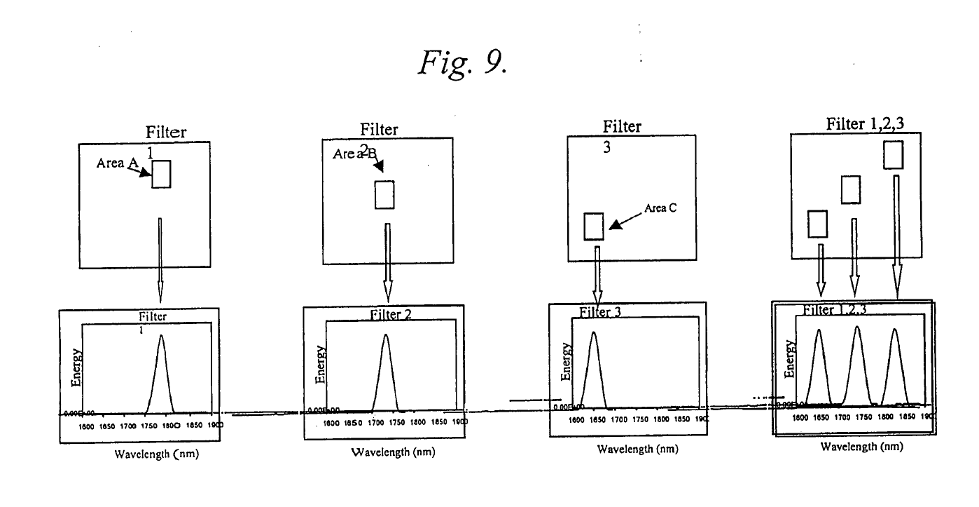

FIG. 8 also demonstrates the selection of specific rows and columns of mirrors in the DMA used to create one spectral band filter with a single spectral mode. It should be apparent, however, that using the same technique of blocking areas in the DMA one can obtain a plurality of different specific spectral band filters, which can have multi-modal characteristics. The design of such filters is illustrated in FIG. 9.

As shown in FIG. 9, a multitude of different specific filters can be designed on one DMA using simple stacking. FIG. 9 illustrates the creation of several filters by selective reflection from specific micro-mirrors. In particular, the left side of the figure illustrates the creation of three different filters, designated 1, 2, and 3. This is accomplished by the selection of specific mirrors on the DMA, as described above with reference to FIG. 8. The total collection of spectral band filters is shown at the bottom-left of this figure. The spectral band provided by each filter is shown on the right-hand side of the figure. The bottom right portion illustrates the radiation passing through the combination of filters 1, 2 and 3.

The above discussion describes how the relative intensity of each spectral band can be a function of the DMA area used in the reflection. The following table illustrates the linear relationship between areas of the DMA occupied by individual filters, and the resulting filter. Clearly, if the entire DMA array is in the “on” position, there will be no filtering and in principle the input radiation passes through with no attenuation.

| FIG. 9, left side | FIG. 9, right side |
|---|---|
| Reflected radiation from micro-mirrors | Filter created |
| area A | 1 |
| area B | 2 |
| area C | 3 |
| areas a + b + c | 1 + 2 + 3 |

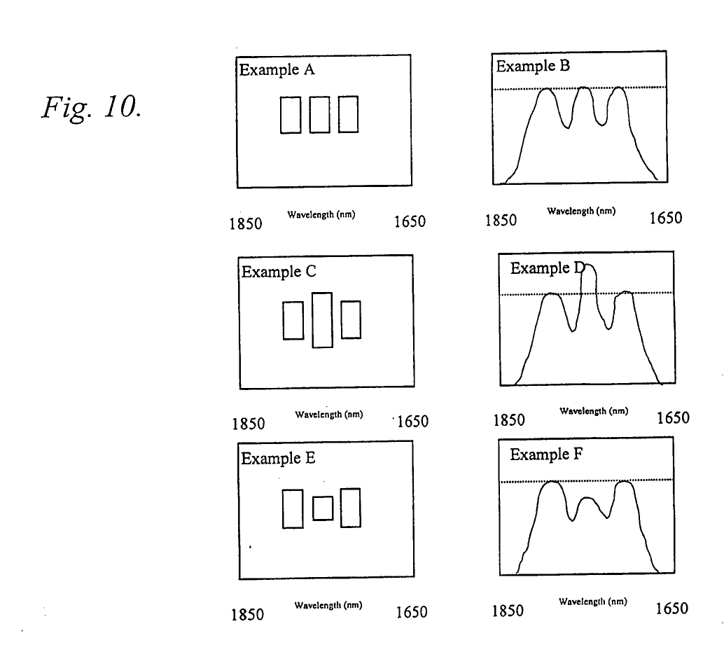

FIG. 10 illustrates the means for the intensity variation of a spectral filter built in accordance with this invention, and is summarized in the table below.

| Example A | Example B |
|---|---|
| Reflection from a DMA | The intensity recorded at the detector |
| See FIGS. 8 and 9. | for example A for the combination |
| Reflection areas 1, 2, and 3 create | filter 1, 2, and 3, Intensity, I, I₁ = I₂ = |
| spectral filter 1, 2 and 3 | I₃ |
| respectively. area 1 = area 2 = | |
| area 3 | |
| Example C | Example D |
| The reflection of area 2 of the | The intensity recorded at the detector |
| DMA is increased. | for filters 1, 2, and 3 is |
| area 1 = area 3 < area 2 | I₁ _I₃ < I₂ |
| Example E | Example F |
| The reflection of area 2 of the | The intensity recorded at the detector |
| DMA is decreased | for filter 1, 2, and 3 is |
| area 1 = area 3 < area 2 | I₁ = I₃ < I₂ |

(ii) Modulation

FIGS. 9 and 10 illustrate the ability to design spectral filters with different characteristics using a DMA. The important point to keep in mind is that different spectral components of the radiation from the sample have been separated in space and can be filtered individually. It is important to retain the ability to process individual spectral components separately. To this end, in accordance with the present invention, spectral components are modulated.

The basic idea is to simply modulate the output from different filters differently, so one can identify and process them separately. In a preferred embodiment, different modulation is implemented by means of different modulation rates. Thus, with reference to FIG. 9, the output of filter 1 is modulated at rate M₁; output of filter 2 is modulated at rate M₂, and filter 3 is modulated using rate M₃, where M_{1—}M_{2—}M₃. In different embodiments, modulation may be achieved by assigning a different modulation encodement to each filter, with which it is modulated over time.

As a result, a system built in accordance with the present invention is capable of providing: a) Spectral bandwidth by selection of specific columns of micro-mirrors in an array; b) Spectral intensity by selection of rows of the array; and c) Spectral band identification by modulation. All of the above features are important in practical applications, as discussed in Section IV below.

C. Alternative Embodiments

(i) Modulating Spectrometers without a DMD.

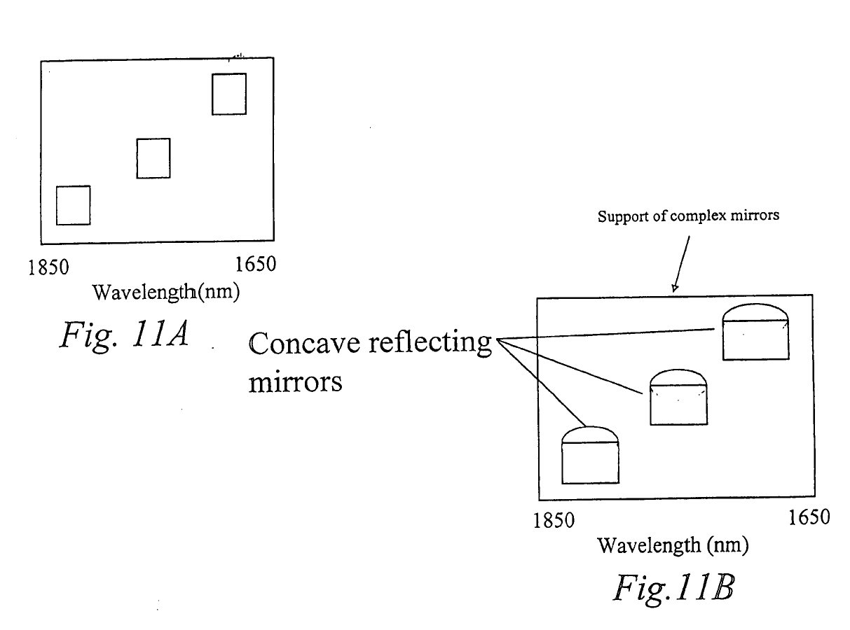

FIGS. 11-14 illustrate alternative embodiments of a modulating spectrometer in accordance with this invention, where the DMA is replaced with different components. In particular, FIGS. 11A and B show an embodiment in which the DMA is replaced with fixed elements, in this case concave mirrors. The idea is to use fixed spectral grating, which masks out spectrum block components that are not needed and passes those which are.

The idea here is that the broadly illuminated dispersive element distributes spectral resolution elements in one dimension so that in the orthogonal dimension one can collect light of the same wavelengths. With reference to FIG. 6A one can see that at a particular defined plane, herein called the focal plane, one has a wavelength axis(x or columns) and a spatial axis(y or rows). If one were to increase the number of spatial resolution elements (y) that are allowed to pass energy through the system and out of the exit aperture for any given wavelength (x), or spectral resolution element (x), this would have the effect of increasing the intensity of the particular spectral resolution elements' intensity at the detector.

If the array of spatio/spectral resolution elements at the focal plane as shown in FIG. 6A is replaced with fixed elements, such as the concave mirrors in FIG. 11B, one can have a different device configured to perform a particular signal processing task—in this case pass the predetermined spectrum components at the desired intensity levels. FIG. 11A shows the spatio/spectral resolution elements at the focal plane to be used. The fixed optical elements are placed to interact with predetermined spatio/spectral resolution elements provided by the grating and entrance aperture geometry and to direct the specific assortment of spatio/spectral elements to specific spatial locations for modulation encoding (possibly using the barber pole arrangement, shown next).

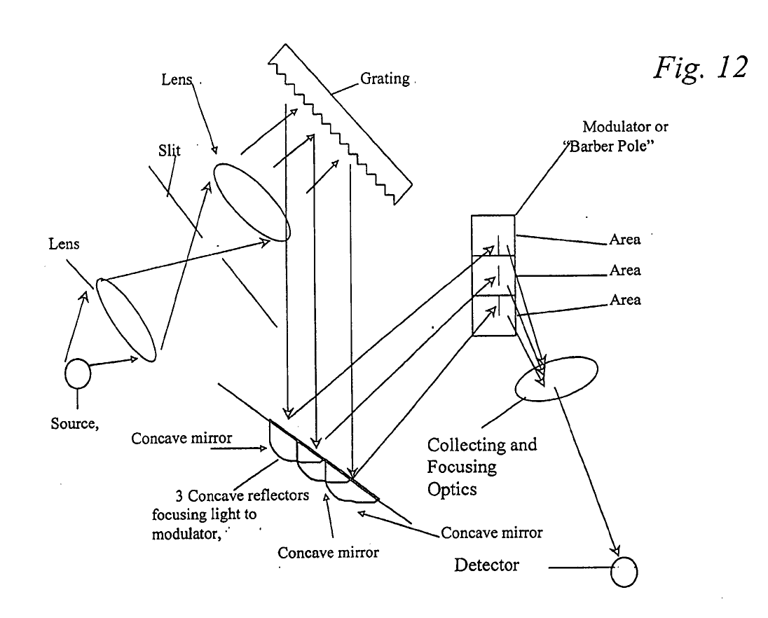

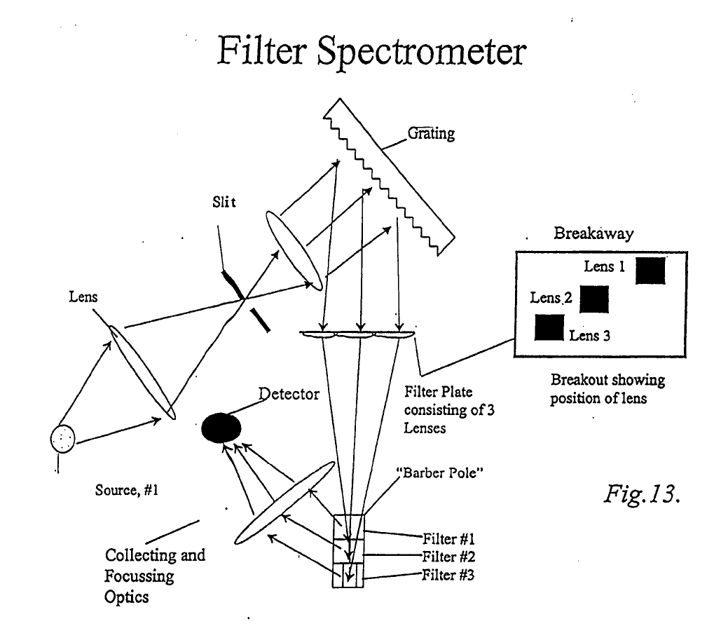

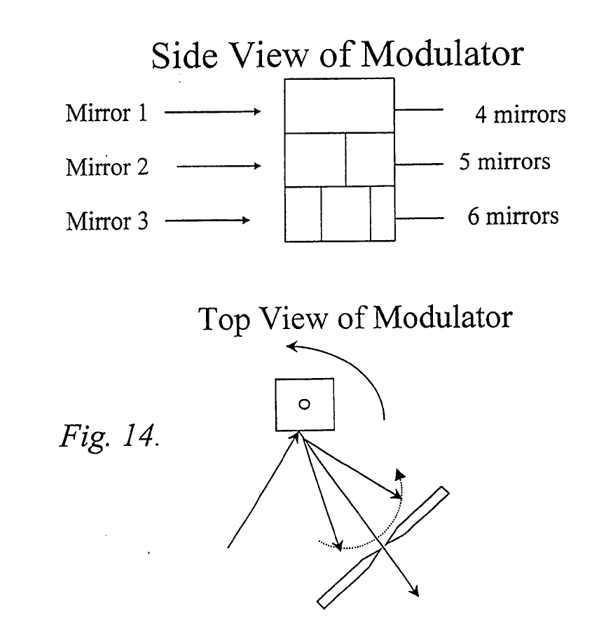

FIG. 12 illustrates an embodiment of a complete modulating spectrometer in which the DMA element is replaced by the concave mirrors of FIG. 11. FIG. 13 illustrates a modulating lens spectrometer using lenses instead of DMA, and a “barber pole” arrangement of mirrors to implement variable modulation. The “barber pole” modulation arrangement is illustrated in FIG. 14.

With reference to FIG. 14, modulation is accomplished by rotating this “barber pole” that has different number of mirrors mounted for reflecting light from the spatially separated spectral wavelengths. Thus, irradiating each vertical section will give the reflector its own distinguishable frequency. In accordance with this embodiment, light from the pole is collected and simultaneously sent to the detector. Thus, radiation from concave mirror 1 impinges upon the four-mirror modulator; concave mirror 2 radiation is modulated by the five-mirror modulator, and concave mirror 3 directs radiation to the six-mirror modulator. In the illustrated embodiment, the modulator rate is four, five, or six times per revolution of the “barber pole.”

The operation of the device is clarified with reference to FIG. 12, tracing the radiation from the concave mirrors 12 to the detector of the system. In particular, concave mirror 1 reflects a selected spectral band with chosen intensity. This radiated wave impinges upon a modulator, implemented in this embodiment as a rotation barber pole. The modulating rates created by the barber pole in the exemplary embodiment shown in the figure are as shown in the table below.

| | Number of mirrors | Modulation |
|---|---|---|
| | Per 360_rotation | Per 360_of barber pole |
| Area A | 4 | 4/360_{—} |
| Area B | 5 | 5/360_{—} |
| Area C | 6 | 6/360_{—} |

Accordingly, this arrangement yields a modulation rate of 4/360 for the radiation from Area A, FIG. 12.

By a analogy, the mirrors of Areas B and C are modulated at the rate of 5/360_ and 6/360_, respectively. As illustrated, all radiation from mirrors A, B, and C is simultaneously directed to the detector. This radiation is collected by either a simple mirror lens or a toroidal mirror, which focuses the radiation onto a single detector. The signal from the detector now goes to electronic processing and mathematical analyses for spectroscopic results.

(ii) Modulating Light Sources Spectrometer.

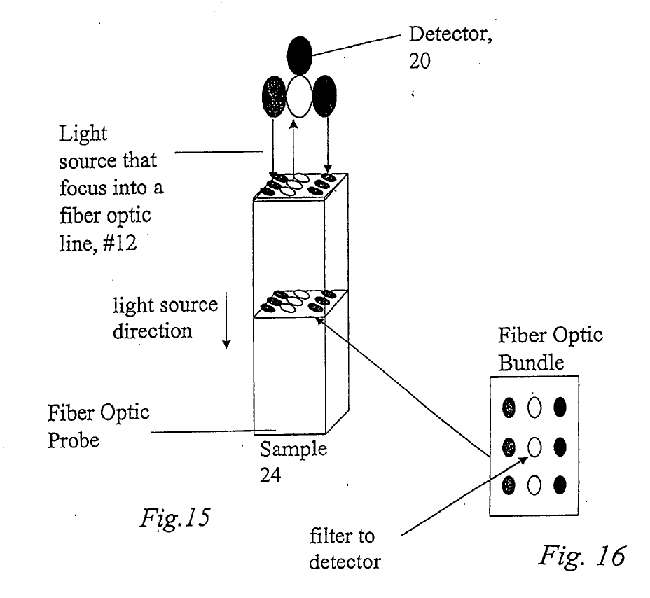

In the discussion of modulating spectrometers, a single light source of electromagnetic radiation was described. There exist yet another possibility for a unique optical design—a modulating multi-light source spectrometer. FIGS. 15 and 16 illustrate an embodiment of this invention in which a light source 12 provides several modulated spectral bands, e.g., light emitting diodes (LED), or lasers (shown here in three different light sources). The radiation from these light sources impinges upon the sample 24. One possible illumination design is one in which light from a source, e.g. LED, passes through a multitude of filters, impinging upon the sample 24. The radiation from the sample is transmitted to a detector 20, illustrated as a black fiber. The signal from the detector is electronically processed to a quantitative and qualitative signal describing the sample chemical composition.

In this embodiment, a plurality of light sources is used at differed modulating rates. FIG. 15 and 16 illustrate the combination of several light sources in the spectrometer. The choice of several different spectral bands of electromagnetic radiation can be either light emitting diodes, LED, lasers, black body radiation and/or microwaves. Essentially the following modulation scheme can be used to identify the different light sources, in this example LED's of different spectral band wavelength.

| No. of | Spectral band | Modulation |
|---|---|---|
| Source | Wavelength, nm | Rate |
| 1 | 1500-1700 | m₁ |
| 2 | 1600-1800 | m₂ |
| 3 | 1700-1900 | m₃ |
| . | . | . |
| . | . | . |
| . | . | . |

Note:
m₁_m₂ _m₃ _. . .

It should be noted that either the radiation will be scattered or transmitted by the sample 24. This scattered or transmitted radiation from the sample is collected by an optical fiber. This radiation from the sample is conducted to the detector. The signal from the detector is electronically processed to yield quantitative and qualitative information about the sample.

In a particular embodiment the radiation path consists of optical fibers. However, in accordance with alternate embodiments, mirrors and lenses could also constitute the optical path for a similar modulating multi-light source spectrometer.

(iii) Modulating Multi-Source Hyperspectral Imaging Spectrometer

The spectrometer described in the preceding section records spectral information about one unique area on a single detector. In a similar manner, the spectral characteristic of a multitude of areas in a sample can be recorded with a multitude of detectors in accordance with different embodiments of the invention. Such a multitude of detectors exists in an array detector. Array detectors are known in the art and include, for example Charge coupled devices (CCD), in the ultraviolet, and visible portions of the spectrum; InSb—array in near infrared; InGaAs—array in near infrared; Hg—Cd—Te—array in mid-infrared and other array detectors.

Array detectors can operate in the focal plane of the optics. Here each detector of the array detects and records the signal from a specific area, xᵢyᵢ. Practical Example B in Section IV on the gray-level camera provides a further illustration. Different aspects of the embodiments discussed in sections (iii) and (iv) are considered in more detail in the following sections. As is understood by one skilled in the art, standard optical duality implies that each of the preceding configurations can be operated in reverse, exchanging the position of the source and the detector.

### II. PRE-SAMPLING PROCESSING

The preceding section described an aspect of the invention referred to as post-sample processing, i.e., signal processing performed after a sample had been irradiated. In accordance with another important aspect of this invention, significant benefits can result from irradiating a sample with pre-processed radiation, in what is referred to as pre-sample processing. Most important in this context is the use, in accordance with this invention, of one or more light sources, capable of providing modulated temporal and/or spatial patterns of input radiation. These sources are referred to next as controllable source(s) of radiation, which in general are capable of generating arbitrary combinations of spectral radiation components within a predetermined spectrum range.

Several types of prior art devices are known that are capable of providing controllable radiation. Earlier prior art devices primarily relied upon various “masking” techniques, such as electronically alterable masks interposed in the optical pathway between a light source and a detector. More recent prior art devices use a combination of two or more light-emitting diodes (LEDs) as radiation sources. Examples are provided in U.S. Pat. Nos. 5,257,086 and 5,488,474, the content of which is hereby incorporated by reference for all purposes. As discussed in the above patents, an array of LEDs or light-emitting lasers is configured for activation using a particular encoding pattern, and can be used as a controllable light source. A disadvantage of this system is that it relies on an array of different LED elements, each operating in a different, relatively narrow spectrum band. In addition, there are technological problems associated with having an array of discrete radiation elements with different characteristics.

These and other problems associated with the prior art are addressed in accordance with the present invention using a device that in a specific embodiment can be thought of as the reverse of the setup illustrated in FIG. 1A. In particular, one or more broadband radiation sources illuminate the digital micro-mirror array (DMA) 18 and the modulations of the micro-mirrors in the DMA encode the source radiation prior to impinging upon the sample. The reflected radiation is then collected from the sample and directed onto a detector for further processing.

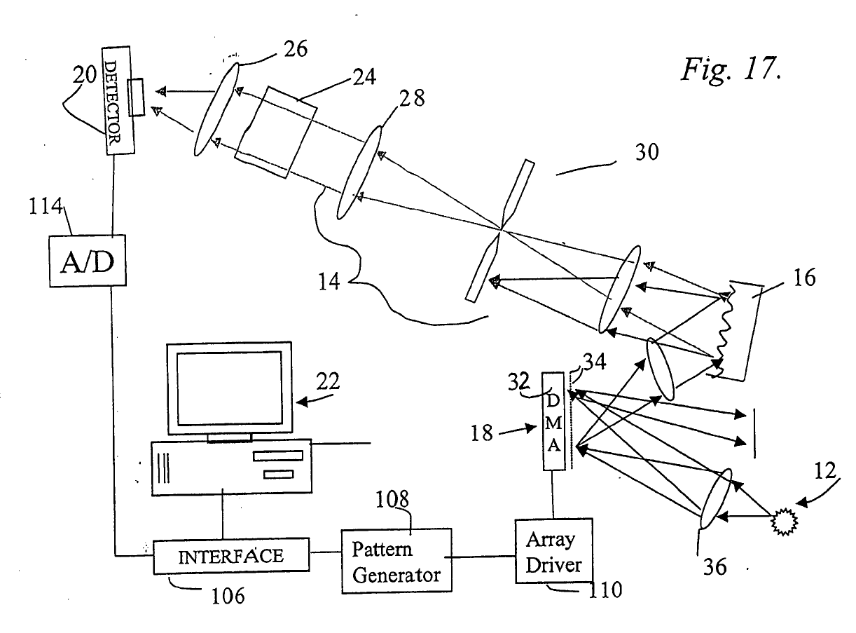

FIG. 17 illustrates a schematic representation of an apparatus in accordance with the present invention using a controllable radiation source. Generally, the system includes a broadband radiation source 12, DMA 18, wavelength dispersion device 16, slit assembly 30, detector 20 and control assembly 22.

In particular, control assembly 22 may include a conventional personal computer 104, interface 106, pattern generator 108, DMA driver 110, and analog to digital (A/D) converter 114. Interface 106 operates as a protocol converter enabling communications between the computer 22 and devices 108-114.

Pattern generator 108 may include an EPROM memory device (not shown) which stores the various encoding patterns for array 18, such as the Hadamard encoding pattern discussed below. In response to control signals from computer 22, generator 108 delivers signals representative of successive patterns to driver 110. More particularly, generator 108 produces output signals to driver 110 indicating the activation pattern of the mirrors in the DMA 18. A/D converter 114 is conventional in nature and receives the voltage signals from detector 20, amplifies these signals as analog input to the converter in order to produce a digital output representative of the voltage signals.

Radiation source 12, grating 16, DMA 18 slit assembly 30 and detector 20 cooperatively define an optical pathway. Radiation from source 12 is passed through a wavelength dispersion device, which separates in space different spectrum bands. The desired radiation spectrum can them be shaped by DMA 18 using the filter arrangement outlined in Section I(B)(i). In accordance with a preferred embodiment, radiation falling on a particular micro-mirror element can also be encoded with a modulation pattern applied to it. In a specific mode of operating the device, DMA 18 is activated to reflect radiation in a successive set of encoding patterns, such as Hadamard, Fourier, wavelet or others. The resultant set of spectral components is detected by detector 20, which provides corresponding output signals. Computer 22 then processes these signals.

Computer 22 initiates an analysis by prompting pattern generator 108 to activate the successive encoding patterns. With each pattern, a set of wavelength components are resolved by grating 16 and after reflection from the DMA 18 is directed onto detector 20. Along with the activation of encoding patterns, computer 22 also takes readings from A/D converter 114, by sampling data. These readings enable computer 22 to solve a conventional inverse transform, and thereby eliminate background noise from the readings for analysis.

In summary, the active light source in accordance with the present invention consists of one or more light sources, from which various spectral bands are selected for transmission, while being modulated with a temporal and/or spatial patterns. The resulting radiation is then directed at a region (or material) of interest to achieve a variety of desired tasks. A brief listing of these tasks include: (a) Very precise spectral coloring of a scene, for purposes of enhancement of display and photography; (b) Precise illumination spectrum to correspond to specific absorption lines of a compound that needs to be detected, (see FIGS. 38-42 on protein in wheat as an illustration) or for which it is desirable to have energy absorption and heating, without affecting neighboring compounds (This is the principle of the microwave oven for which the radiation is tuned to be absorbed by water molecules allowing for heating of moist food only); (c) The procedure in (b) could be used to imprint a specific spectral tag on ink or paint, for watermarking, tracking and forgery prevention, acting as a spectral bar code encryption; (d) The process of light curing to achieve selected chemical reactions is enabled by the tunable light source.

Various other applications are considered in further detail in Section IV. Duality allows one to reverse or “turn inside out” any of the post-sample processing configurations described previously, to yield a pre-sample processing configuration. Essentially, in the former case one takes post sample light, separates wavelengths, encodes or modulates each, and detects the result. The dualized version for the latter case is to take source light, separates wavelengths, encode or modulate each, interact with a sample, and detect the result

### III. OPTICAL ENCODING, DECODING AND SIGNAL PROCESSING

The preceding two sections disclosed various embodiments of systems for performing post- and pre-sample processing. In a specific embodiment, the central component of the system is a digital micro-mirror array (DMA), in which individual elements (micro-mirrors) can be controlled separately to either pass along or reject certain radiation components. By the use of appropriately selected modulation patterns, the DMA array can perform various signal processing tasks. In a accordance with a preferred embodiment of this invention, the functionality of the DMAs discussed above can be generalized using the concept of Spatial Light Modulators (SLMs), devices that broadly perform spatio-spectral encoding of individual radiation components, and of optical synapse processing units (OSPUs), basic processing blocks. This generalization is considered in subsection III.A, followed by discussions of Hadamard processing, spatio-spectral tagging, data compression, feature extraction and other signal processing tasks.

A. Basic Building Blocks

(i) Spatial Light Modulators (SLMs)

In accordance with the present invention, one-dimensional (1D), two-dimensional (2D) or three-dimensional (3D) devices capable of acting as a light valve or array of light valves are referred to as spatial light modulators (SLMs). More broadly, an SLM in accordance with this invention is any device capable of controlling the magnitude, power, intensity or phase of radiation or which is otherwise capable of changing the direction of propagation of such radiation. This radiation may either have passed through, or be reflected or refracted from a material sample of interest. In a preferred embodiment, an SLM is an array of elements, each one capable of controlling radiation impinging upon it. Note that in accordance with this definition an SLM placed in appropriate position along the radiation path can control either spatial or spectral components of the impinging radiation, or both. Furthermore, “light” is used here in a broad sense to encompass any portion of the electromagnetic spectrum and not just the visible spectrum. Examples of SLM's in accordance with different embodiments of the invention include liquid crystal devices, actuated micro-mirrors, actuated mirror membranes, di-electric light modulators, switchable filters and optical routing devices, as used by the optical communication and computing environments and optical switches. In a specific embodiment, Sections 1A and 1B discussed the use of a DMA as an example of spatial light modulating element. U.S. Pat. No. 5,037,173 provides examples of technology that can be used to implement SLM in accordance with this invention, and is hereby incorporated by reference.

In a preferred embodiment, a 1D, 2D, or 3D SLM is configured to receive any set of radiation components and functions to selectively pass these components to any number of receivers or image planes or collection optics, as the application may require, or to reject, reflect or absorb any input radiation component, so that either it is or is not received by one or more receivers, image planes or collection optics devices. It should be clear that while in the example discussed in Section I above the SLM is implemented as a DMA, virtually any array of switched elements may be used in accordance with the present invention.

Generally, an SLM in accordance with the invention is capable of receiving any number of radiation components, which are then encoded, tagged, identified, modulated or otherwise changed in terms of direction and/or magnitude to provide a unique encodement, tag, identifier or modulation sequence for each radiation component in the set of radiation components, so that subsequent optical receiver(s) or measuring device(s) have the ability to uniquely identify each of the input radiation components and its properties. In a relevant context, such properties include, but are not limited to, irradiance, wavelength, band of frequencies, intensity, power, phase and/or polarization. In Sections I and II above, tagging of individual radiation components is accomplished using rate modulation. Thus, in Section I, different spectral components of the input radiation that have been separated in space using a wavelength dispersion device are then individually encoded by modulating the micro-mirrors of the DMA array at different rates. The encoded radiation components are directed to a single detector, but nevertheless can be analyzed individually using Fourier analysis of the signal from the detector. Other examples for the use of “tagging” are discussed below.

(ii) The Optical Synapse Processing Unit (OSPU)

In accordance with this invention, various processing modalities can be realized with an array of digitally controlled switches (an optical synapse), which function to process and transmit signals between different components of the system. In the context of, the above description, the basic OSPU can be thought of as a data acquisition unit capable of scanning an array of data, such as an image, in various modes, including raster, Hadamard, multiscale wavelets, and others, and transmitting the scanned data for further processing. Thus, a synapse is a digitally controlled array of switches used to redirect image (or generally data) components or combinations of light streams, from one location to one or more other locations. In particular it can perform Hadamard processing, as defined below, on a plurality of radiation elements by combining subsets of the elements (i.e., binning) before conversion to digital data. A synapse can be used to modulate light streams by modulating temporally the switches to impose a temporal bar code (by varying in time the binning operation). This can be built in a preferred embodiment from a DMA, or any of a number of optical switching or routing components, used for example in optical communications applications.

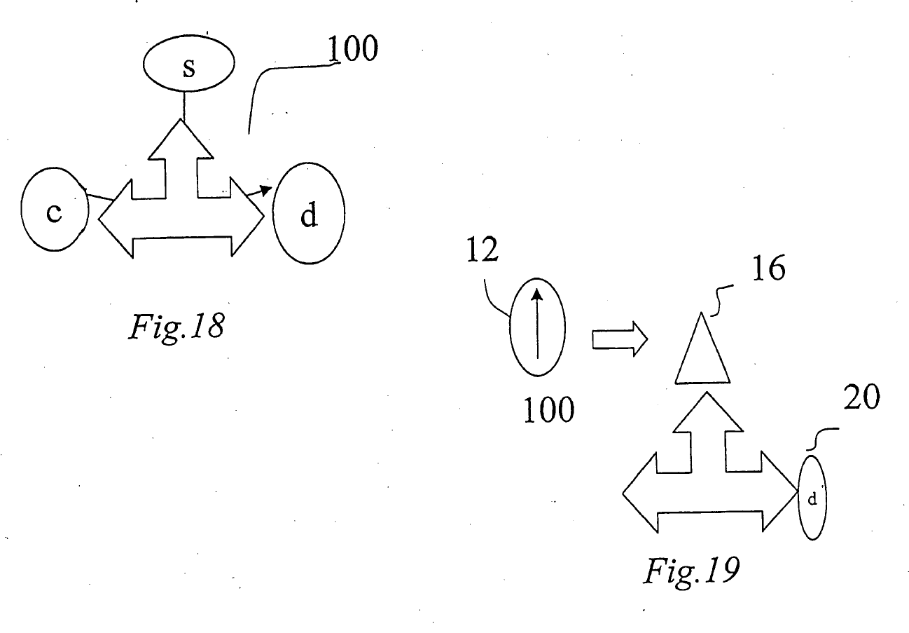

An OSPU unit in accordance with the present invention is shown in diagram form in FIG. 18A and 18B, as three-port device taking input from a radiation source S, and distributing it along any of two other paths, designated C (short for camera) and D (for detector). Different scanning modes of the OSPU are considered in more detail in Section III.B. below.

In the above disclosure and in one preferred embodiment of the invention an OSPU is implemented using a DMA, where individual elements of the array are controlled digitally to achieve a variety of processing tasks while collecting data. In accordance with the present invention, information bearing radiation sources could be, for example, a stream of photons, a photonic wavefront, a sound wave signal, an electrical signal, a signal propagating via an electric field or a magnetic field, a stream of particles, or a digital signal. Example of devices that can act as a synapse include spatial light modulators, such as LCDs, MEMS mirror arrays, or MEMS shutter arrays; optical switches; optical add-drop multiplexers; optical routers; and similar devices configured to modulate, switch or route signals. Clearly, DMAs and other optical routing devices, as used by the optical communication industry can be used to this end. It should be apparent that liquid crystal displays (LCD), charge coupled devices (CCD), CMOS logic, arrays of microphones, acoustic transducers, or antenna elements for electromagnetic radiation and other elements with similar functionality that will be developed in the future, can also be driven by similar methods.

Applicants' contribution in this regard is in the novel process of performing pre-transduction digital computing on analog data via adaptive binning means. Such novelty can be performed in a large number of ways. For example, one can implement adaptive current addition using a parallel/serial switch and wire networks in CMOS circuits. Further, in the acoustic processing domain, one or more microphones can be used in combination with an array of adjustable tilting sound reflectors (like a DMD for sound). In each case, one can “bin” data prior to transduction, in an adaptive way, and hence measure some desired computational result that would traditionally be obtained by gathering a “data cube” of data, and subsequently digitally processing the data. The shift of paradigm is clear: in the prior art traditionally analog signals are captured by a sensor, digitized, stored in a computer as a “data cube”, and then processed. Considerable storage space and computational requirements are extended to do this processing. In accordance with the present invention, data from one or more sensors is processed directly in the analogue domain, the processed result is digitized and sent to a computer, where the desired processing result may be available directly, or following reduced set of processing operations.

In accordance with the present invention, the digitally controlled array is used as a hybrid computer, which through the digital control of the array elements performs (analog) computation of inner products or more generally of various correlations between data points reaching the elements of the array and prescribed patterns. The digital control at a given point (i.e., element) of the array may be achieved through a variety of different mechanisms, such as applying voltage differences between the row and column intersecting at the element; the modulation is achieved by addressing each row and column of the array by an appropriately modulated voltage pattern. For example, when using DMA, the mirrors are fluctuating between two tilted positions, and modulation is achieved through the mirror controls, as known in the art. The specifics of providing to the array element of signal(s) following a predetermined pattern will depend on the design implementation of the array and are not considered in further detail. Broadly, the OSPU array is processing raw data to extract desired information.

In accordance with the present invention, various assemblies of OSPU along with other components can be used to generalize the ideas presented above and enable new processing modalities. For example, FIG. 19 illustrates in block diagram form the design of a spectrograph using OSPU. As shown, the basic design brings reflected or transmitted radiation from a line in the sample or source onto a dispersing device 16, such as a grating or prism, onto the imaging fiber into the OSPU to encode and then forward to a detector 20.

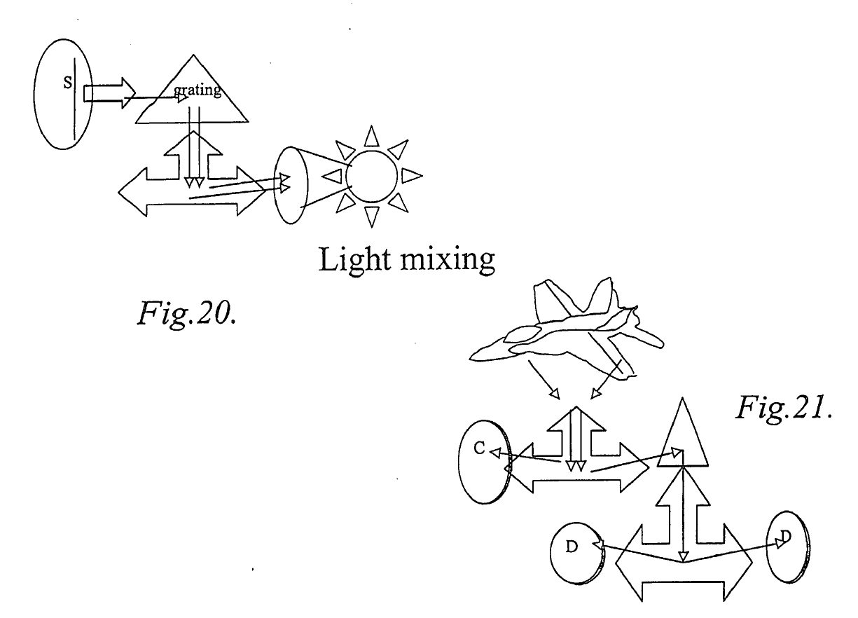

FIG. 20 illustrates in a diagram form an embodiment of a tunable light source, which operates as the spectrograph in FIG. 19, but uses a broadband source. In this case, the switching elements of the OSPU array, for example the mirrors in a DMA, are set to provide a specified energy in each row of the mirror, which is sent to one of the outgoing imaging fiber bundles. This device can also function as a spectrograph through the other end, i.e., fiber bundle providing illumination, as well as spectroscopy.

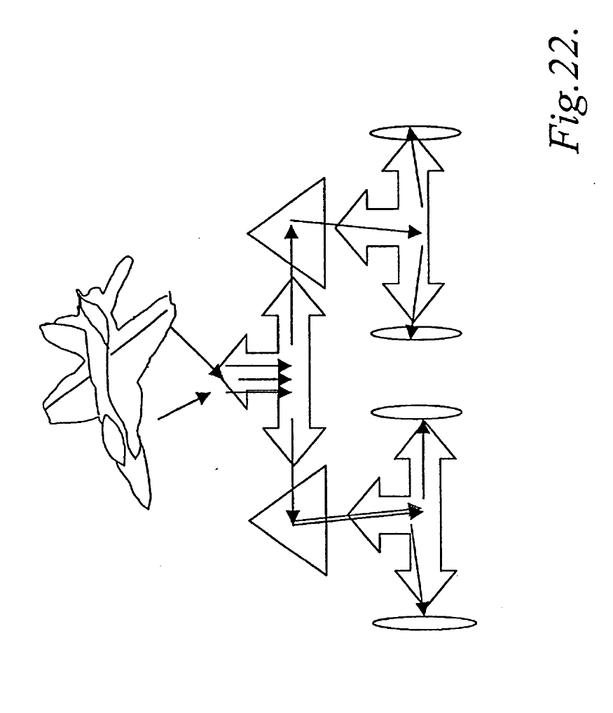

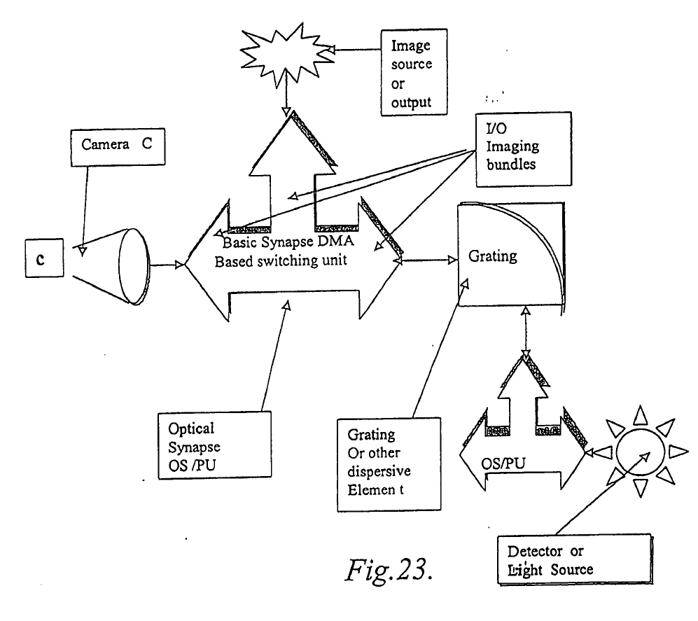

FIG. 21 illustrates in a diagram form an embodiment of the spectral imaging device discussed in Section I above, which is built with two OSPUs. Different configurations of generalized processing devices are illustrated in FIG. 22, in which each side is imaging in a different spectral band, and FIG. 23, which illustrates the main components of a system for processing input radiation using an OSPU.

B. Scanning an Area of Interest

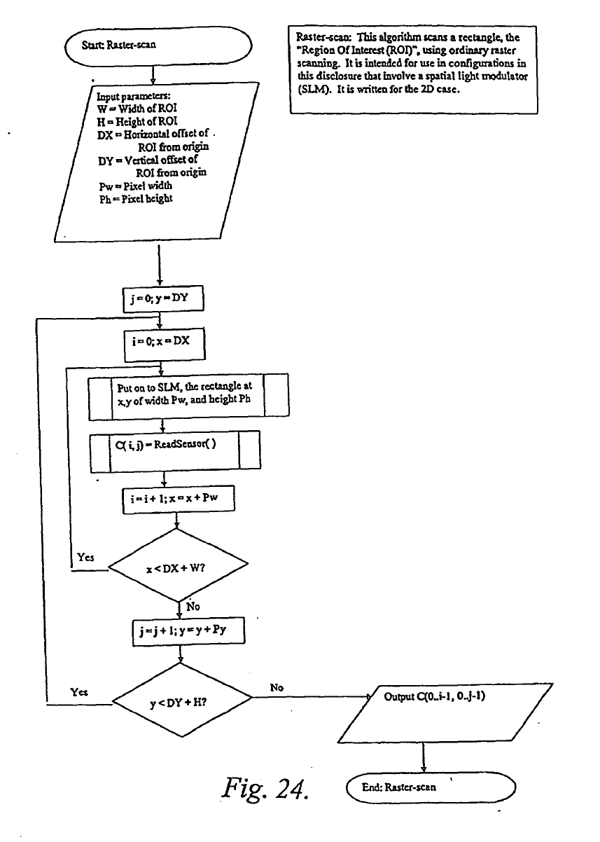

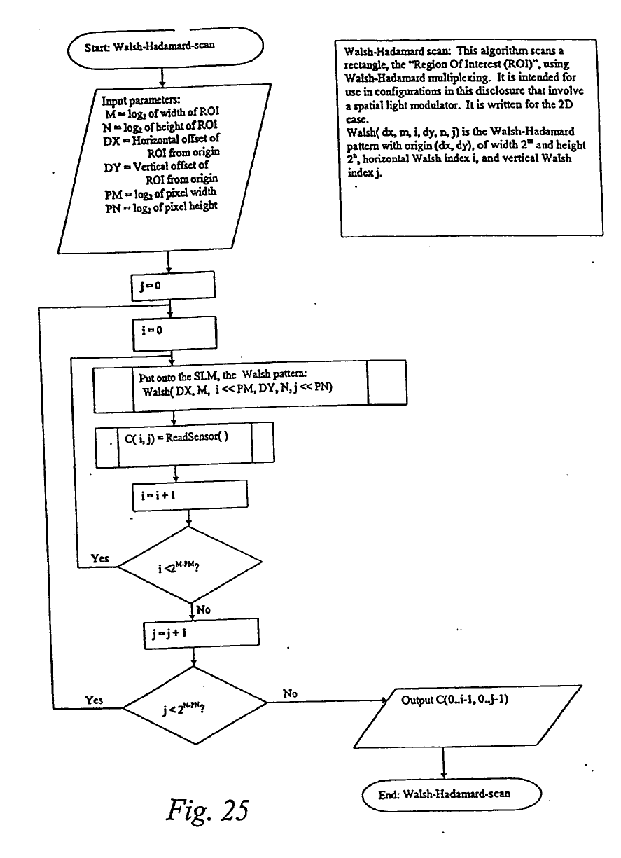

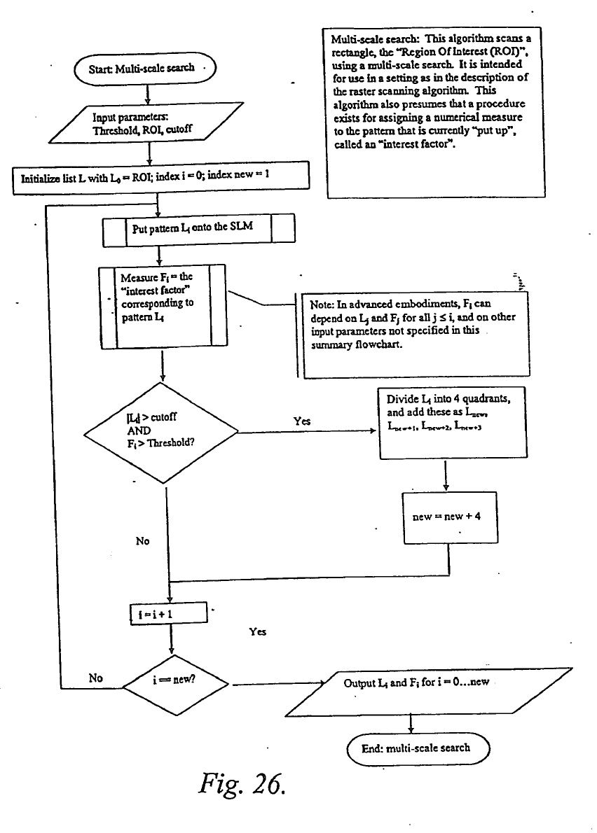

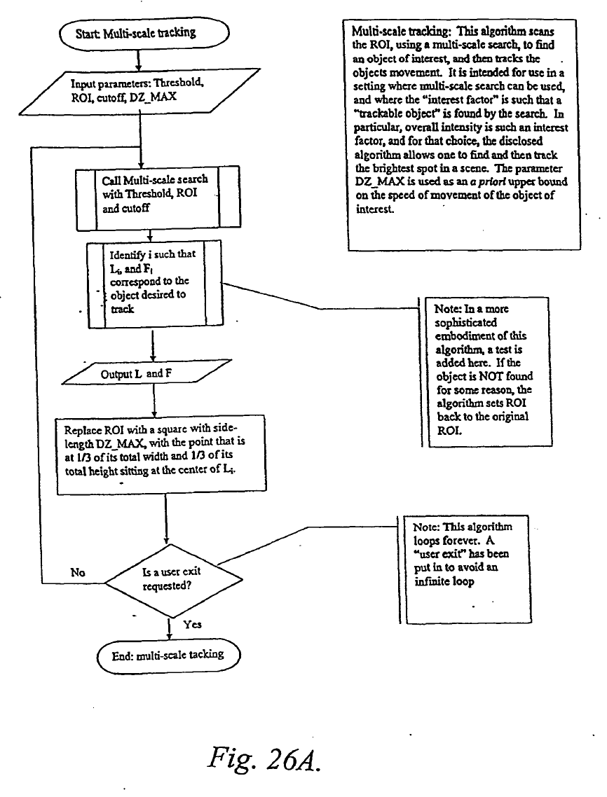

In accordance with the present invention, different scanning modes can be used in different applications, as illustrated in FIG. 24, FIG. 25 and FIG. 26. These algorithms are of use, for example, when one is using an OSPU in conjunction with a single sensor, and the OSPU is binning energy into that sensor, the binning being determined by the pattern that is put onto the SLM of the OSPU.

In particular, FIG. 24 is a flow chart of a raster-scan using in one embodiment of the present invention. This algorithm scans a rectangle, the “Region Of Interest (ROI),” using ordinary raster scanning. It is intended for use in configurations in this disclosure that involve a spatial light modulator (SLM). It is written for the 2D case, but the obvious modifications will extend the algorithm to other dimensions, or restrict to 1D.

FIG. 25 is a flowchart of a Walsh-Hadamard scan used in accordance with another embodiment of the invention. This algorithm scans a rectangle, the “Region Of Interest (ROI)”, using Walsh-Hadamard multiplexing. Walsh(dx, m, i, dy, n, j) is the Walsh-Hadamard pattern with origin (dx, dy), of width 2^{m} and height 2ⁿ, horizontal Walsh index i, and vertical Walsh index j.

FIG. 26 is a flowchart of a multi-scale scan. This algorithm scans a rectangle, the “Region Of Interest (ROI)”, using a multi-scale search. It is intended for use in a setting as in the description of the raster scanning algorithm. The algorithm also presumes that a procedure exists for assigning a numerical measure to the pattern that is currently on is called an “interest factor.”

FIG. 26A illustrates a multi-scale tracking algorithm in a preferred embodiment of the present invention. The algorithm scans the region of interest, (using multi-scan search), to find an object of interest and then tracks the object's movement across the scene. It is intended for use in a setting where multi-scale search can be used, and where the “interest factor” is such that a trackable object can be found. Examples of interest factors used in accordance with a preferred embodiment (when pattern Lᵢ is put onto the SLM, the sensor reads Cᵢ and we are defining the “interest factor” Fᵢ). In the preceding scan algorithms a single sensor is assumed. Thus

F(Lᵢ)=Cᵢ 1.

F(Lᵢ)=Cᵢ/area(Lᵢ) 2.

F(Lᵢ)=Cᵢ/Cₖ, 3.

where Lₖ is the rectangle that contains Lᵢ, and that has N times the area of Lᵢ, (for example, N=4), and which has already been scanned by the algorithm (there will always be exactly one such).

A modification of the algorithm is possible, where instead of putting up the pattern Lᵢ, one can put up a set of a few highly oscillatory Walsh patterns fully supported on exactly Lᵢ, and take the mean value of the sensor reading as Fᵢ. This estimates the total variation within Lᵢ and will yield an algorithm that finds the edges within a scene. In different examples the sensor is a spectrometer. F(Lᵢ)=distance between the spectrum read by the sensor, and the spectrum of a compound of interest. (distance could be, e.g., Euclidean distance of some other standard distance). This will cause the algorithm to zoom in on a substance of interest.

In another embodiment, F(Lᵢ)=distance between the spectrum read by the sensor, and the spectrum already read for Lₖ, where Lₖ is the rectangle that contains Lᵢ, and that has N (N=4) times the area of Lᵢ, and which has already bee scanned by the algorithm (there will always be exactly one such). This will cause the algorithm to zoom in on edges between distinct substances.

In yet another embodiment, F(Lᵢ)=distance between the spectrum read by the sensor, and the spectrum already read for L₀. This will cause the algorithm to zoom in on substances that are anomalous compared to the background.

In derived embodiments, F(Lᵢ) can depend on a priori data from spectral or spatio-spectral libraries.

By defining the interest factor appropriately, one can thus cover a range of different applications. In a preferred embodiment, the interest factor definitions can be pre-stored so a user can analyze a set of data using different interest factors.

It is also clear that, in the case of Walsh functions, because of the multi-scale nature of the Walsh patterns, one can combine raster and Walsh-Hadamard scanning (raster scanning at large scales, and using Walsh-Hadamard to get extra signal to noise ratio at fine scales, where it is needed most). This allows one to operate within the linear range of the detector.

Also, one can used the combined raster/Walsh idea in variations of the Multi-scale search and tracking algorithms. For this, whenever one is studying the values of a sensor associated with the sub-rectangles of a bigger rectangle, one could use the Walsh patterns at the relevant scale, instead of scanning the pixels at that scale. This will provide for an improvement in SNR. One could again do this only at finer scales, to stay in the detectors linearity range.

C. Hadamard and Generalized Hyperspectral Processing

Several signal processing tasks, such as filtering, signal enhancement, feature extraction, data compression and others can be implemented efficiently by using the basic ideas underlying the present invention. The concept is first illustrated in the context of one-dimensional arrays for Hadamard spectroscopy and is then extended to hyperspectral imaging and various active illumination modes. The interested reader is directed to the book “Hadamard Transform Optics” by Martin Harwit, et al., published by Academic Press in 1979, which provides an excellent overview of the applied mathematical theory and the degree to which common optical components can be used in Hadamard spectroscopy and imaging applications.

Hadamard processing refers generally to analysis tools in which a signal is processed by correlating it with strings of 0 and 1 (or ±1). Such processing does not require the signal to be converted from analogue to digital, but permits direct processing on the analog data by means of an array of switches (synapse). In a preferred embodiment of the invention, an array of switches, such as a DMA, is used to provide spatio-spectral tags to different radiation components. In alternative embodiments it can also be used to impinge spatio/spectral signatures, which directly correlate to desired features.

A simple way to explain Hadamard spectroscopy is to consider the example of the weighing schemes for a chemical scale. Assume that we need to weigh eight objects, x₁, x₂ . . . x₈, on a scale. One could weigh each object separately in a process analogous to performing a raster scan, or balance two groups of four objects. Selecting the second approach, assuming that the first four objects are in one group, and the second four in a second group, balancing the two groups can be represented mathematically using the expression:

m=x₁+x₂+x₃+x₄−(x₅+x₆+x₇+x₈)=(x, w),

where x is a vector, the components of which correspond to the ordered objects xi,=(1,1,1,1,−1,−1,−1,−1) and (x, w) designates the inner product of the two vectors. Various other combinations of object groups can be obtained and mathematically expressed as the inner product of the vector x and a vector of weights w, which has four +1 and four −1 elements.

For example, w=(1, −1, 1, 1, −1, −1, 1,−1) indicates that x₁,x₃,x₄,x₇ are on the left scale while x₂ x₅ x₆ x₈ are on the right. The inner product, or weight M=(x, w) is given by the expression:

m=(x,w)=x₁−x₂+x₃+x₄−x₅−x₆+x₇−x₈

It is well known that if one picks eight mutually orthogonal vectors wᵢ which correspond, for example, to the eight Walsh patterns, one can recover the weight xᵢ of each object via the orthogonal expansion method

x=[(x, w₁)w₁+(x, w₂)w₂+ . . . +(x,w₈)w₈],

or in matrix notation

[W]x=m; x=[W]⁻¹ m

where [W] is the matrix of orthogonal vectors, m is the vector of measurements, and [W]⁻¹ is the inverse of matrix [W].

It is well known that the advantage of using the method is its higher-accuracy, more precisely if the error for weighing measurement is ε, the expected error for the result calculated from the combined measurements is reduced by the square root of the number of samples. This result was proved by Hotteling to provide the best reduction possible for a given number of measurements.

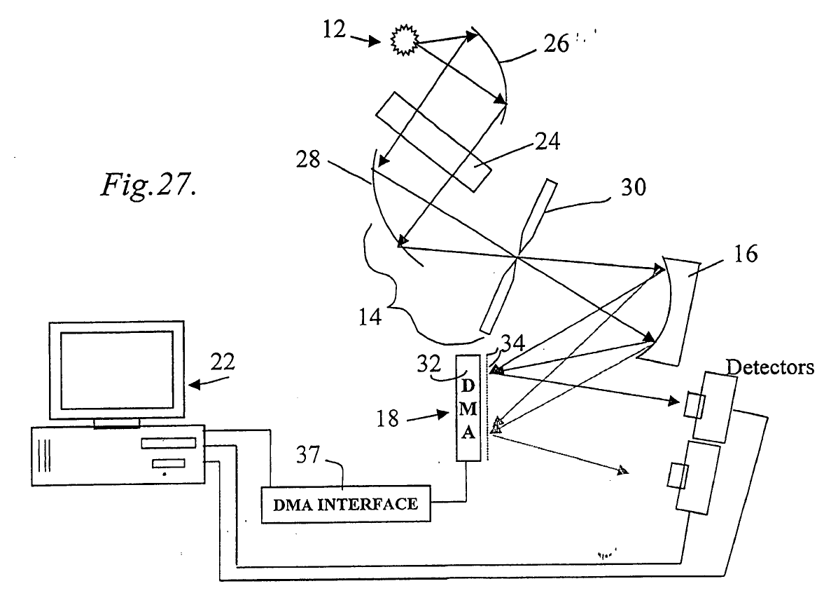

In accordance with the present invention, this signal processing technique finds simple and effective practical application in spectroscopy, if we consider a spectrometer with two detectors (replacing the two arms of the scales). With reference to FIG. 27, the diffraction grating sends different spectral lines into an eight mirror array, which redistributes the energy to the 2 detectors in accordance with a given pattern of +1/ -1 weights, i.e., wᵢ=(1,−1,1,1,−1,−1,1,−1). Following the above analogy, the difference between the output values of the detectors corresponds to the inner product m=(x,wᵢ). If one is to redistribute the input spectrum energy to the 2 spectrometers using eight orthogonal vectors of weights, (following the pattern by alternating the mirror patterns to get eight orthogonal configurations), an accurate measurement of the source spectrum can be obtained. This processing method has certain advantages to the raster scan in which the detector measures one band at a time.

Clearly, for practical applications a precision requiring hundreds of bands may be required to obtain accurate chemical discrimination. However, it should be apparent that if one knows in advance which bands are needed to discriminate two compounds, the turning of the mirrors to only detect these bands could provide such discrimination with a single measurement.

Following is a description of a method for selecting efficient mirror settings to achieve discrimination using a minimum number of measurements. In matrix terminology, the task is to determine a minimum set of orthogonal vectors.

In accordance with the present invention, to this end one can use the Walsh-Hadamard Wavelet packets library. As known, these are rich collections of _{—}1, 0 patterns which will be used as elementary analysis patterns for discrimination. They are generated recursively as follows: (a) first, double the size of the pattern w in two ways either as (w,w) or as (w,−w). It is clear that if various n patterns wᵢ of length n are orthogonal, then the 2n patterns of length 2n are also orthogonal. This is the simplest way to generate Hadamard-Walsh matrices.

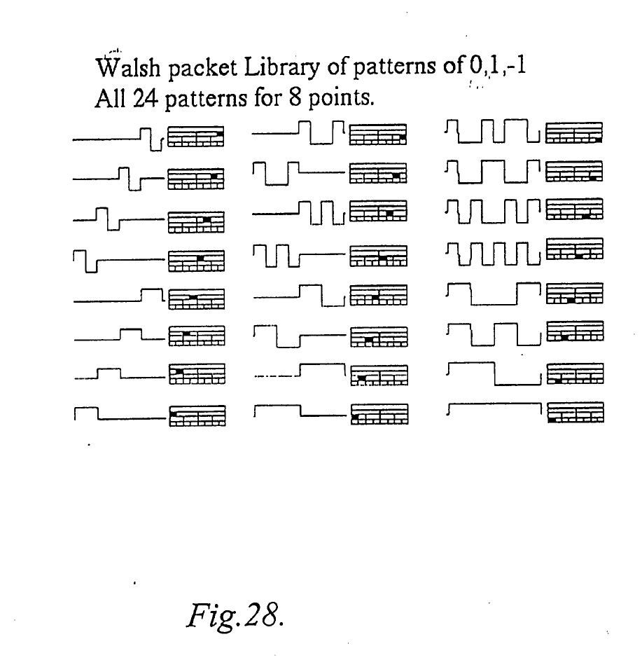

The wavelet packet library consists of all sequences of length N having broken up in 2^{m} blocks, all except one are 0 and one block is filled with a Walsh pattern (of _{—}1) of length 2— where _+m=n. As known, a Walsh packet is a localized Walsh string of _{—}1. FIG. 28 illustrates all 24 library elements for N=8.

A correlation of a vector x with a Walsh packet measures a variability of x at the location where the packet oscillates. The Walsh packet library is a simple and computationally efficient analytic tool allowing sophisticated discrimination with simple binary operations. It can be noted that in fact, it is precisely the analog of the windowed Fourier transform for binary arithmetic.

As an illustration, imagine two compounds A and B with subtle differences in their spectrum. The task is to discriminate among them in a noisy environment and design efficient mirror configurations for DMA spectroscope. In accordance with a preferred embodiment, the following procedure can be used:

(1) Collect samples for both A and B, the number of samples collected should be representative of the inherent variability of the measurements. A sample in this context is a full set x of the spectrum of the compound.

(2) Compute the inner product (x, w) for all samples X of A and (y, w) for all samples Y of B for each fixed Walsh product w.

(3) Measure the discrimination power pw of the pattern w to distinguish between compound A and B. This could be done by comparing the distribution of the numbers {(x·w)} to the distribution of the numbers {(y, w)}, where the farther apart these distributions, the better they can be distinguished.

(4) Select an orthogonal basis of patterns w maximizing the total discrimination power and order them in decreasing order.

(5) Pick the top few patterns as an input to a multidimensional discrimination method.

As an additional optional step in the above procedure, experiments can be run using data on which to top few selected patterns failed, and repeat steps 3, 4 and 5.

Because of the recursive structure of the W-packet library, it is possible to achieve 2+3+4 in N log 2 N computations per sample vector of length N, i.e. essentially at the rate data collection. It should be noted that this procedure of basis selection for discrimination can also be used to enhance a variety of other signal processing tasks, such as data compression, empirical regression and prediction, adaptive filter design and others. It allows to define a simple orthogonal transform into more useful representations of the raw data. Further examples are considered below and illustrated in Section IV in the wheat protein example.

In this Section we considered the use of Hadamard processing to provide simple, computationally efficient and robust signal processing. In accordance with the present invention, the concept of using multiple sensors and/or detectors can be generalized to what is known as hyperspectral processing.

As known, current spectroscopic devices can be defined broadly into two categories point spectroscopy and hyperspectral imaging. Point spectroscopy in general involves a single sensor measuring the electromagnetic spectrum of a single sample (spatial point).

This measurement is repeated to provide a point-by-point scan of a scene of interest. A scene of interest may include one or more objects of interest. In contrast, hyperspectral imaging generally uses an array of sensors and associated detectors. Each sensor corresponds to the pixel locations of an image and measures a multitude of spectral bands.

The objective of this imaging is to obtain a sequence of images, one for each spectral band.

At present, true hyperspectral imaging devices, having the ability to collect and process the full combination of spectral and spatial data are not really practical as they require significant storage space and computational power.

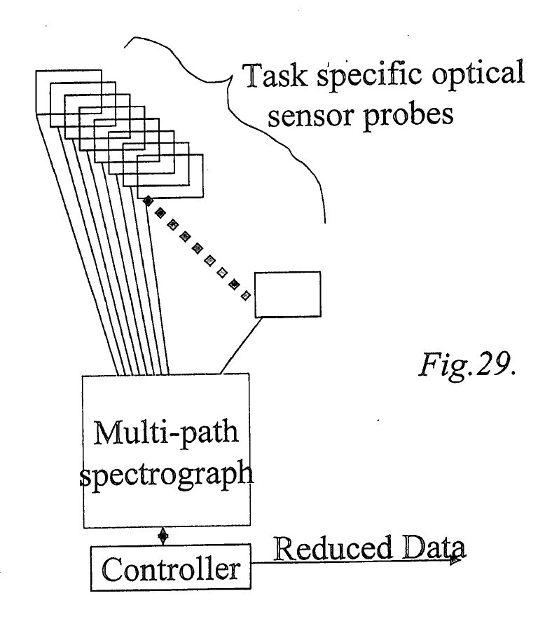

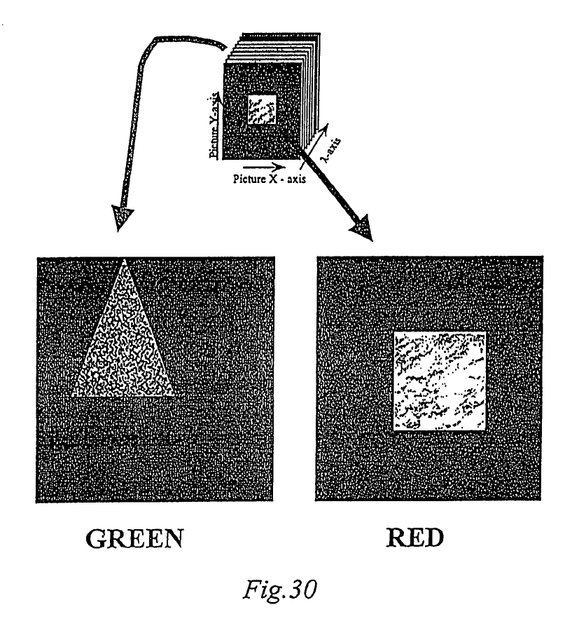

In accordance with the present invention, significant improvement over the prior art can be achieved using hyperspectral processing that focuses of predefined characteristics of the data. For example, in many cases only a few particular spectral lines or bands out of the whole data space are required to discriminate one substance over another. It is also often the case that target samples do not posses very strong or sharp spectral lines, so it may not be necessary to use strong or sharp bands in the detection process. A selection of relatively broad bands may be sufficient do discriminate between the target object and the background. It should be apparent that the ease with which different spatio-spectral bands can be selected and processed in accordance with the present invention is ideally suited for such hyperspectrum applications. A generalized block diagram of hyperspectral processing in accordance with the invention is shown in FIG. 29. FIG. 30 illustrates two spectral components (red and green) of a data cube produced by imaging the same object in different spectral bands. It is quite clear that different images contain completely different kinds of information about the object. The same idea is illustrated in FIGS. 31 and 32, where FIG. 31 illustrates hyperspectral imaging from airborne camera and shows how one can identify different crops in a scene, based on the predominant spectral characteristic of the crop. FIG. 32 is an illustration of a hyperspectral image of human skin with spectrum progressing from left to right and top to bottom, with increasing wavelength.

FIGS. 31A-E illustrate different embodiments of an imaging spectrograph in de-dispersive mode, that can be used in accordance with this invention for hyperspectral imaging in the UV, visual, near infrared and infrared portions of the spectrum. For illustration purposes, the figures show a fiber optic probe head with a fixed number of optical fibers. As shown, the fiber optic is placed at an exit slit. It will be apparent that a multitude of fiber optic elements and detectors can be used in alternate embodiments.

FIG. 32 shows an axial and cross-sectional view of the fiber optic assembly illustrated in FIGS. 31A-E .

FIG. 33 shows a physical arrangement of the fiber optic cable, detector and the slit.

FIG. 34 illustrates a fiber optic surface contact probe head abutting tissue to be examined;

FIG. 35A and 35B illustrate a fiber optic e-Probe for pierced ears that can be used for medical monitoring applications in accordance with the present invention.

FIG. 36A, 36B and 36C illustrate different configurations of a hyperspectral adaptive wavelength advanced illuminating imaging spectrograph (HAWAIIS).

In FIG. 36A, DMD (shown illuminating the −1 order) is a programmable spatial light modulator that is used to select spatio/spectral components falling upon and projecting from the combined entrance/exit slit. The illumination is fully programmable and can be modulated by any contiguous or non-contiguous combination at up to 50 KHz. The corresponding spatial resolution element located at the Object/sample is thus illuminated and is simultaneously spectrally imaged by the CCD (located in order +1 with efficiency at 80%) as in typical CCD imaging spectrographs used for Raman spectral imaging.

With reference to FIGS. 36, the output of a broadband light source such as a TQH light bulb(1001) is collected by a collection optic (lens 1002) and directed to a spatial light modulator such as the DMA used in this example(1003). Specific spatial resolution elements are selected by computer controlled DMA driver to propagate to the transmission diffraction grating(1005) via optic (lens 1004). The DMA(1003) shown illuminating the −1 order of the transmission diffraction grating(1005) is a programmable spatial light modulator that is used to select spatio/spectral resolution elements projecting through the entrance/exit slit(#1007) collected and focused upon the sample(1009) by optic (lens 1008). The spatio/spectral resolution elements illuminating the sample are fully programmable. The sample is thus illuminated with specific and known spectral resolution elements. The reflected spectral resolution elements from specific spatial coordinates at the sample plane are then collected and focused back through the entrance/exit slit by optic (lens 1008). Optic (lens 1006) collimates the returned energy and presents it to the transmission diffraction grating(1005). The light is then diffracted preferentially into the +1 order and is subsequently collected and focused by the optic (lens 1010) onto a 2D dector array(1011). This conjugate spectral imaging device has the advantage of rejecting out of focus photons from the sample. Spectral resolution elements absorbed or reflected are measured with spatial specificity by the device.

FIGS. 43-47(A-D) illustrate hyperspectrum processing in accordance with the present invention, including data maps, encodement mask, DMA programmable resolution using different numbers of mirrors and several encodegrams.

D. Spatio-Spectral Tagging

One of the most important aspects of the present invention is the use of modulation of single array elements or groups of array elements to “tag” radiation impinging on these elements with its own pattern of modulation. In essence, this aspect of the invention allows to combine data from a large number of array elements into a few processing channels, possibly a single channel, without losing the identity of the source and/or the spatial or spectral distribution of the data.

As known in the art, combination of different processing channels into a smaller number of channels is done using signal multiplexing. In accordance with the present invention, multiplexing of radiation components which have been “tagged” or in some way encoded to retain the identity of their source, is critical in various processing tasks, and in particular enables simple, robust implementations of practical devices. Thus, for example, in accordance with the principles of the present invention, using a micro mirror array, an optical router, an on-off switch (such as an LCD screen), enables simplified and robust image formation with a single detector and further makes possible increasing the resolution of a small array of sensors to any desired size, as discussed in Section IV next.

The important point in this respect is that in accordance with this invention, methods for digitally-controlled modulation of sensor arrays are used to perform signal processing tasks while collecting data. Thus, the combination and binning of a plurality of radiation sources is manipulated in accordance with this invention to perform calculations on the analog data, which is traditionally done in the digital data analysis process. As a result, a whole processing step can be eliminated by preselecting the switching modulation to perform the processing before the A/D conversion, thereby only converting data quantities of interest. This aspect of the present invention enables realtime representation of the final processed data, which in processing-intense applications can be critical.

E. Data Compression, Feature Extraction and Diagnostics

By modulating the SLM array used in accordance with this invention, so as to compute inner products with elements of an orthogonal basis, the raw data can be converted directly on the sensor to provide the data in transform coordinates, such as Fourier transform, Wavelet transform, Hadamard, and others. This is in fact a key aspect of the resent invention, and the reason why it is important is that the amount of data collected is so large that it may swamp the processor or result in insufficient bandwidth for storage and transmission. As known in the art, without some compression many imaging devices may become useless. As noted above, for hyperspectral imaging a full spectrum (a few hundred data points) is collected for each individual pixel resulting in a data glut. Thus, compression and feature extraction are essential to enable a meaningful image display. It will be appreciated that the resulting data file is typically much smaller, providing significant savings in both storage and processing requirements. A simple example is the block 8×8 Walsh expansion, which is automatically computed by appropriate mirror modulation, the data measured is the actual compressed parameters.

In another related aspect of the present invention, data compression can also be achieved by building an orthogonal basis of functions retaining the important features for the task at hand. In a preferred embodiment, this can be achieved by use of the best basis algorithm. See, for example, Coifman, R. R. and Wickerhauser, M. V., “Entropy-based Algorithms for Best Basis Selection”, IEEE Trans. Info. Theory 38 (1992), 713-718, and U.S. Pat. Nos. 5,526,299 and 5,384,725 to one of the inventors of this application. The referenced patents and publications are incorporated herein by reference.

By means of background, it is known that the reduction of dimensionality of a set of data vectors can be accomplished using the projection of such a set of vectors onto a orthogonal set of functions, which are localized in time and frequency. In a preferred embodiment, the projections are defined as correlation of the data vectors with the set of discretized re-scaled Walsh functions, but any set of appropriate functions can be used instead, if necessary.

The best basis algorithm to one of the co-inventors of this application provides a fast selection of an adapted representation for a signal chosen from a large library of orthonormal bases. Examples of such libraries are the local trigonometric bases and wavelet packet bases, both of which consist of waveforms localized in time and frequency. An orthonormal basis in this setting corresponds to a tiling of the time-frequency plane by rectangles of area one, but an arbitrary such tiling in general does not correspond to an orthonormal basis. Only in the case of the Haar wavelet packets is there a basis for every tiling, and a fast algorithm to find that basis is known. See, Thiele, C. and Villemoes, L., “A Fast Algorithm for Adapted Time-Frequency Tilings”, Applied and Computational Harmonic Analysis 3 (1996), 91-99, which is incorporated by reference.

Walsh packet analysis is a robust, fast, adaptable, and accurate alternative to traditional chemometric practice. Selection of features for regression via this method reduces the problems of instability inherent in standard methods, and provides a means for, simultaneously optimizing and automating model calibration.

The Walsh system {Wₙ}ₙ₌₀^{∞} is defined recursively by

W₂ₙ(t)=Wₙ(2t)+(−1)ⁿWₙ(2t−1)

W₂ₙ₊₁(t)=Wₙ(2t)−(−1)ⁿWₙ(2t−1)

With W₀(t)=1 on 0≦t<1. If [0,1[x[0,∞[ is the time frequency plane, dyadic rectangles are subsets of the form

I×ω=[2^{-j}k,2^{-j}(k+1)]×[2^{m}n,2^{m}(n+1)],

with j, k, m and n non-negative integers, and the tiles are the rectangles of area one (j=m). A tile p is associated with a rescaled Walsh function by the expression

wₚ(t)=2^{j/2}Wₙ(2^{j}t−k)

Fact: The function wₚ and w_{q} are orthogonal if and only if the tiles p and q are disjoint. Thus, any disjoint tiling will give rise to an orthonormal basis of L²(0,1) consisting of rescaled Walsh functions. For any tiling B, we may represent a function f as

$$f = {\sum }_{p ∈ B}^{} ⟩ f , {w}_{p} ⟨ {w}_{p}$$

and may find an optimal such representation for a given additive cost functional by choosing a tiling minimizing the cost evaluated on the expansion coefficients.

In Section IV we consider an example contrasting the use of adaptive Walsh packet methods with standard chemometrics for determining protein concentration in wheat. The data consists of two groups of wheat spectra, a calibration set with 50 samples and a validation set of 54 samples. Each individual spectrum is given in units of log(1/R) where R is the reflectance and is measured at 1011 wavelengths, uniformly spaced from 1001 nm to 2617 nm. Standard chemometric practice involves computing derivative-like quantities at some or all wavelengths and building a calibration model from this data using least squares or partial least squares regression.

To illustrate this, let Yᵢ be the percent protein for the i-th calibration spectrum Sᵢ, and define the feature Xᵢ to be

$${X}_{i} = \frac{{S}_{i} ( 2182 nm ) - {S}_{i} ( 2134 nm )}{{S}_{i} ( 2183 nm ) - {S}_{i} ( 2260 nm )}$$

where Sᵢ(WLnm) is log(1/R) for the i-th spectrum at wavelength WL in nanometers. This feature makes use of 4 of the 1011 pieces of spectral data, and may be considered an approximate ratio of derivatives. Least squares provides a linear model AXᵢ+B yielding a prediction Ŷᵢ of Yᵢ. An estimate of the average percentage regression error is given by:

$$\frac{100}{N} {\sum }_{i = 1}^{N} \frac{\vert {\hat{Y}}_{i} - {Y}_{i} \vert}{\vert {Y}_{i} \vert}$$

with N being the number of sample spectra in the given data set (N is 50 for the calibration set). Retaining the same notation as for the calibration set, one can compute the feature Xᵢ for each validation spectrum Sᵢ and use the above model to predict Yᵢ for the validation spectra. The average percentage regression error on the validation set is 0.62%, and this serves as the measure of success for the model. This model is known to be state-of-the-art in terms of both concept and performance for this data, and will be used as point of comparison.

The wavelength-by-wavelength data of each spectrum is a presentation of the data in a particular coordinate system. Walsh packet analysis provides a wealth of alternative coordinate systems in which to view the data. In such a coordinate system, the coordinates of an individual spectrum would be the correlation of the spectrum with a given Walsh packet. The Walsh packets themselves are functions taking on the values 1, −1, and 0 in particular patterns, providing a square-wave analogue of local sine and cosine expansions. Examples of Walsh packets are shown in FIG. 28.

In accordance with the present invention, such functions may be grouped together to form independent coordinate systems in different ways. In particular, the Walsh packet construction is dyadic in nature and yields functions having N=2^{k} sample values. For N=1024, the closest value of N for the example case of spectra having 1011 sample values, the number of different coordinate systems is approximately 10²⁷². If each individual Walsh packet is assigned a numeric cost (with some restrictions), a fast search algorithm exists, which will find the coordinate system of minimal (summed) cost out of all possible Walsh coordinate systems. Despite the large range for the search, the algorithm is in not approximate, and provides a powerful tool for finding representations adapted to specific tasks.

These ideas may be applied to the case of regression for the wheat data in question. Any Walsh packet provides a feature, not unlike the Xᵢ computed above, simply by correlating the Walsh packet with each of the spectra. These correlations may be used to perform a linear regression to predict the protein concentration. The regression error can be used as a measure of the cost of the Walsh packet. A good coordinate system for performing regression is then one in which the cost, i.e. the regression error, is minimal. The fast algorithm mentioned above gives us the optimal such representation, and a regression model can be developed out of the best K (by cost) of the coordinates selected.

In a particular embodiment, for each of the calibration spectra Sᵢ, first compute all possible Walsh packet features and then determine the linear regression error in predicting the Yᵢ for each Walsh packet. Using this error as a cost measure, select a coordinate system optimized for regression, to provide a (sorted) set of features {Xᵢ(1), . . . , Xᵢ(K)} associated with each spectrum Sᵢ. These features are coordinates used to represent the original data, in the same way that the wavelength data itself does. Four features were used in the standard model described above, and, hence, one can choose K=4 and use partial least squares regression to build a model for predicting Yᵢ. The average percentage regression error of this model on the validation data set is 0.7%, and this decreases to 0.6% for K=10. FIG. 39A shows a typical wheat spectrum together with one of the top 4 Walsh packets used in this model. The feature that is input to the regression model is the correlation of the Walsh packet with the wheat spectrum. (In this case the Walsh feature computes a second derivative, which suppresses the background and detects the curvature of the hidden protein spectrum in this region).

Similar performance is achieved by Walsh packet analysis using the same number of features. The benefit of using the latter becomes clear if noise is taken into account. Consider the following simple and natural experiment: add small amounts of Gaussian white noise to the spectra and repeat the calibrations done above using both the standard model and the Walsh packet model. The results of this experiment are shown in FIG. 41A, which plots the regression error versus the percentage noise energy for both models (we show both the K=4 and the K=10 model for the Walsh packet case to emphasize their similarity). A very small amount of noise takes the two models from being essentially equivalent to wildly different, with the standard model having more than three times the percentage error as the Walsh packet model. The source of this instability for the standard model is clear. The features used in building the regression model are isolated wavelengths, and the addition of even a small amount of noise will perturb those features significantly. The advantage of the Walsh packet model is clear in FIG. 42. The feature being measured is a sum from many wavelengths, naturally reducing the effect of the noise.

The Walsh packet method described here has other advantages as well. One of the most important is that of automation. The fast search algorithm automatically selects the best Walsh packets for performing the regression. If the data set were changed to, say, blood samples and concentrations of various analytes, the same algorithm would apply off the shelf in determining optimal features. The standard model would need to start from scratch in determining via lengthy experiment which wavelengths were most relevant.

Adaptability is also an important benefit. The optimality of the features chosen is based on a numeric cost function, in this case a linear regression error. However, many cost functions may be used and in each case a representation adapted to an associated task will be chosen. Optimal coordinates may be chosen for classification, compression, clustering, non-linear regression, and other tasks. In each case, automated feature selection chooses a robust set of new coordinates adapted to the job in question.

### IV. PRACTICAL APPLICATIONS

A number of applications of approaches and techniques used in accordance with the present invention were discussed or pointed to in the above disclosure. In this Section we present several applications illustrative of the advantages provided by the invention and the range of its practical utility.

A. Gray Level Camera Processing System and Method

This application concerns a processing system, in which a video camera is synchronized to modulation of a tunable light source, allowing analysis of the encoded spectral bands from a plurality of video images to provide a multispectral image. The utility of the application is due in part to the fact that it does not require special conditions—since the ambient light is not modulated it can be separated from the desired spectral information. The system is the functional equivalent of imaging the scene a number of times with a multiplicity of color filters. It allows the formation of any virtual photographic color filter with any absorption spectrum desired. A composite image combining any of these spectral bands can be formed to achieve a variety of image analysis, filtering and enhancing effects.

For example, an object with characteristic spectral signature can be highlighted by building a virtual filter transparent to this signature and not to others (which should be suppressed). In particular, for seeing the concentration of protein in a wheat grain pile (the example discussed below) it would be enough to illuminate with two different combination of bands in sequence and take the difference of the two consecutive images. More elaborate encodements may be necessary if more spectral combinations must be measured independently, but the general principle remains.

In a different embodiment, an ordinary video camera used in accordance with this invention is equipped with a synchronized tunable light source, so that odd fields are illuminated with a spectral signature that is modulated from odd field to odd field, while the even fields are modulated with the complementary spectral signature so that the combined even/odd light is white. Such an illumination system allows ordinary video imaging which after digital demodulation provides detailed spectral information on the scene with the same capabilities as a gray level camera.

This illumination processing system can be used for machine vision for tracking objects and anywhere that specific real time spectral information is useful.

In another embodiment, a gray level camera can measure several preselected light bands using, for example, 16 bands by illuminating the scene consecutively by the 16 bands and measuring one band at a time. A better result in accordance with this invention can be obtained by selecting 16 modulations, one for each band, and illuminating simultaneously the scene with all 16 colors. The sequence of 16 frames can be used to demultiplex the images. The advantages of multiplexing will be appreciated by those of skill in the art, and include: better signal to noise ratio, elimination of ambient light interference, tunability to sensor dynamic range constraints, and others.

A straightforward extension of this idea is the use of this approach for multiplexing a low resolution sensor array to obtain better image quality. For example, a 4×4 array of mirrors with Hadamard coding could distribute a scene of 400×400 pixels on a CCD array of 100×100 pixels resulting in an effective array with 16 times the number of CCD. Further, the error could be reduced by a factor of four over a raster scan of 16 scenes.

B. Chemical Composition Measurements

In accordance with the present invention by irradiating a sample of material with well-chosen bands of radiation that are separately identifiable using modulation, one can directly measure constituents in the material of interest. This measurement, for example, could be of the protein quantity in a wheat pile, different chemical compounds in human blood, or others. It should be apparent that there is no real limitation on the type of measurements that can be performed, although the sensors, detectors and other specific components of the device, or its spectrum range may differ.

In the following example we illustrate the measurement of protein in wheat, also discussed in Section III.E. above. The data consists of two groups of wheat spectra, a calibration set with 50 samples and a validation set of 54 samples.

With further reference to Section III.B, FIG. 37 shows a DMA search by splitting the scene. The detection is achieved by combining all photons from the scene into a single detector, then splitting the scene in parts to achieve good localization. In this example, one is looking for a signal with energy in the red and blue bands. Spectrometer with two detectors, as shown in FIG. 27 can be used, so that the blue light goes to the top region of the DMA, while the red goes to the bottom.

First, the algorithm checks if it is present in the whole scene by collecting all photons into the spectrometer, which looks for the presence of the spectral energies. Once the particular spectrum band is detected, the scene is split into four quarters and each is analyzed for presence of target. The procedure continues until the target is detected.

FIG. 38 illustrates the sum of wheat spectra training data (top), sum of |w| for top 10 wavelet packets (middle), and an example of protein spectra—soy protein (bottom). The goal is to estimate the amount of protein present in wheat. The middle portion of the figure shows the region where the Walsh packets provide useful parameters for chemo-metric estimation.

FIG. 39 illustrates the top 10 wavelet packets in local regression basis selected using 50 training samples. Each Walsh packet provides a measurement useful for estimation. For example, the top line indicates that by combining the two narrow bands at the ends and the subtracting the middle band we get a quantity that is linearly related to the protein concentration. FIG. 40 is a scatter plot of protein content (test data) vs. correlation with top wavelet packet. This illustrates a simple mechanism to directly measure relative concentration of desired ingredients of a mixture using the present invention.

It will be appreciated that in this case one could use an LED-based flashlight illuminating in the three bands with a modulated light, which-is then imaged with a CCD video camera that converts any group of consecutive three images into an image of protein concentration. Another implementation is to replace the RGB filters on a video camera by three filters corresponding to the protein bands, to be displayed after substraction as false RGB. Various other alternative exist and will be appreciated by those of skill in the art.

FIG. 41 illustrates PLS regression of protein content of test data: using top 10 wavelet packets (in green—1.87% error, from 6 LVs) and top 100 (in red—1.54% error from 2 LVs)—compare with error of 1.62% from 14 LVs using all original data. This graph compares the performance of the simple method described above to the true concentration values.

FIG. 42 illustrates the advantage of DNA-based Hadamard Spectroscopy in terms of visible improvement in the SNR of the signal for the Hadamard Encoding over the regular raster scan.

It will be appreciated that the above approach can be generalized to a method of detecting a chemical compound with known absorption lines. In particular, a simple detection mechanism for compounds with known absorption is to use an active illumination system that transmits radiation (such as light) only in areas of the absorption spectrum of the compound. The resulting reflected light will be weakest where the compound is present, resulting in dark shadows in the image (after processing away ambient light by, for example, subtracting the image before illumination). Clearly, this approach can be used to dynamically track objects in a video scene. For example, a red ball could be tracked in a video sequence having many other red objects, simply by characterizing the red signature of the ball, and tuning the illumination to it, or by processing the refined color discrimination. Clearly this capability is useful for interactive TV or video-gaming, machine vision, medical diagnostics, or other related applications. Naturally, similar processing can be applied in the infrared range (or LW) to be combined with infrared cameras to obtain a broad variety of color night vision or (heat vision), tuned to specific imaging tasks. To encode the received spatial radiation components one can use pulse code modulation (PCM), pulse width modulation (PWM), time division multiplexing (TDM) and any other modulation technique that has the property of identifying specific elements of a complex signal or image.

In accordance with the invention, in particular applications one can rapidly switch between the tuned light and its complement, arranging that the difference will display the analate of interest with the highest contrast. In addition, it is noted that the analate of interest will flicker, enabling detection by the eye. Applications of this approach in cancer detection in vivo, on operating table, can easily be foreseen.

C. Miscellaneous

A straightforward extension of the present invention is a method for initiating select chemical reactions using a tunable light source. In accordance with this aspect of the invention, the tunable light source of this invention can be tuned to the absorption profile of a compound that is activated by absorbing energy to achieve, for example, curing, drying, heating, cooking of specific compounds in a mixture and other desired results. Applications further include photodynamic therapy, such as used in jaundice treatment, chemotherapy, and others.

Yet another application is a method for conducting spectroscopy with determining the contribution of individual radiation components from multiplexed measurements of encoded spatio-spectral components. In particular a multiplicity of coded light in the UV band could be used to cause fluorescence of biological materials, the fluorescent effect can be analyzed to relate to the specific coded UV frequency allowing a multiplicity of measurements to occur in a multiplexed form. An illumination spectrum can be designed to dynamically stimulate the material to produce a detectable characteristic signature, including fluorescence effects and multiple fluorescent effects, as well a Raman and polarization effects. Shining UV light in various selected wavelengths is known to provoke characteristic fluorescence, which when spectrally analyzed can be used to discriminate between various categories of living or dead cells.

Another important application of the system and method of this invention is the use of the OSPU as a correlator or mask in an optical computation device. For example, an SLM, such as DMA can act as a spatial filter or mask placed at the focal length of a lens or set of lenses. As illustrated above, the SLM can be configured to reject specific spatial resolution elements, so that the subsequent image has properties that are consistent with spatial filtering in Fourier space. It will be apparent that the transform of the image by optical means is spatially effected, and that the spatial resolution of images produced in this manner can be altered in a desired way. Exactly how the spatial resolution is altered will depend on the particular application and need not be considered in further detail.

Yet another area of use is performing certain signal processing functions in an analog domain. For example, spatial processing with a DMA can be achieved directly in order to acquire various combinations of spatial patterns. Thus, an array of mirrors can be arranged to have all mirrors of the center of the image point to one detector, while all the periphery may point to another. Another useful arrangement designed to detect vertical edges will raster scan a group of, for example, 2×2 mirrors pointing left combined with an adjacent group of 2×2 mirrors pointing right. This corresponds to a convolution of the image with an edge detector. The ability to design filters made out of patterns of 0,1,−1 i.e., mirror configurations, will enable the imaging device to only measure those features which are most useful for display, discrimination or identification of spatial patterns.

The design of filters can be done empirically by using the automatic best basis algorithms for discrimination, discussed above, which is achieved by collecting data for a class of objects needing detection, and processing all filters in the Walsh Hadamard Library of wavelet packets for optimal discrimination value. The offline default filters can then be upgraded online in realtime to adapt to filed conditions and local clutter and interferences.

D. Other Embodiments of the Invention

An adaptive digitally tuned light source in the form of a de-dispersive imaging spectrograph in both the visible and near infrared spectral regions can be constructed using the methods and systems of the present disclosure. Such devices are capable of illuminating a sample with appropriate energy-weighted spectral bands or spatio-spectral bands that relate only to the constituents of interest to the investigator. The energy from each of the spectral resolution elements can be digitally modulated to provide a tuned weighted spectral output. A tuned light source device based on this technology can be adapted for use in a conventional imaging microscope system to enable direct measure of spatio-spectral features of interest.

Spatial light modulators integrated as programmable optical masks or apertures in spectrometry and spectral imaging devices enable the integration of data processing with the acquisition process. A range of obstructions to practical optical metrology have been overcome, the efforts being largely aimed at improving the efficacy and range of spectrometry and spectral imaging applications. By combining programmable aperture optical instrumentation with automated diagnostic feature extraction and analysis algorithms, performance advances in analytical instrumentation and information delivery are realized. Instruments that are not merely capable of collecting data but adapting to the measure of interest and sample matrix in a way that optimizes the measure as well as the presentation of the answer are realized. These concepts are realized using SLMs (see, e.g., W. G. Fateley, U.S. Pat. No. 6,392,748).

Enabling advances in programmable optical mask technologies, combined with new tools in mathematics that have been developed over the last ten years, allow sifting through empirical data to extract optimized parameters for diagnostics and prediction. These parameters are used to optimize measurement by changing the configuration of the programmable apertures placed in the optical path. SLMs have been employed in various spectrometric and spectral imaging embodiments that are capable of many complex modalities of operation. These hybrid instruments are capable of simultaneously employing a multitude of measurement schemes from the very simple sequential resolution element measurement to Fourier transform modulation schemes, Hadamard-Walsh, and others, as well as complex combinations of all of these. The successful application of these concepts specifically promises for biomedicine the ability to provide timely diagnostic measurements of significance.

(i) Hadamard Transform Optics

An overview of the benefits of Hadamard mathematics in spectrometry, imaging, and spectral imagery, is provided as an introduction to some features of programmable modulated aperture systems. Detailed mathematical discussions can be found in the literature, e.g., M. Harwit et al., Hadamard Transform Optics, 1-20, Academic Press, New York, 1979. The theoretical improvement predicted in SNR when compared to sequential measurements has been realized (see, e.g., R. A. DeVerse, et al., Realization of the Hadamard Multiplex Advantage Using a Programmable Optical Mask in a Dispersive Flat-Field Near-Infrared Spectrometer, Appl. Spectrosc. 54 1751, 2000). The theoretical reduction in noise with associated improvement in SNR for a single element detector is √N/2 provided the system is not operating under photon noise limited conditions.

Hadamard transform optical measurement schemes typically use a changeable optical mask at the focal plane to select one more than half of the N resolution elements for each of N measurements. Each encoded sum of resolution elements is measured and indexed with the encodement number to generate an encodegram. FIG. 48 shows encoded near-infrared spectral data. Applying a fast mathematical transform algorithm to the recorded detector response for N different encodements of (N+1)/2 open combinations of mask elements converts the data to the single beam spectrum of polystyrene shown in FIG. 49. The etendue of the system is increased on the order of (N+1)/2 times. The theoretical improvement in SNR is over 31× where N=1000 spectral resolution elements. A visual indication of this is shown in FIG. 50 when compared with FIG. 51. FIG. 50 is a spectral image slice of a 5 polymer sample in the NIR spectral region collected using sequential or raster scanning methods. FIG. 51 shows the next scan conducted using Walsh-Hadamard mathematics.

(ii) Instrumentation

Research by the Hammaker-Fateley group at Kansas State University has worked to improve the performance of instruments for spectroscopy, imaging and spectral imaging for many decades using multiplexing strategies based on mathematical models. An early example of the potential of this approach is the application of Fourier transform mathematics to spectroscopy, now widely available in commercial instrumentation. This technology has been enabled by requisite advances in lasers, computers, engineering and manufacturing technology. The primary benefit realized is an increase in the etendue of the system which, among other benefits, realizes improved SNR. Improvement in the SNR of the measure is a fundamental measure of improved performance, and with SNR improvement comes the potential to increase sensitivity and reduce quantification errors in analytical spectrometric methodologies. Decker and others in the early 1970s illustrated the benefits of alternative transform techniques in spectrometric instrumentation (see, e.g., J. A. Decker, Appl. Opt. 10(3), 510, 1971). The Fateley-Hammaker group has investigated many embodiments of Hadamard transform instrumentation. The limiting technology was primarily the Hadamard encoded optical mask or aperture. Through the years they successfully directed efforts to incorporate liquid crystal and mechanical optical masks into many successful prototype devices. As early Fourier transform spectrometry instrumentation efforts struggled to find adequate supporting technology, Hadamard transform spectroscopy has historically been dependent upon advances in optical mask technology. Early optical masks did not permit the realization of a commercially viable and competitive high performance optical system. Liquid crystal masks are hampered by polarization requirements, absorption and contrast issues, and are limited in their spectral range of operation. Mechanical mask technology allows broad spectral range of operation but suffers from position repeatability problems, slow movement, fixed encodements and mask element size, structural requirements of spacers between elements and moving parts issues. The ideal optical mask for employing programmable optical aperture techniques would be in the form of a spatial light modulator where each resolution element or “pixel” was opaque to all wavelengths when “off” and would pass all wavelengths when “on”.

The commercially available SLM in the form of a digital micro-mirror device (DMD) by Texas Instruments provides an answer to many of the problems encountered when employing encoded optical masks. Work began in 1997 to integrate the DMD as a programmable optical mask into various spectrometric and spectral imaging prototype instruments. Fundamental patents based on the use of spatial light modulators in spectrometric and spectral imagery embodiments have issued as a result of this work.

The commercially available SLM in the form of a digital micro-mirror device (DMD) by Texas Instruments Incorporated, Dallas, Tex., is a binary digital device that works on binary spatial filtering principles. FIG. 52 shows an image and illustrated enlargement of an 848×600 DMD. The micro-mirror surface can be aluminum, which is highly reflective over broad spectral regions. Other reflective surfaces can be used in different embodiments of the invention. The small micro-mirrors rotate from the “on” (+100) to “off” (−10°) position on the diagonal and come to rest in less than 20 μs. Reliability in relative spatial position is assured. Only the number of micro-mirrors in the array limits the number of useful mask elements or pixels. Micro-mirrors are employed in such a way that the individual micro-mirrors in the array correspond to particular spatial, spectral or spatio-spectral resolution elements. This arrangement allows for the simultaneous measurement of a multitude of contiguous or non-contiguous, individual or combined resolution elements. Programmable mirror modulation rates provide for tremendous flexibility in applying mathematically reinforced and optimized measurement schemes.

Because the DMD is highly programmable, unique methodologies and the improvements they bring about can be directly compared for performance attributes without requiring any human interaction (see, e.g., Q. S. Hanley, et al., “Optical sectioning fluorescence spectroscopy in a Programmable Array Microscope,” Appl. Spectrosc. 52, 783-789 1998). The DMD as a programmable optical mask has enabled a direct empirical measure of the improved performance based on SNR when using Hadamard encoding methods compared to conventional sequential measurements by allowing the maintenance of identical optical paths for the two required sequential experiments. The DMD enables the implementation of Hadamard sequences with length in excess of 260,000 elements, which is possibly the largest ever used successfully in optical systems to date. The construction and use of encoding masks of this size would be extremely difficult at best considering previously available optical mask technology.

The DMD is subject to many of the same physical advantages and limitations of solid-state devices. It can handle high optical energy densities and is designed to tolerate the intense irradiance from the arc lamps associated with projector-based applications. The DMD has been used to spatially encode an expanded ˜7 Watt continuous Argon Ion laser sources used in a Raman imaging application with no observation of degradation in device performance (see, e.g., R. A. DeVerse, et al., “Hadamard transform Raman imagery with a digital micro-mirror array” Vibr. Spect. 19, 177-186, 1999).

Employing encoded mask technology allows for a direct improvement in throughput performance. Hadamard transform mathematics predict a √N/2 reduction in the noise of the measure of N resolution elements for a single path geometry and where the detector is not operating in photon noise limited conditions. It is observed that the noise in photometric systems using PIN detectors is a result of detector noise, thermal noise and amplifier noise and the SNR of these systems improve by supplying larger signals. Most common infrared detectors suffer from noise that is largely independent of signal level (see, e.g., H. Mark, J Workman Jr., “Is noise brought by the stork? Analysis of noise part 1” Spectroscopy 15(10), 24-25, 2000).

The DMD and other SLMs provide provide for pre-sensor computation of spatio/spectral dimensions and for simultaneous improvements in fundamental SNR, probabilities of detection and sensitivity while allowing for flexibility in method and application.

(iii) Optical Configuration

A dispersive imaging spectrograph receives energy through a single fixed entrance aperture. This source energy is dispersed and re-imaged into spatio-spectral resolution elements at a focal plane. These resolution elements are typically focused onto a focal plane for detection by a two-dimensional array of detectors. Individual detectors in the array are of particular spatial extent to receive the energy of an individual spatio-spectral resolution element. If this detector were now a broad band emitter then the imaging spectrograph could be capable of emitting predictable subset of bands of optical energy that are in accordance with the position at the focal plane. The detector array of the dispersive spectrograph is replaced with a DMD system that affects an array of modulated broad-band sources to realize a de-dispersive imaging spectrograph configuration, capable of functioning in a variety of modalities. FIG. 53 shows this concept of a de-dispersive system. Spatially resolved broadband sources at the focal plane that lie in the dispersion plane are seen at the exit aperture as a particular spatio-spectral resolution element. FIG. 54 shows an example of the relative spatio-spectral resolution element distribution. FIG. 53 and FIG. 54 are complimentary in description of A1 and An. The data shown in FIG. 48 and FIG. 49 are collected using a programmable aperture de-dispersive imaging spectrograph operated in a spectral light source modality. The same instrument is also used to collect the data shown in FIG. 50 and FIG. 51. The difference between the measures using the same optical path is in the size and shape of the sample resolution elements. Spatio-spectral resolution elements can be combined to form any subset or superset of spatio-spectral resolution elements. They are summed at the output aperture of the system prior to impinging upon the sample. The data shown in FIG. 48 and FIG. 49 used spatio-spectral sample resolution elements constructed from a superset of 16 micro-mirrors in the spectral dimension and 600 micro-mirrors in the spatial dimension. In the case of the data shown in FIG. 50 and FIG. 51, each spatio-spectral sample resolution element is 9 micro-mirrors square so as to resolve the spatial dimension at the output aperture.

The DMD in this configuration combined with appropriate driving electronics and algorithmic processing enables a tuneable, flexible, highly programmable modulated light source capable of employing adaptive optical metrology for investigating a variety of interesting spectrometric and spectral imaging modalities.

(iv) Biomedical Applications

The flexible spectrometric system of the present disclosure combines a programmable aperture with adaptive algorithmic methodologies for biomedical applications. A tuneable light source prototype is integrated with a laboratory microscope to illustrate alternative procedures for computer assisted pathological assessment of biological tissues. A portable device according to the present disclosure can be used with an imaging microscope system to employ a multitude of algorithmic techniques in an effort to optimize contrast in the spectroscopic “read-out” for tissue diagnosis and add a quantitative rigor to the process. Biologically important structures in the sample can be qualitatively and quantitatively evaluated while processed imagery can be sent to a video display for the pathologist's review. In addition to expediting an assessment, the adaptive light microscope also provides quantitative output that makes possible objective comparisons between samples and a reference “yardstick,” thereby improving the accuracy of such assessments. Potential users of this device include pathologists and technicians in hospital pathology labs as well as surgeons and surgical support personnel. Because the device is portable and stand-alone, it is suited to field hospital applications as well. Present day procedures for examining a tissue sample require that the sample first be stained, then examined under a light microscope and subjectively evaluated by the examining technician or doctor. The evaluation typically follows a rough decision tree outline to arrive at a best available assessment of the sample's condition. The advantages to using the proposed adaptive light microscope would be that an objective and standardized evaluation process could be conducted, whereby distinct tissue features could be algorithmically correlated to various conditions. The device can employ the conventional methodologies to collect all data available, then adapt, or be adapted by the user, to employ the best combinations of weighted spectral bands to illuminate the sample.

The present disclosure discloses a programmable light source system, which enables a unique approach to broadband and multiplexed spectrometric measurements. This is accomplished by providing effective and robust chemometric and broadband filtering tools. The stains that colors the tissue are developed to make it easy for an observer to look into the microscope and identify the structures shown. A conventional bright field imaging system acquires RGB data. The present disclosure provides for improvements over RGB methodologies. Instead of analyzing three colors, many more can be considered. This can enable rapid identification and quantification of many spatio-spectral features of interest. The methods of the present disclosure can successfully extract features in complex samples that are difficult or intractable for conventional RGB imaging systems to extract. The encoded data collection schemes can be applied to the tuned light microscopy system in a variety of settings. The system of the present disclosure provides for an automated feature extraction and information delivery system that can significantly augment the efforts of microscopists to differentiate and quantify tissues.

### V. EXAMPLES

Data presented is collected by illuminating a slide of stained colon biopsy tissue in a Nikon BioPhot light imaging microscope.

A. Optical Path

The experiment involves fiber-optically coupling a tuned light prototype spectrometer to a Nikon BioPhot light microscope. Although not optimized for delivering light into a microscope, the results illustrate one potential application of this technology for biomedical science. Stained slides from a colon cancer biopsy were illuminated by a sequence of spectral bands from 450 nm to 850 nm and the image captured by a CCD camera system. To automate the data collection and achieve adaptive or interactive ability, the image collection was synchronized with the output modulations of the tuned light source. Patterns can be modulated based on the previous imagery but in this experiment this software was not implemented. There are over 1,000 spectral resolution elements that are available to be modulated and de-dispersively mixed through an output aperture. The magnitude of photonic flux from each of the spectral resolution elements can be digitally controlled to over 700 levels, enabling a highly tuned, weighted spectral output for rapid high performance spectral imagery. FIG. 55 shows an image of the portable tuned light source prototype for non-invasive blood chemometry. FIG. 56 shows an image of the tuned light source and imaging microscope setup.

B. Output Characteristics of the Tuned Light Instrument for Non Invasive Blood Chemometry

FIGS. 57 and 58 show the tuned light source output as measured by an Ocean Optics SD2000 dual channel CCD based spectrometer. The output of the tuned light source spectrometer was built to accommodate SMA connectorized reflectance probes for non-invasive blood monitoring experiments. This made it a simple matter to couple into the input of the Ocean Optics spectrometer. The system is tuned to an output that showed a linear increase in energy with wavelength of the four bands selected. The output was adjusted via the controlling computers graphical user interface in order to compensate for the non-linear spectral response function of the Ocean Optics spectrometer and generate the display shown in FIG. 57. The output energy could also be decreased with increasing wavelength as shown in FIG. 58. Spectral data was recorded as JPG images of the spectral data presentation window. It is possible to access and modulate each of the 1,000 resolution elements at a full width half maximum bandpass of 5 nm.

C. Data Collection

Images were collected via simple raster scan using 128 bands of 8 micro-mirror columns. A Sensovation CCD camera was mounted on top of a Nikon BioPhot light imaging microscope system. Camera integration time was set to 600 ms. Total collection time was ˜7 minutes. Hadamard modalities increasing photonic flux promise to decrease integration times to less than 60 ms given the current geometry. A dedicated microscope system is being built to address issues with efficient coupling of the light source to the microscope for future experiments.

FIG. 59 shows an image of a portion of a stained colon biopsy. While even to the untrained eye certain features can appear differentiated, without some non-trivial processing (examining e.g. geometry, density, texture) on this black and white image, it would be hard for a computer to differentiate them. Using imaged spectral information, this turns out to be an easy task. FIG. 60 shows the same tissue imaged at band #70 using the tuned light source. The tissue stain absorbance is greater here and can be quantified in an analytical setting. FIG. 61 demonstrates a simple feature extraction technique and FIG. 62 shows these features falsely colored and overlaid with the broadband image. FIG. 63 shows other band combinations to bring into contrast other features. FIG. 64 shows alternative display options that can work to highlight features of interest to improve information delivery.

D. Application of Spatial Light Modulators for New Modalities in Spectrometry and Imaging

The single-detector, hyper-spectral imaging system includes a digital micro-mirror array as a spatial light modulator. It is found that this configuration, combined with some novel mathematical methods, provides an incredible range of flexibility in application. The digital micro-mirror device used is commercially available from Texas Instruments. It is shown in FIG. 65, shown here with its cover removed. Each mirror in the 600 row by 848 column array is highly reflective when in their “on” position. They are built on top of integrated circuits that provide a 20 degree range of motion with “on-off” states at +and − 10°. (See FIG. 65) Since the instrument has this efficient binary quality, it effectively functions as a digital device. The concept is to employ DMDs to spatially modulate an aperture, image or focal plane or act as an array of point sources.

In this configuration, with a single detector, we can combine the spatio-spectral resolution elements in any way preferred. In this configuration, the micro-mirror array is located at the focal plane of the spectrograph. The rows and columns may either be assigned as spectral or spatial resolution elements, depending on the preferred imaging method. This flexibility of assignment, and the ability to easily program and control the mirrors electronically, allows for such benefits as dynamic resolution adjustment, tunable light bands, and static spatial scanning. (See FIG. 66.)

There are various modalities made possible by the DMA imaging system. The system provides for the ability to raster scan with accost-effective, single detector, COTS instrument. (See FIG. 67.) FIG. 70 shows the results from scan using a single detector with COTS hardware. This system is significantly lower in price, at approximately one tenth the price of other systems.

Without any adjustments other than a re-programming of the mirrors, the DMA instrument can also be configured as a multiplexing spectrometer, thereby offering significant gains in SNR. (See FIG. 71.) Multiplexing involves letting more than one slit-width of light through to the detector, which increases total light intensity at the detector without adding additional error, thereby improving SNR. Multiple configurations of slits create a pattern of encoded information, which can then be mathematically de-convoluted to produce a traditional spectrum. (See FIG. 72.) The programmable DMA lends itself easily to an encodement mask, which can cycle through patterns without requiring macro-moving mechanical parts that are typically susceptible to mis-alignment and malfunction. A high degree of correspondence is seen between predicted and actual improvements in SNR using the DMA instrument. The improvement in SNR that multiplexing provides is easy to see in FIG. 74.

In the example of FIG. 75, the DMA instrument was used in Raster scanning mode to produce spectra of three materials. The same instrument was then used for a multiplexed scan of the same scene, as shown in FIG. 76. The spectra have a much higher resolution given the multiplexed advantage. The DMA device of the present disclosure is the only presently known system capable of running either a Raster or Hadamard scan on the same scene without any necessary external adjustment of the instrument or scene. This is also true for combinations of these techniques as well as other encodements, such as Fourier methods.

The DMA instrument allows for choosing an imaging method based on existing conditions that typically correlate with SNR (such as scan rate, available lighting, etc.), as illustrated in FIG. 77.

In addition to representing spatio-spectral elements, the mirrors of the DMA can equally well represent two spatial dimensions. (See FIG. 78.) This allows for scanning of a two-dimensional scene without slit translation, as each slit width of spatial information is captured by each corresponding row of mirrors on the DMA.

When the DMA is coupled with a standard, black & white camera to collect the spectrum of each “slit” representation, a hyperspectral data cube can be generated. It would also be possible to build a device that combines two DMA's and is therefore capable of producing a hyperspectral data cube of a two-dimensional scene without slit translation and with only a single detector. (See FIGS. 79 and 80.)

The flexibility of the DMA also allows for the modulation of light intensity within specific spectral bands for creating a tuned light source. This is achieved simply by limiting the number of “on” mirror rows within a particular spectral “column.” With homogenous illumination across the slit, the intensity of spectral bands thereby become completely programmable. (See FIG. 81.) Tuned light sources have also been created in the near infrared region of the spectrum. (See FIGS. 86A-D.)

By shaping the spectral signature of the light source illuminating a scene, the spectra of all pixels in the image can be processed in parallel. (See FIG. 87.) More specifically, each pixel in the camera measures the correlation of the spectral absorption profile of the material at that location with the spectral profile of the light source. By choosing the spectral profile to correspond to a useful chemometric feature, and by differencing two successive images, specific chemical concentrations at various locations can be measured directly. If an array of 1000×1000 pixels with a collection of 300 spectral bands is used, each image snapshot pair provides the result of a million inner products in 300 dimensions, thereby bypassing the need to collect and process the data offline. This technique works particularly well for biomedical tissue samples, as shown in FIGS. 88A-D and 89A-B.

The same idea also works for creating dynamic filters for passive spectroscopy. The DMA electronic shutter system operates as a photonic switch to select and encode spatio/spectral features in the scene. (See FIG. 90.) This shutter, when coupled with a conventional push broom spectrograph, allows for multiplexing simultaneous acquisitions of lines in the scene. In the example shown in FIG. 91, a spectral filter, which is designed on line with no a priori knowledge, is used to suppress vegetation, and reveals the “residual” truck spectrum.

While the foregoing has described and illustrated aspects of various embodiments of the present invention, those skilled in the art will recognize that alternative components and techniques, and/or combinations and permutations of the described components and techniques, can be substituted for, or added to, the embodiments described herein. It is intended, therefore, that the present invention not be defined by the specific embodiments described herein, but rather by the appended claims, which are intended to be construed in accordance with the well-settled principles of claim construction, including that: each claim should be given its broadest reasonable interpretation consistent with the specification; limitations should not be read from the specification or drawings into the claims; words in a claim should be given their plain, ordinary, and generic meaning, unless it is readily apparent from the specification that an unusual meaning was intended; an absence of the specific words “means for” connotes applicants' intent not to invoke 35 U.S.C. §112 (6) in construing the limitation; where the phrase “means for” precedes a data processing or manipulation “function,” it is intended that the resulting means-plus-function element be construed to cover any, and all, computer implementation(s) of the recited “function”; a claim that contains more than one computer-implemented means-plus-function element should not be construed to require that each means-plus-function element must be a structurally distinct entity (such as a particular piece of hardware or block of code); rather, such claim should be construed merely to require that the overall combination of hardware/firmware/software which implements the invention must, as a whole, implement at least the function(s) called for by the claim's means-plus-function element(s).

What is claimed is:

1. A method for identifying spatio-spectral features of one or more objects comprising the steps of:
a. collecting one or more hyperspectral datacubes of a first set of one or more objects;
b. building a spectrometric model from said hyperspectral datacubes;
c. illuminating a second set of one or more objects with energy-weighted spectral bands that relate to the model in step (b) using a tunable light source;
d. measuring the energy resulting from the illumination in step (c); and
e. using the measurements in step (d) to identify spatio-spectral features of the illuminated object(s).

2. The method of claim 1, wherein said tunable light source comprises a spatial light modulator.

3. A device for identifying spatio-spectral features of one or more objects, comprising:
a. means for collecting hyperspectral datacubes;
b. means for building spectrometric models;
c. tunable light source means;
d. means for illuminating one or more objects with energy-weighted spectral bands that relate to spectrometric models; and
e. means for measuring the energy resulting from illumination by said means for illuminating.

4. The device of claim 3, wherein said tunable light source comprises a spatial light modulator.
